(19) United States
(12) Patent Application Publication
(10) Pub. No.: US 2005/0273450 A1
(43) Pub. Date: Dec. 8, 2005

(54) Regular expression acceleration engine and processing model

(76) Inventors: Robert J. McMillen, Carlsbad, CA (US); Michael D. Ruehle, San Diego, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/851,482

(22) Filed: May 21, 2004

(51) Int. Cl. G06F 7/00

(52) U.S. Cl. 707/1

(57) ABSTRACT

Optimization for improved construction and execution of state machines configured to identify lexemes in data files is disclosed. This optimization includes, for example, systems and methods for disambiguating between overlapping matches found in data files, using trailing context regular expressions, removing stall states from state machines, selecting between a plurality of sets of regular expressions, analyzing multiple data files concurrently, analyzing portions of a single data file concurrently, representing state machines using instructions representative of transitions between states, and using virtual terminal instructions.

### BACKGROUND OF THE INVENTION

1. Field of the Invention

The invention relates generally to methods and systems for performing pattern matching on digital data. In particular, it involves a form of pattern matching in which sequences of symbols are identified using regular expressions.

2. Description of the Related Art

With the maturation of computer and networking technology, the volume and types of data transmitted on the various networks have grown considerably. For example, symbols in various formats may be used to represent data. These symbols may be in textual forms, such as ASCII (American Standard Code for Information Interchange), EBCDIC (Extended Binary Coded Decimal Interchange Code), the fifteen ISO 8859, 8 bit character sets, UTF-8, UTF-16, or Unicode multi-byte characters, for example. Data may also be stored and transmitted in specialized binary formats representing executable code, sound, images, and video, for example.

Along with the growth in the volume and types of data used in network communications, a need to process, understand, and transform the data has also increased. For example, the World Wide Web and the Internet comprise thousands of gateways, routers, switches, bridges, and hubs that interconnect millions of computers. Information is exchanged using numerous high level protocols like SMTP (Simple Mail Transfer Protocol), MIME (Multipurpose Internet Mail Extensions), HTTP (Hyper Text Transfer protocol), and FTP (File Transfer Protocol) on top of low level protocols like TCP (Transport Control Protocol), UDP (User Datagram Protocol), IP (Internet Protocol), MAP (Manufacturing Automation Protocol), and TOP (Technical and Office Protocol). The documents transported are represented using standards like RTF (Rich Text Format), HTML (Hyper Text Markup Language), XML (eXtensible Markup Language), and SGML (Standard Generalized Markup Language). These standards may further include instructions in other programming languages. For example, HTML may include the use of scripting languages like Java and Visual Basic.

As information is transported across a network, there are many points at which some of the information may be interpreted to make routing decisions. To reduce the complexity of making routing decisions, many protocols organize the information to be sent into a protocol specific header and an unrestricted payload. At the lowest level, it is common to subdivide the payload into packets and provide each packet with a header. In such a case (e.g., TCP/IP), the routing information required is at fixed locations, where relatively simple hardware can quickly find and interpret it. Because these routing operations are expected to occur at wire speeds, simplicity in determining the routing information is preferred. However, as discussed further below, a number of factors have increased the need to look more deeply inside packets to assess the contents of the payload in determining characteristics of the data, such as routing information.

Today's Internet is rife with security threats that take the form of viruses and denial of service attacks, for example. Furthermore, there is much unwanted incoming information sent in the form of SPAM and undesired outgoing information containing corporate secrets. There is undesired access to pornographic and sports web sites from inside companies and other organizations. In large web server installations, there is the need to load balance traffic based on content of the individual communications. These trends, and others, drive demand for more sophisticated processing at various points in the network and at server front ends at wire speeds and near wire speeds. These demands have given rise to anti-virus, intrusion detection and prevention, and content filtering technologies. At their core, these technologies depend on pattern matching. For example, anti-virus applications look for fragments of executable code and Java and Visual Basic scripts that correspond uniquely to previously captured viruses. Similarly, content filtering applications look for a threshold number of words that match keywords on lists representative of the type of content (e.g., SPAM) to be identified. In like manner, enforcement of restricted access to web sites is accomplished by checking the URL (Universal Resource Locator) identified in the HTTP header against a forbidden list.

Once the information arrives at a server, having survived all the routing, processing, and filtering that may have occurred in the network, it is typically further processed. This further processing may occur all at once when the information arrives, as in the case of a web server. Alternatively, this further processing may occur at stages, with a first one or more stages removing some layers of protocol with one or more intermediate forms being stored on disk, for example. Later stages may also process the information when the original payload is retrieved, as with an e-mail server, for example.

In the information processing examples cited above, the need for high speed processing becomes increasingly important due to the need to complete the processing in a network and also because of the volume of information that must be processed within a given time.

The first processing step that is typically required by protocols, filtering operations, and document type handlers is to organize sequences of symbols into meaningful, application specific classifications. Different applications use different terminology to describe this process. Text oriented applications typically call this type of processing lexical analysis. The groups of one or more symbols are called lexemes and are labeled as tokens. Other applications that deal with non-text or mixed data types call the process pattern matching, the symbol groups patterns, and may label them with a pattern ID or a token. These and other terms in use that represent this process are substantially equivalent. Without loss of generality, throughout the remainder of this disclosure, the lexical analysis and related terminology shall be used.

Performing lexical analysis is a computationally expensive step, because every symbol of information should be examined and dispositioned. This process does not require every symbol or group of symbols to be assigned a token. In some instances, it is desirable to specifically ignore some sequences of symbols. Nevertheless, every symbol is typically examined to make that determination. Once a token stream is created, there is usually a significant reduction in the required processing rate. For example, if the average number of symbols per token is 10, then the token output rate is 1/10^{th} the symbol input rate. Ignoring some symbols leads to further reduction. In general, it is common in language processing (e.g. HTML and XML) for virtually every symbol to map to a token, whereas in filtering applications (e.g. Anti-Virus, Anti-SPAM), it is common for a majority of symbols to be unassigned and therefore ignored.

In some applications, the processing required consists solely of lexical analysis. For example, in virus signature identification, in one possible embodiment, one token is assigned per signature and each signature may consist of eight to 120 bytes (signature lengths are arbitrarily chosen for illustrative purposes). A clean file scanned will cause no tokens to be returned. A file infected with a single virus should cause one token to be returned which identifies the virus. Other applications follow lexical analysis with further processing of the token stream. For example, content based routing of XML documents may use lexical analysis with a token driven state machine programmed by XPATH expressions, where XPATH expressions describe how to process items in XML by defining a path through the document's logical structure or hierarchy. In some embodiments, SPAM filters assign weights to each token found and then compare the sum of the weights to a threshold to decide how to classify the document (e.g., e-mail) examined.

Regular expressions are well known in the prior art and have been in use for some time for pattern matching and lexical analysis. An early example of their use is disclosed by K. L. Thompson in U.S. Pat. No. 3,568,156, issued Mar. 2, 1971. In addition to the examples cited above, the following issued patents and published patent applications exemplify a broad range of uses for regular expressions in the prior art. Each of the above and following applications and published patent applications is hereby incorporated by reference for all purposes.
Transaction recognition and prediction
   U.S. Pat. No. 6,477,571 Ross, Transaction Recognition and Prediction using Regular Expressions
Classifying content in packets
   US Patent Publication 2003/0135653 Marovich, Method and System for Communications Network
Extracting information from HTML documents
   U.S. Pat. No. 6,446,098 Iyer et al. Method for Converting Two-Dimensional Data into a Canonical Representation
   US Patent Publication 2002/0103831 Iyer et al., System and Method for Converting Two-Dimensional Data into a Canonical Representation
   US Patent Publication 2002/0116419 Iyer et al., System and Method for Converting Two-Dimensional Data into a Canonical Representation
Processing dial information in Voice over IP and similar applications
   U.S. Pat. No. 6,275,574 Oran, Dial Plan Mapper
   U.S. Pat. No. 6,636,594 Oran, Dial Plan Mapper
Automated mapping of fields between different data sets in data processing applications
   U.S. Pat. No. 6,216,131 Liu et al., Methods for Mapping Data Fields from One Data Set to Another in a Data Processing Environment
   U.S. Pat. No. 6,496,835 Liu et al., Methods for Mapping Data Fields from One Data Set to Another in a Data Processing Environment
Speech Recognition
   U.S. Pat. No. 6,327,561 Smith et al., Customized Tokenization of Domain Specific Text via Rules Corresponding to a Speech Recognition Vocabulary
Natural Language Searching
   U.S. Pat. No. 6,202,064 Julliard, Linguistic Search System
Intrusion Detection in networks
   U.S. Pat. No. 6,487,666 Shanklin et al., Intrusion Detection Signature Analysis using Regular Expressions and Logical Operators
Content Filtering (SPAM detection, Web site filtering, Corporate proprietary information protection)
   U.S. Pat. No. 6,675,162 Russell-Falla et al., Method for Scanning, Analyzing and Handling Various Kinds of Digital Information Content

In each of the above-cited applications, patents, and examples, regular expression evaluation is a key part of the information processing. To the extent that expressions could be evaluated faster, each application may be accelerated. Accordingly, there is a need to increase the speed of evaluation, and otherwise processing, of regular expressions.

In defining lexemes (patterns), the brute force approach would be to enumerate every symbol sequence of interest and to associate a token value with each one. In some content filtering applications this approach may be practical. For example, word lists may be created with tens to hundreds of entries to specify the lexemes of interest. On the other hand, this brute force approach is much less practical for many protocols, and especially for language processing where identification of an integer with any number of digits or a word of any length may be necessary. Regular expression notation was created to address this need. One simple application of regular expressions is discussed in U.S. Pat. No. 3,568,156 to Thompson.

Regular expressions typically comprise terms and operators. A term may include a single symbol or multiple symbols combined with operators. Terms may also be recursive, so a single term may include multiple terms combined by operators. In dealing with regular expressions, three operations are defined, namely, juxtaposition, disjunction, and closure. In more modern terms, these operations are referred to as concatenation, selection, and repetition, respectively. Concatenation is implicit, one term is followed by another. Selection is represented by the logical OR operator which may be signified by a symbol, such as ‘|’. When using the selection operator, either term to which the operator applies will satisfy the expression. Repetition is represented by ‘*’ which is often referred to as a Kleene star. The Kleene star, or other repetition operator, specifies zero or more occurrences of the term upon which it operates. Parentheses may also be used with regular expressions to group terms.

A few examples will illustrate the usage and meaning of common regular expression notations. Assume that a stream of data, such as stored in a file or streaming via a network, comprises symbols from the ASCII character set. A trivial case is represented by a word, say ‘cat’. The regular expression ‘cat’ contains two implied concatenation operations between three terms, which are each single characters. More particularly, the regular expression specifies a ‘c’ followed by an ‘a’ followed by a ‘t’. The regular expression ‘cat’ is referred to as a literal expression, where a literal expression is a value written exactly as it is meant to be interpreted. Those of skill in the art will recognize that literal expressions may be sufficient for applications that require only keyword or fixed sequences of symbols. In many applications, however, the use of operators increases the flexibility and value of regular expressions. For example, a selection operator, such as in the regular expression ‘(cat)|(dog)|(bird)’, is satisfied if any one of the character sequences is found. When a space is used in a string or a regular expression, for clarity it will be represented using the symbol, ‘□’. The use of repetition and selection operators may be combined in a regular expression, such as ‘(t|T) he□*cat□*leapt□*’ which will match the phrase ‘the□cat□leapt’ whether it is at the beginning of a sentence, so the ‘t’ is capitalized, or in the middle of a sentence where it is not, and regardless of the number of spaces that follow each word. It would also match ‘thecatleapt’. To match any integer, the expression required is ‘(0|1|2|3|4|5|6|7|8|9) (0|1|2|3|4|5|6|7|8|9)*’. The expression is written this way to require at least one digit to exist, since the repetition operator permits zero occurrences.

These three operators (concatenation, selection, and repetition) are sufficient to define a considerable range of expressions. However, as the last example illustrates, it can be tedious to define the expressions needed. Hence, additional operators have been defined for use in regular expressions. For example, the addition of the ‘+’ operator, which is interpreted as “one or more instances” reduces the previous expression to ‘(0|1|2|3|4|5|6|7|8|9)+’. While the use of the ‘+’ operator adds increased flexibility in regular expressions, the expression that matches any individual word still requires the enumeration of every letter in the alphabet. Accordingly, symbol classes that specify any combination of lists of individual symbols and/or ranges of symbols can be defined by enclosing them in square brackets, ‘[’ and ‘]’. More particularly, a range is specified by a first symbol, a hyphen, and a second symbol. The set of symbols included in a range is determined by the collating sequence of the defined symbol set. For example, integers can now be specified by the simple expression ‘[0-9]+’. This works because the binary values assigned to the ASCII characters ‘0’ through ‘9’, hexadecimal 30 through 39 respectively, are sequential and in the same order as that implied by the meaning of the digit characters. Similarly, the letters of the alphabet are assigned values that correspond to the order in which they are defined to occur in the English alphabet. Thus, any lower case word would be matched by the range ‘[a-z]+’ and any capitalized word could be found with the ranges ‘[A-Za-z]+’. This is an example of including two ranges inside the square brackets. Because the upper and lower case letters are not contiguous in the ASCII collating sequence, specifying ‘[A-z]+’ would not give the desired result. As another example, the expression ‘[aeiou]’ will match a single vowel. Similarly, the expression ‘[A-Za-z_][A-Za-z0-9_-]*’ would find each instance of a legal variable name in many programming languages, C for example. This expression specifies that the name must begin with a letter or underscore and may be optionally followed by any number of letters, digits, underscores, or hyphens. Since hyphens are used in ranges, they can be included as a symbol if escaped with a backslash, ‘\’, or, appear as the first or last symbol in the class, as in this example.

Another common operator used in regular expressions is the question mark, ‘?’, which typically means zero or one occurrence of the preceding symbol or range. The generalized form for counting occurrences is given by ‘{min,max}’ which indicates there must be at least min occurrences and not more than max. Thus, ‘?’ is equivalent to ‘{0,1}’. Omitting max implies no upper limit, so ‘*’ is equivalent to ‘{0,}’, and ‘+’ is equivalent to ‘{1,}’. To complete this feature, ‘{qty}’ indicates that there must be exactly qty occurrences.

There are many possible equivalent notations for any desired expression. For example, in some implementations ‘\d’ is defined to mean any digit and so is equivalent to ‘[0-9]’ and in fact many such commonly used character classes are defined that way. Many regular expression notations include a NOT operator for symbol classes which may be symbolized by caret, ‘\hat{ }’. A caret's special meaning applies only if it used as the first symbol inside a symbol class, so that ‘[\hat{ }0-9]’ would match any single character except a digit. The equivalent notation is ‘\D’, i.e., negation is indicated by capitalizing the letter code.

Another text oriented feature available in some systems using regular expressions is to provide for anchoring an expression to the beginning or end of a line. In the ASCII and virtually all 8 bit character sets, end-of-line is signaled by some combination of carriage return, ‘\r’, and linefeed ‘\n’. For example, UNIX based systems use a linefeed by itself, Microsoft Windows based systems use a carriage return/linefeed pair, and Apple Macintosh based systems use only a carriage return. The single regular expression, ‘(\r)|(\r?\n)’, can be used to detect any of these cases.

A caret symbol, ‘\hat{ }’, appearing as the first symbol in an expression will match only if the remainder of the expression is found at the beginning of a line. The caret is referred to as a beginning-of-line anchor. Similarly, when a dollar sign, ‘$’, appears as the last symbol in an expression, the occurrence of the preceding part of the expression must be the last thing on the line or there is no match. The dollar sign is referred to as an end-of-line anchor. A lexeme so identified does not contain any of the symbols that constitute the end of a line. In any instance where there is a need to match one of the characters that has been given special meaning, such as a caret or dollar sign, the backslash, ‘\’, is used as an escape mechanism to signal that the literal character immediately following it is to be used. Alternatively, the special characters may be enclosed in quotes.

Symbol classes are extremely useful, but sometimes it is desirable to simply match any symbol without regard to its value. A wildcard character is used to signify that any character matches. In some notations, a period, ‘.’ is used as the wildcard character. In other embodiments, an asterisk, ‘*’, represents a wildcard character. A wildcard character may be defined to mean either, “match any single character” or, “match any number of alphanumeric characters,” in various embodiments. In some embodiments, in text oriented regular expression notations, the end-of-line symbol or symbols are excluded from the wild card. Such exclusion prevents the expression ‘.*’ from matching the entire input. An example of its use would be in the lexical analyzer for the C or C++ programming language where program comments, which the compiler ignores, are indicated by two forward slashes, ‘//’. The notation ‘//’ signals that all following text up to the end of the line is to be ignored. The regular expression ‘//.*’, will match all such comments in the input and the comment is simply consumed. Accordingly, the expression ‘//.*’ may be used when it is undesirable to report a token based on characters within a comment. If the exclusion were not provided, it would be necessary, for example, to write the expression as ‘//[\hat{ }\n\r]*’, so that any possible end-of-line symbol is explicitly excluded. If using a different character set, any symbols used to signal an end-of-line would have to be included in the negated symbol class.

Examples of regular expression notations or languages known in the art include awk, flex, grep, egrep, Perl, POSIX, Python, and tcl. Regular expressions may be better understood by referring to Mastering Regular Expressions, Second Edition, J. E. F. Friedl, O'Reilly, Cambridge, 2002, which is hereby incorporate by reference for all purposes. Regardless of notation, all regular expression languages can be compiled into state machines using techniques well know by those practiced in the art. Such techniques may be better understood by referring to Compilers: Principles, Techniques, and Tools, J. D. Ullman, A. V. Aho, and R. Sethi, Addison-Wesley Longman, Inc., 1985, which is hereby incorporate by reference for all purposes. Methods for creating either a nondeterministic finite automata (NFA) or a deterministic finite automata (DFA) are also described in the Ullman reference.

FIG. 1a is a DFA state machine diagram 100, which includes states 0 through 8 that correspond to the regular expression ‘(t|T) he□*cat’. State 0 is the initial state as indicated by double concentric circles. The occurrence of symbols, in this case ASCII characters, causes transitions from one state to the next. State 8 is a terminal state, so indicated by a thick lined circle. Terminal states have no out-transitions. In the DFA state machine diagram of FIG. 1a, reaching state 8 constitutes having satisfied the expression, so this is referred to as an accepting state. States 0 through 7 are non-accepting states. As an example of its operation, receiving the character ‘T’ causes a transition from state 0 to state 1, whereas receiving ‘t’ causes a transition to state 2. Receiving any other character causes the machine to remain in state 0. The transition from state 0 to state 0, often referred to as an idle state, occurs when none of the available transitions to other states are satisfied. This negation of other transitions is indicated by the tilde, ‘˜’, as illustrated in FIG. 1a. From either of states 1 or 2, receiving an ‘h’ causes transition to state 3. The collection of states 0 through 3 illustrates how the selection operator is implemented. In other words, states 0 through 3 are equivalent to the regular expression ‘(t|T)h’.

Still referring to FIG. 1a, when the state machine is at state 4, a space character will cause the transition from state 4 to state 5. Since it is not a visible character, in one embodiment, the notation for substituting a space character's hexadecimal ASCII value is shown as ‘\x20’. The collection of states 4 through 6 illustrate the implementation of the repetition, ‘*’, operator. In other words, states 4 through 6 are equivalent to the regular expression ‘□*c’. Removal of the arc 110 would have the effect of converting the ‘*’ to a ‘+’ in the expression, which then requires at least one space between the words in order to move from state 4 to 6.

It is implicit in the diagram, by convention of those practiced in the art, that any character received in a non-start state, not matching one of the explicit out-transitions, causes transition to a failure terminal state. Such a state is also referred to as a non-accepting terminal state. FIG. 1b shows state machine 150, comprised of states 0 through 9, which is functionally identical to state machine 100, in which the failure transitions are shown explicitly. States 8 and 9 are both terminal states, but state 8 is an accepting state and state 9 is a non-accepting state. It only serves to obscure the state machine's operation to show the default failure state, hence the convention.

In most common applications of regular expressions, there are many expressions of interest. By compiling them together into a single state machine, all expressions are evaluated simultaneously in one scan of the input. This leads to the construction of state machines that have multiple accepting states. Hence tokens are associated with each regular expression so each particular regular expression may be independently located and identified. If no other means are provided, it is customary for the compiler to assign a unique token value, such as a number, to each regular expression that corresponds to a regular expression on a list provided to the compiler. It is also common to provide a means by which the regular expressions' author can convey to the compiler a particular value to be assigned to each expression. In the state machine, once an accepting state is reached, it is typical for some action to be taken. At a minimum, the token value associated with the regular expression is reported. Furthermore, depending on the application, it is common to report the location of the matching text in the input, or optionally, to transmit the lexeme with the token.

FIG. 2 is a block diagram illustrating a system 200 for compiling and using regular expressions. The user of the system 200 creates a regular expression list 210 using a text editor. The list 210 is processed by the compiler 220 to create a state transition table 230. The table 230 is in a form that the state machine engine 250 can interpret and execute. This compilation process only needs to be performed once for a given set of regular expressions. Once the state machine engine 250 has the desired state transition table 230 available, the state machine engine 250 can process an arbitrary number of input files 240 and produce a corresponding output file 260 for each. The output file 260 contains output information associated with each lexeme found in the input 240 according to its particular design.

When multiple regular expressions are supported, the compiler should have a means for resolving conflicts between expressions. One type of conflict occurs when two or more expressions are satisfied by the same input. The compiler should have a policy for deciding which of the expressions to report. Although all can be reported, it is generally more desirable to select one based on a priority. A common method is to give priority to the expression appearing earliest on the list (alternatively, the lowest on the input list could take priority). An example will illustrate why this is preferable. Suppose a lexical analyzer is created for HTML documents. Such documents contain tags consisting of a tag name surrounded by angle brackets, e.g., ‘<name>’. A lexical analyzer that identifies certain specific tags uniquely, but also separately identifies all other tags generically, may be desired. If the expression for one of the specific tags is ‘<tbl>’ and the expression for generic tags is ‘<[A-Za-z][A-Za-z0-9_]*>’, both expressions will reach an accepting state when the string ‘<tbl>’ is scanned. Accordingly, by listing all the specific tag expressions ahead of the generic expression, assuming the earliest listed has priority, the correct token will be assigned to each input lexeme.

Another type of conflict that may occur arises between expressions that match strings in which one is the same as the first part of another. FIG. 3 is a state machine 300, composed of states 0 through 6, which illustrates the situation. The state machine 300 illustrates one state machine that results when the two expressions ‘near’ and ‘nearer’ appear in the same list. In order to ensure that the expression ‘near’ may be found, the state 4 is a hexagonal shape, indicating that state 4 is a non-terminal accepting state for ‘near’, since it has an out-transition for ‘e’. If the next two characters are ‘e’ ‘r’, the accepting state for ‘nearer’ will be reached. The usual solution is for the compiler to give priority to the expression that matches the most input text. This is sometimes referred to as a greedy strategy. Thus, the state machine must remember that it has a possible match, referred to as the last accepting state, but continue to look for a longer match. Each successive intermediate non-terminal accepting state, like state 4, replaces the previous such state as the last accepting state. If a longer match is not found, then the state machine treats the last accepting state as the terminal state. With respect to state machine 300, if the characters ‘er’ are not found, after the characters ‘near’ have been found, then the state machine 300 treats state 4 as if it were a terminal state. This example also serves to illustrate the need to backup in the input stream in such cases. More particularly, if an accepting state is not found after a last accepting state has been found, the input pointer should return to the character that follows the character examined when the last accepting state (treated as the terminal state) was encountered, so that the search continues from that point. The next state after reaching a terminal state is an initial state. With respect to state machine 300, after determining that state 4 should be treated as a terminal state, the input pointer should be set to point to (the second) ‘e’ and the state machine should be reset to state 0, the start state. In languages like Perl that process one regular expression at a time, means are provided for indicating whether a greedy strategy is to be used or not. The alternative is sometimes called a lazy strategy.

With reference to FIG. 2, one embodiment of such a system 200 in the prior art is exemplified by the FLEX application, commonly available on UNIX systems. A description of FLEX is provided in lex & yacc, Second Edition, T. Mason, J. Levine, and D. Brown, O'Reilly Media, Inc., 1992, which is hereby incorporated by reference for all purposes. In general, FLEX is a compiler 220 written as a software program that accepts a regular expression list 210 as input and generates both the state transition tables 230 and state machine engine 250 in the form of a C language program. When the C program is compiled, the executable will accept input files 240, scan them, and produce output 260 in accordance with the regular expression list 210. Since FLEX accommodates multiple regular expressions, it gives priority to the first expression listed in case more than one expression matches the input and uses the greedy strategy.

FLEX has two powerful features that are not typically found in other regular expression implementations. These are start conditions and trailing context. Both of these features require additional notation in the regular expression language and mechanisms to be added to the state machine engine for proper operation. The simplest form of a start condition has already been described, the caret operator, ‘\hat{ }’, when used as the first character of an expression. It establishes a leading context for the rest of the expression. In effect, it enables the remainder of the expression, i.e., “starts” it. It is considered context because the end-of-line symbol or symbols, signaling that subsequent characters are at the beginning of a line, is not included in the lexeme. The token assigned to such a lexeme carries the additional meaning that the lexeme is located at the beginning of a line. Start conditions generalize this capability.

Start conditions are typically represented by a name enclosed in angle brackets, e.g., ‘<SC-NAME>’. For clarity, all start condition names are capitalized in this description, but this is not a restriction of the feature. Any alphanumeric character string can be used to name a start condition and there is no limit on the number of names used. Start conditions must, however, be declared before being used. To use a declared start condition, it must be the first item in the expression. Also, multiple conditions may be listed within the angle brackets, e.g., ‘<COND1, COND2>’. Regular expressions without a start condition have the implied condition called INITIAL, which is a reserved name. INITIAL is the only condition active when the state machine begins processing new input. Activating a different start condition can only be done as the action taken when a particular lexeme is found. In the FLEX implementation, the notation used to indicate this is ‘{BEGIN(SC-NAME);}’ placed after the regular expression with at least one white space character between them. Only one condition can be active at a time. The example that follows illustrates the usage of this feature. For clarity in the example, further features are provided in the notation. Multiple actions can be included between the braces and a particular token may be returned by using the statement ‘OUTPUT (TOK-NAME);’, where TOK-NAME has been declared to have a particular numerical value.

Assume that the appearance of a variable name in a function argument versus anywhere else in the input is to be distinguished. Functions are assumed to have the form of a function name followed by its arguments enclosed in parentheses. In the following listing, lines are numbered for reference, but would not be included in the actual input. The declaration of the token names and values is not included below.

| 1 | %x FUNC_SC | | |
|---|---|---|---|
| 2 | %% | | |
| 3 | [a-zA-Z] [a-zA-Z0-9]* | { OUTPUT(VAR_NAME); | |
| | | } | |
| 4 | [a-zA-Z] [a-zA-Z0-9]*\( | { | BEGIN(FUNC_SC); |

| | | OUTPUT(FUNC_NAME); } |
|---|---|---|
| 5 | <FUNC_SC> [a-zA-Z] [a-zA-Z0-9]* | { |
| | | OUTPUT(FUNC_VAR_{—} |
| | | NAME); } |
| 6 | <FUNC_SC>\) | { BEGIN(INITIAL); } |

In the example, on line 1 the start condition FUNC_SC is declared to be exclusive (‘% x’) so that once it is active, the implicit INITIAL start condition becomes inactive. Line 2 separates the declaration from the list of regular expressions. The expressions on lines 3 and 4 are both initially active. The expression on line 3 will match any variable name while active and that on line 4 will find functions. Since parentheses have special meaning, a backslash is used to escape the meaning and convey to the compiler that a match to the opening parenthesis character is requested. Even though function names are also variable names, the greedy matching strategy assures that function names and variable names are distinguished. When the expression on line 4 is satisfied, the action taken is to activate the FUNC_SC start condition (disabling the INITIAL condition) and return a token indicating a function name was found. Now only the expressions on lines 5 and 6 are active. The expression on line 5 will find each instance of a variable name listed as a parameter of the function. Line 6 detects the closing parenthesis and switches the start condition back to INITIAL.

Trailing context is complimentary to leading context, but uses a different notation. The simplest form of trailing context has already been illustrated with the dollar sign operator. The general form uses the forward slash, ‘/’, to separate the main part of the expression from its trailing context. For example, if r₁ is an arbitrary regular expression and t₁ is another expression, then ‘r₁/t₁’ will find lexemes satisfying r₁ only if followed by t₁. However, none of the input used to satisfy t₁ is included in the lexeme identified. The token assigned to the lexeme identified by such means carries the additional meaning that the lexeme is known to be followed by the context specified. Subsequent processing of tokens can rely on this knowledge. Although trailing context is a useful feature, the cost of using it is having to backup in the input stream to the first character that follows the lexeme. This location is referred to as the trail head, because it is the beginning of the trailing context. The input that constituted the trailing context must now be processed by the collection of expressions.

To see an example of where this capability is useful, refer to the expression on line 4 above. Note that, on line 4, the opening parenthesis is included in the lexeme for the function name. Thus, if a symbol table is to be built, that character must be removed before the function name is stored. Using trailing context solves this problem as shown below.

| | | |
|---|---|---|
| [a-zA-Z] [a-zA-Z0-9]*/\( | { | BEGIN(FUNC_SC); |

OUTPUT(FUNC_NAME); }

In the above example, an opening parenthesis is required to follow a name, but the parenthesis is not included as part of the lexeme. The cost of using trailing context is low in this case since it is only necessary to back up one character. With regard to the greedy matching strategy, trailing context is included in the determination of which expression matched more input even if the lexeme associated with it matched less input.

In many regular expression languages oriented to processing one expression at a time, like Perl, leading context and trailing context are handled differently. Subexpressions are allowed, enclosed in parentheses for example, to appear anywhere within a regular expression. Subexpressions themselves can be any regular expression and there is no limit on the number that may occur in a single expression. Thus if r₁, r₂, and r₃ are arbitrary regular expressions, then the general form of a regular expression containing a subexpression is ‘r₁ (r₂) r₃’. r₁ is the leading context for r₂, and r₃ is the trailing context for r₂. The lexeme corresponding to r₂ is referenced by ‘\1’, where backslash signals an escape and the following digit is an index that selects subexpressions in order in which they occur. In the case of nesting, subexpressions are counted in the order in which the left parenthesis occurs. For example, a more complex expression containing three subexpressions is ‘r₁ (r₂ (r₃) r₄ (r₅) r₆) r₇’. The first subexpression, referenced by ‘\1’, is ‘r₂(r₃)r₄(r₅)r₆’, the second, referenced by ‘\2’, is r₃ and the third, referenced by ‘\3’, is r₅. This feature and those previously discussed have significant implications when implementing such capabilities in hardware, which will be addressed in more detail later.

A preponderance of the prior art regarding regular expressions prefers their implementation to be as software that runs on a general purpose computer. Although this allows the features provided to be rich and flexible, it has the limitation of being too slow to meet the needs of high speed network and server applications that were discussed earlier. Accordingly, a hardware implementation of the above-described regular expression methods is desired.

Among hardware implementations for regular expression processing in the prior art are a number of limitations and problems. In U.S. Patent Publication 2003/0204584 to Zeira et al. a generic architecture for a search engine that is analogous to a classical microcoded CPU architecture is described. In place of an arithmetic logic unit (ALU) is a character comparison unit. Logic is provided to fetch instructions from the microcode memory, decode various opcodes and defined fields in the instruction, and take actions based on the result of each character comparison, including determination of the next address from which to fetch the next instruction. The input is provided by a traffic control unit which is oriented toward receiving packets from a network. One drawback to this approach is its sequential nature. Multiple clock cycles are required per character in the input to read an instruction from memory, decode it, perform the indicated operation, calculate the next instruction address, and possibly write a result to memory. Accordingly, methods and systems that overcome this limitation are desired. For example, methods and systems are desired that use pipelining techniques to enable character processing at greater speeds than available in the prior art.

Another limitation of hardware implementations in the prior art is exemplified by US Patent Publication 2003/0051043 to Wyschogrod et al. An approach is described therein that processes N characters at a time, with a preferred implementation in which N=4 and each character is 8 bits. The approach is claimed to have “relatively small memory requirements.” However, comparison is made only to a brute force approach which no one practiced in the art would use, even in a software implementation. A more relevant comparison should be made to a one character at a time implementation. This issue may be further understood by considering the memory requirements of a basic state machine. Functionally, at least one memory location is required per possible transition per state. Thus, the brute force approach for single character processing uses 2ⁿ transitions per state for n bit characters, where n is typically 8. When processing one character at a time, 256 is a reasonable number, but depending on the number of states required, may still consume a great deal of memory. Four 8 bit characters may be considered to be a single 32 bit symbol, which implies the need for 2³² or over 4 billion transitions per state, which is inefficient and unreasonable.

Using an extension of a technique known in the art for reducing the number of possible out-transitions, Wyschogrod et al. teaches a method for reducing the total number of out-transitions implied by N characters to a manageable number for current memory technology. The technique for single characters, exemplified by the FLEX implementation, maps characters to character classes (symbol classes) in which all characters in the same class cause the same state transitions. Thus, the number of memory locations per state required is one per class. The actual number of classes needed depends on the regular expressions used. The less literal characters are used and the more wild cards are used, the fewer the classes. Text based applications may benefit greatly from this technique given that there are only 95 visible characters. In the worst case, in which every visible character and the end-of-line characters are in classes by themselves, the remaining 8 bit values can be mapped into a single class giving a 60% reduction in memory required. More typical is the case in which a few characters are used for keywords and a few visible symbols are used for delimiters. This leads to reduction in the number of classes to about 20 to 64, which is approximately ⅛^{th} to ¼^{th} the number of classes required in the brute force approach.

Wyschogrod et al.'s approach creates character classes per character per transition. The number of bits per character to represent the classes varies, but for the comparable text oriented application as above, the average number of bits per character would be 3 to 4. Given the preferred implementation of four characters, this is 12 to 16 bits or 2¹²=4096 to 2¹⁶=65,536 memory locations per state transition. This is 64 to 3200 times as much memory as the single character implementation. In addition, more memory is required for the class translation tables, where there is a table per state transition. Each table has 256 entries and each entry is as many bits wide as the sum of the number of bits required by each class. Processing two characters at a time leads to a range of 6 to 8 bits, which requires 64 to 256 locations per state plus the 256 word overhead of the class translation tables per state. This is 5 to 25 times the space required by the single character approach.

Using Wyschogrod et al.'s technique makes the problem tractable given the size of state of the art memory technology, but consistently requires substantially more memory per state than the equivalent byte oriented state machine. Given identical hardware memory resources, the multi-character technique severely limits the number of state transitions that can be supported, and thus the number and complexity of regular expressions, compared to the single character approach. Accordingly, hardware systems and methods that overcome these limitations are desired.

A further limitation exists for non-text applications, such as an anti-virus scanner, for example. Such non-text applications tend to look explicitly for byte sequences representing executable CPU code. Typical collections of virus signatures use 90% to 100% of all possible 8 bit values which leads to a character class per character. Accordingly, the above described table compression technique becomes less useful, essentially reducing the multi-character technique to the brute force approach.

The Wyschogrod et al. approach also requires more processing time per N characters. Normally, three cycles are required but Wyschogrod claims it can be reduced to two cycles using pipelining techniques. In summary, with two characters, the processing rate averages one character per instruction memory cycle at a cost of 5 to 25 times the memory or ⅕^{th to} 1/25^{th} the maximum state transition capacity. With four characters, the rate is two characters per instruction memory cycle at a cost of 64 to 3200 times the memory or 1/64^{th} to 1/3200^{th} the maximum state transition capacity. In this implementation, binary symbol applications, in which most symbol values are used, are impractical for more than two characters at a time, requiring over 65,000 memory locations per state transition. Accordingly, systems and methods that address these limitations are desired. For example, systems and methods are desired that incorporate novel techniques for pipelining and file segmentation, enabling characters to be processed at the rate of one character per instruction memory access and the same state memory requirement as the single character technique described above.

A further limitation of the prior art is in the hardware implementation for subexpressions. One such implementation is described in Patent Publication No. 2003/0123447 to Smith. One drawback of the teaching is that dedicated hardware is required for each subexpression. Thus the total number of subexpressions that can be handled at a time is limited by the hardware. Accordingly, systems and methods that address this limitation are desired. For example, systems and methods are desired that use start conditions and trailing context to achieve the same results provided by subexpressions with no limitations on the number of subexpressions used. In addition, systems and methods are desired that implement subexpressions without limitations on the quantities and types of subexpressions.

### SUMMARY OF THE INVENTION

In one embodiment, a method of recognizing a lexeme in a data file comprising a plurality of symbols comprises generating one or more regular expression queries, generating a deterministic finite automata (DFA) based on the regular expression queries, and executing the DFA on the data file, wherein the executing comprises identifying a first lexeme in the data file after processing one or more symbols of the data file, storing in a storage device a location in the data file associated with a last symbol of the first lexeme, processing one or more additional symbols of the data file, and determining if the first lexeme is a part of a second lexeme comprising the one or more additional symbols. In one embodiment, if the first lexeme is not a part of the second lexeme, reporting the identification of the first lexeme and continuing processing of additional symbols starting with a symbol immediately following the stored location.

In another embodiment, a method of recognizing a lexeme in a data file comprising a plurality of symbols comprises generating a regular expression query including a lexeme and a trailing context, wherein each of the lexeme and the trailing context includes one or more symbols, generating a deterministic finite automata (DFA) based on the regular expression query, executing the DFA on the data file, wherein the executing comprises identifying the lexeme in the data file after processing one or more symbols of the data file, storing in a storage device a trail head location indicating a position of the symbol immediately following the lexeme, processing one or more additional symbols of the data file, determining if the additional symbols match the trailing context, and if the additional symbols match the trailing context, reporting the identification of the lexeme.

In another embodiment, a compiler configured to generate a deterministic finite automata (DFA) based at least partly upon one or more regular expression queries comprises means for determining one or more non-terminal states that occur logically after a non-terminal accepting state and before either of (1) a next non-terminal accepting state or (2) a terminal state, and means for associating a state transition instruction of the non-terminal accepting state with each of the determined one or more non-terminal states.

In another embodiment, a method of removing stall states from a state machine comprises (a) identifying a non-terminal accepting state by searching one or more states downstream from an initial state, wherein a lexeme is associated with the non-terminal accepting state, (b) identifying a non-terminal non-accepting state downstream from the identified non-terminal accepting state, (c) associating information identifying the lexeme with the non-terminal non-accepting state, and (d) repeating steps b and c until another non-terminal accepting state or a terminal state is reached.

In another embodiment, a method of selecting one set of regular expression queries among a plurality of sets of regular expression queries comprises storing a plurality of regular expression queries in a computing device, receiving a data file comprising a plurality of symbols, identifying a start condition value in the received data file, and determining one set of regular expression queries that corresponds with the start condition.

In another embodiment, a method of switching between sets of regular expression queries comprises storing a plurality of sets of regular expression queries in a computing device, receiving a data file comprising a plurality of symbols, identifying a start condition value in the received data file, determining a set of regular expression queries that corresponds with the start condition, analyzing one or more symbols of the data file according to the determined set of regular expression queries, identifying, based on the one or more symbols of the data file, another set of regular expression queries, and executing the identified another set of regular expression queries.

In another embodiment, a method of lexically analyzing a data file comprises providing a first rule set corresponding to a first set of regular expressions, identifying a first lexeme in the data file according to the first rule set, based on the identified first lexeme, identifying a second rule set corresponding to a second set of regular expressions, and repeating the processes of identifying using the second rule set.

In another embodiment, a method of lexically analyzing a data file comprises (a) providing a N^{th} rule set corresponding to a N^{th} set of regular expressions, (b) identifying a N^{th} lexeme in the data file according to the N^{th} rule set, (c) based on the identified first lexeme, identifying a N+1^{th} rule set corresponding to a N+1^{th} set of regular expressions, (d) setting N equal to N+1, and (e) repeating steps b-d.

In one embodiment, a system for lexically analyzing a data file comprises (a) means for providing a N^{th} rule set corresponding to a N^{th} set of regular expressions, (b) means for identifying a N^{th} lexeme in the data file according to the N^{th} rule set, (c) means for identifying a N+1^{th} rule set corresponding to a N+1^{th} set of regular expressions based on the identified first lexeme, (d) means for setting N equal to N+1, and (e) means for repeating steps b-d.

In another embodiment, a system for locating one or more tokens in a plurality of data files each comprising a plurality of symbols comprises a storage device, such as a memory, for example, for storing at least a portion of one or more regular expression queries, a compiler configured to generate a deterministic finite automata (DFA) based at least partly upon the one or more regular expression queries, an execution engine configured to operate on the plurality of data files according to the DFA, wherein the execution engine is configured to process one symbol every M clock cycles, and a multiplexer coupled to the execution engine and configured to receive symbols from at least M of the plurality of data files, wherein the execution engine receives one symbol from each of the M data files at least every M clock cycles.

In one embodiment, a method for locating one or more tokens in M data files each comprising a plurality of symbols comprises receiving one or more regular expression queries, generating a deterministic finite automata (DFA) based at least partly upon the one or more regular expression queries, and operating on the plurality of data files according to the DFA, wherein the execution engine receives one symbol from each of the M data files at least every M clock cycles.

In another embodiment, a system for locating one or more tokens in M data files each comprising a plurality of symbols comprises means for receiving one or more regular expression queries, means for generating a deterministic finite automata (DFA) based at least partly upon the one or more regular expression queries, and means for operating on the plurality of data files according to the DFA, wherein the execution engine receives one symbol from each of the M data files at least every M clock cycles.

In another embodiment, an apparatus for processing a single data file comprising a plurality of symbols comprises a segmenter configured to divide the file into M segments, a plurality of M storage locations each configured to buffer portions of one of the M segments, and a core execution unit configured to execute a state machine, wherein movement from a current state to a next state in the state machine requires M clock cycles, the core execution unit comprising a memory for recording information indicating one or more boundaries between the M segments, wherein the core execution unit reads a symbol from one of the plurality of M storage locations during each clock cycle.

In another embodiment, a method of representing a state machine comprises (a) determining a number M of out transitions from a N^{th} state in the state machine, (b) generating an instruction corresponding to each of the M transitions from the N^{th} state, wherein each of the instructions includes an indication of a next state in the state machine, (c) repeating steps a and b for each of the states of the state machine, and (d) storing at least some of the instructions for each of the states of the state machine in a memory, wherein the indication of the next state in the one or more instructions is usable to determine an address of the next state in the memory. In one embodiment, for a particular state in the state machine, only one of the M transitions from the particular state is not a failure transition and the M-1 failure transitions are combined in a single instruction for storage in the memory. In another embodiment, for a particular state in the state machine, only two of the M transitions from the particular state are not failure transitions and the M-2 failure transitions are combined in a single instruction for storage in the memory.

In another embodiment, a method of moving between a plurality of states of a state machine, wherein a plurality of instructions indicate transitions between states of the state machine, comprises selecting an instruction corresponding to a transition from a first state, wherein the selecting is based, at least partly, on one or more current symbol classes, setting an offset according to one or more of the current symbol classes and one or more fields of the selected instruction, and determining an address of a next state by adding the offset to an address of the selected instruction. In one embodiment, at least one of the instructions is a virtual terminal instruction, wherein the virtual terminal instruction includes (a) information indicating an output that corresponds to the state associated with the virtual terminal instruction and (b) information usable to determine a next initial state, wherein by executing the virtual terminal instruction, a transition is made directly to the next initial state and the output is produced in a single clock cycle.

In one embodiment, a state machine comprises a plurality of instructions, each instruction representing a transition from one state to another state in a state machine, and a virtual terminal instruction including (a) information indicating an output that corresponds to a state associated with the virtual terminal instruction and (b) information usable to determine a next state, wherein by executing the virtual terminal instruction, in a single clock cycle the state machine transitions from the state associated with the virtual terminal instruction to the determined next state.

### BRIEF DESCRIPTION OF THE DRAWINGS

FIG. 1a is a state machine diagram including states that correspond to the regular expression ‘(t|T)he□*cat’.

FIG. 1b is a state machine diagram that is functionally equivalent to the state machine in FIG. 1a, but including the implied failure transitions not shown in FIG. 1a.

FIG. 2 is a block diagram illustrating a system for compiling and using regular expressions.

FIG. 3 is a state machine diagram that illustrates the situation where multiple expressions are satisfied by a portion of a data stream.

FIG. 4 is a hardware block diagram illustrating one embodiment of the state machine engine of FIG. 2.

FIG. 5a is a state machine diagram for the regular expression ‘near/“□”+=’.

FIG. 5b is a state machine diagram that compiles the two regular expressions given in FIG. 3 with the one from FIG. 5a, namely ‘near’, ‘nearer’, and ‘near/“□”+=’.

FIG. 6a is a block diagram illustrating an instruction format for each of non-terminal and terminal instructions.

FIG. 6b is a state machine diagram illustrating the correspondence between state transitions and instructions.

FIG. 6c is a redrawn version of FIG. 6b illustrating how instructions may be organized in a memory.

FIGS. 7a and 7b illustrate five exemplary instruction formats.

FIG. 8 is a block diagram illustrating the basic organization of a State Table Memory of FIG. 4.

FIG. 9 is a block diagram illustrating four exemplary Next State Block Structures for the three non-terminal format instruction types of FIG. 7a, discussed with respect to FIG. 8.

FIG. 10 is a block diagram illustrating an exemplary organization of data within the structure illustrated in FIG. 8.

FIG. 11 is a block diagram illustrating a basic register set that may be contained in the Core Execution Unit of FIG. 4.

FIG. 12 is a block diagram illustrating an exemplary embodiment of the basic register set of FIG. 11 that may be contained in a Core Execution Unit of FIG. 4.

FIG. 13 is a modified version of the state machine engine of FIG. 4 that processes a single input stream M times faster than an individual input stream is processed by the state machine engine of FIG. 4.

FIG. 14a is a state machine with sixteen states numbered from 0 to 15 and illustrates a state machine in which stall conditions may be removed.

FIG. 14b is a state machine with ten states numbered from 0 to 9 and illustrates a state machine in which some stall conditions remain.

FIG. 15a is a flowchart illustrating an exemplary algorithm for removing stall conditions from a state machine.

FIG. 15b is a flow chart illustrating an exemplary method for processing unchanged terminal states, including unvisited or visited but unchanged states.

FIG. 15c is a flow chart illustrating an exemplary method for processing terminal states that have been visited and changed.

FIG. 15d is a flow chart illustrating an exemplary method for processing unvisited non-terminal states.

FIG. 15e is a flow chart illustrating an exemplary method for processing visited non-terminal states.

FIG. 16a is the state machine of FIG. 14a with the symbol class numbers on each transition relabeled.

FIG. 16b is the state machine of FIG. 14a with the status of registers related to certain states updated to illustrate their status at a particular point of execution of the stall removal algorithm.

FIG. 16c is the state machine of FIG. 14a with the status of registers related to certain states updated to illustrate their status after completion of the stall removal algorithm.

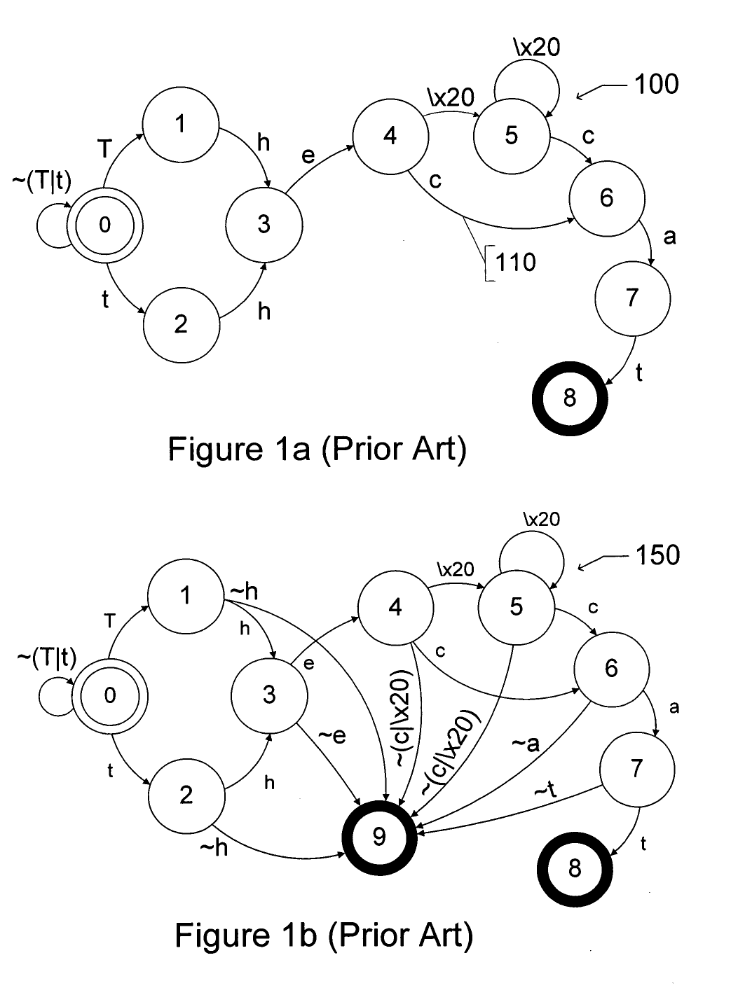

### DETAILED DESCRIPTION OF CERTAIN EMBODIMENTS OF THE INVENTION

Embodiments of the invention will now be described with reference to the accompanying figures, wherein like numerals refer to like elements throughout. The terminology used in the description presented herein is not intended to be interpreted in any limited or restrictive manner, simply because it is being utilized in conjunction with a detailed description of certain specific embodiments of the invention. Furthermore, embodiments of the invention may include several novel features, no single one of which is solely responsible for its desirable attributes or which is essential to practicing the inventions herein described.

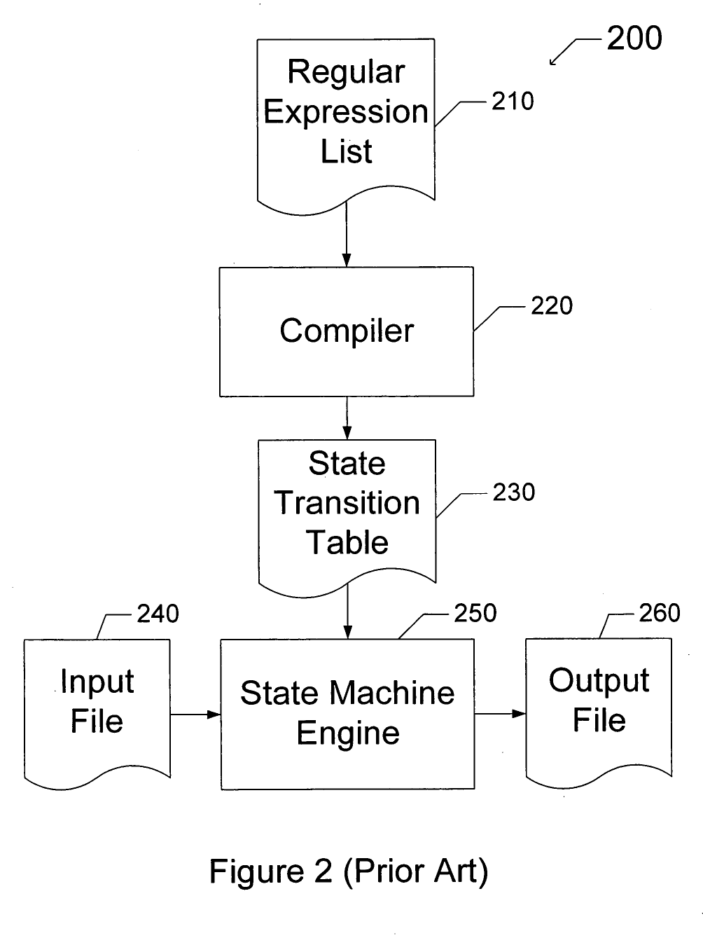

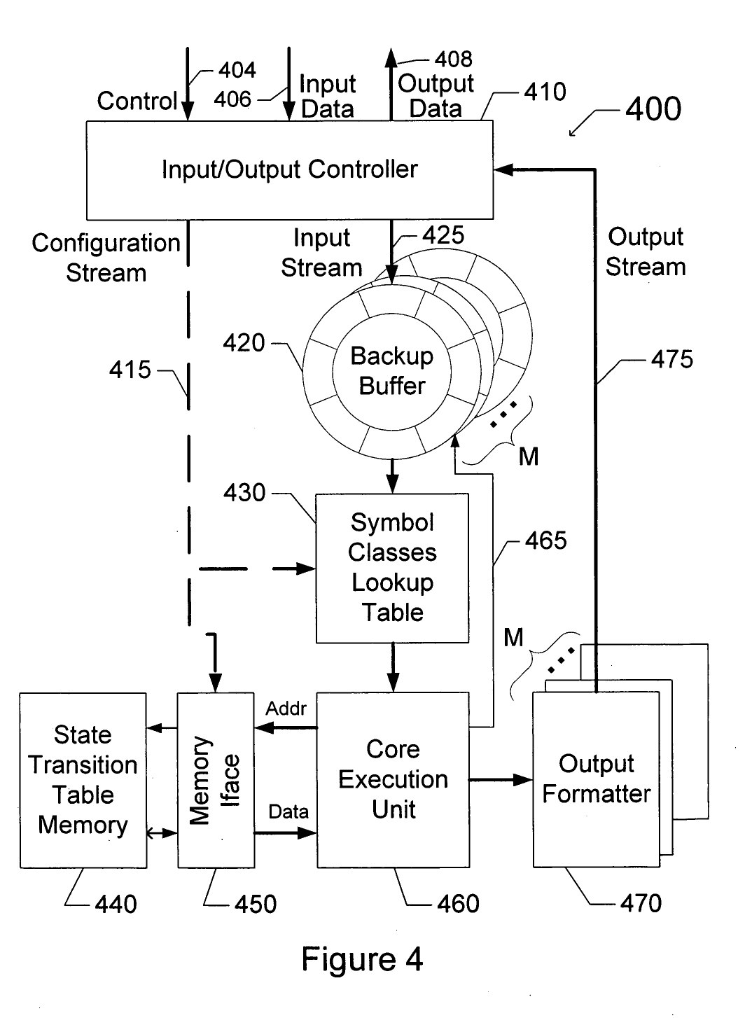

FIG. 4 is a hardware block diagram of a State Machine Engine 400 that is one embodiment of the state machine engine 250 of FIG. 2. In the exemplary embodiment of FIG. 4, the State Machine Engine 400 includes an Input/Output Controller 410 configured to receive Control signals 404 and Input Data 406, and further configured to send Output Data 408. The Input/Output controller 410 is further configured to transmit an Input Stream 425 to a Backup buffer 420 that may include M backup buffers 420. The Backup Buffer 420 is in communication with a Symbol Classes Lookup Table 430 that is accessed to lookup one or more classes corresponding to symbols. The Symbol Classes Lookup Table 430 outputs the lookup information to a Core Execution Unit 460, which is in communication with the Backup Buffer 420. The Core Execution Unit 460 is further in communication with a Memory Interface 450 that interfaces with a State Transition Table Memory 440 and an Output Formatter 470. The Output Formatter 470 provides an output to the Input/Output Controller 410 which may then be transmitted as Output Data 408. Each of these components will be described in further detail below.

In the exemplary embodiment of FIG. 4, the State Machine Engine 400 is designed to process M files simultaneously, where M is 1 or more. If M is 1, a conventional implementation results that processes one file at a time. However, if M is 2 or more, the single clock cycle context switching capability allows the processing resources to be more fully utilized. The optimal value for M is the number of clock cycles required to process one symbol, where the number of clock cycles required to process one symbol is variable depending on the technology used for each implementation. By processing M files simultaneously, a net throughput of one symbol per clock cycle may be achieved. An appropriate value for M may also be determined by the application, the other hardware to which the state machine engine 400 is to be interfaced, and/or the other hardware's ability to drive multiple input streams and receive multiple output streams.

In some embodiments, the combination of the Control signals 404 and the Input Data 406 may be used for several purposes. For example, in one embodiment, the Control signals 404 and the Input Data 406 are used to configure internal registers of the Input/Output Controller 410 in preparation for initializing a State Transition Table Memory 440 and a Symbol Classes Lookup Table 430 (discussed further below). In another embodiment, the Control signals 404 and the Input Data 406 are used to configure other internal registers of the Input/Output Controller 410 for access to any of a multiplicity of M Input Streams 425 to be delivered to a corresponding M Backup Buffers 420. Optionally, the configuring of the M Input Streams 425 may include setting control bits to selectably enable or disable features and modes related to the operation of the Backup Buffers 420, a Core Execution Unit 460 and/or any of a multiplicity of Output Formatters 470. In another embodiment, the Control signals 404 and the Input Data 406 are used to configure still other internal registers of the Input/Output Controller 410 for delivery of M Output Streams 475 generated by the corresponding M Output Formatters 470.

Once configured, the Input/Output Controller 410 generates and outputs a Configuration Stream 415 that is used to initialize the Symbol Classes Lookup Table 430 and the State Transition Table Memory 440. The Memory Interface 450 provides means for sharing access to the State Transition Table Memory 440 between the Input/Output Controller 410 and the Core Execution Unit 460. The Input/Output Controller 410 manages the M Input Streams 425, delivering each to the corresponding one of a multiplicity of M Backup Buffers 420. Each of the Backup Buffers 420 is designed to contain only a portion of one of the M input streams, so the Input/Output Controller 410 refills the Backup Buffers 420 as consumption of its contents crosses a predetermined threshold. In one embodiment, managing the M Input Streams 425 includes disabling various resources when there are fewer than M active streams. Managing the M Input Streams 425 may also include incrementally adding new streams without disturbing any other active streams that are in progress. In another embodiment, managing the M Input Streams 425 also includes incrementally shutting down streams that have completed without disturbing any other active streams that are in progress.

In the exemplary embodiment of FIG. 4, the Input/Output Controller 410 is also configured to receive and manage the M Output Streams 475. Managing the Output Streams 475 may include monitoring the M Output Formatters 470 to determine when the results are ready to be sent as the Output Data 408. In one embodiment, managing the M Output Streams 475 includes coordinating with the status of each of the corresponding M Input Streams 425. The Output Data 408 corresponding to a particular data stream may begin transmission before the entire particular data stream has been received by the Input/Output Controller 410. Alternatively, the Output Data 408 may not be initiated until all corresponding input has been received and processed.

The Backup Buffers 420 have several distinctive features. In one embodiment, each of the Backup Buffers 420 is a circular buffer design in which the newest incoming data replaces the oldest stored data. Alternatively, any other buffer type may be used to temporarily store data from the Input Stream 425. In one embodiment, the Backup Buffers 420 are configured to receive multiple symbols per clock cycle and deliver one symbol of output per clock cycle. In another embodiment, the Backup Buffers 420 are accessible by random access, thus allowing the Core Execution Unit 460 to backup to any location in the buffered data. In another embodiment, the Backup Buffers 420 are configured to detect end-of-line symbols and set an extra bit accompanying each symbol, called the beginning-of-line flag, to signal whether that symbol is the first one on a line. In another embodiment, the Backup Buffers 420 are configured to detect the end of one of the active input streams and signal the Core Execution Unit 460. In another embodiment, the Backup Buffers 420 are configured to deliver one or more EOF (end-of-file) meta-symbols, which are distinguishable from actual symbols, after all actual symbols in an input stream have been delivered. A meta-symbol is outside of the symbol alphabet recognized by a state machine. It is used for signaling and control purposes internal to a state machine engine, in this case, to mark an end of an input stream. Thus, the set of M Backup Buffers 420 contain a means of successively outputting the next symbol requested by the Core Execution Unit 460, one symbol per buffer in round robin fashion, in synchronization with the other units in the State Machine Engine 400 in support of single cycle context switching.

In the exemplary embodiment of FIG. 4, the Symbol Classes Lookup Table 430 is comprised of at least one 2ⁿ entry table where n is the number of bits used to represent each symbol. For example, if the symbols are bytes, the table will contain 256 entries. In this embodiment, the table is wide enough to represent the worst case number of symbol classes, which is n bits. In another embodiment, the table is wide enough to additionally represent an EOF meta-symbol with a distinct equivalence class value. In other embodiments, the table width may be extended to accommodate one or more alternate symbol class mappings. In that case, means are included for selecting the desired mapping. An example of such a use is to create a case sensitive symbol class mapping and a second, case insensitive symbol class mapping. In one embodiment, the selection means consists of a configuration bit in the Input/Output Controller 410, with a selection made for each input stream. In another embodiment, different selection means are provided in the Core Execution Unit 460 for interpreting a bit in certain instructions in the State Transition Table Memory 440 that controls case sensitivity on each transition.

In the exemplary embodiment of FIG. 4, the Core Execution Unit 460 is responsible for executing a state machine represented by a sequences of instructions stored in the State Transition Table Memory 440. The execution of these instructions may consist of several operations. One of the operations is fetching an instruction from the State Transition Table Memory 440 based on a computed next state address. The initial state is typically initialized to 0, or alternatively may be initialized to some other predetermined fixed value for a first access. The initialization value may alternatively be determined by a value in a configuration register in the Input/Output Controller 410. The Core Execution Unit 460 is configured to decode the fetched instruction. The Core Execution Unit 460 may further be configured to fetch a symbol from one of the Backup Buffers 420, lookup the corresponding symbol in the Symbol Classes Lookup Table 430, convert it to one or more class values, and select a single class value to represent the fetched symbol when there is more than one class from which to choose. In another embodiment, the Core Execution Unit 460 determines the next state address based on the interpretation of the instruction fetched and the symbol class selected.

In another embodiment, the Core Execution Unit 460 stores a location of one or more last accepting states for each input stream. The Core Execution Unit 460 may also be configured to store a location of a trail head if trailing context has been encountered. In one embodiment, the Core Execution Unit 460 changes the start condition after an accepting state is reached if the decoded instruction so indicates. The Core Execution Unit 460 may further be configured to select an appropriate initial state based on the active start condition after an accepting state is reached. In one embodiment, the Core Execution Unit 460 selects an alternate start state if the beginning-of-line flag associated with the fetched symbol is true after an accepting state is reached. In another embodiment, the Core Execution Unit 460 sends an output to the correct Output Formatter 470 when an accepting state is reached if so indicated by the decoded instruction. In another embodiment, the Core Execution Unit 460 is configured to multiplex the processing of up to M Input Streams 425, so that each clock cycle a symbol from each stream in turn is accepted for processing.

In one embodiment, reaching the accepting state implies that a lexeme, consisting of a sequence of symbols, has been identified in the input stream. The output may comprise any one or more of various possible components. For example, the output may include a token value associated with the accepting state that also corresponds to a regular expression that was accepted. The output may also include a start location of the identified lexeme, an end location of the identified lexeme, a count of the number of symbols in the lexeme, the literal symbols composing the lexeme, and/or a parameter associated with the lexeme that may facilitate further processing of the output stream. The output may further comprise any other information related to the located lexeme or the input stream.

In the exemplary embodiment of FIG. 4, the multiplicity of M Output Formatters 470 captures the information output by the Core Execution Unit 460. In an advantageous embodiment, each of the M Output Formatters 470 captures only the output associated with the individual Input Stream 425 for which it is responsible. In one embodiment, each of the M Output Formatters 470 is capable of performing a variety of formatting and organizing operations on the output it receives. For example, the formatting may include padding data values with zero value bits to a predetermined larger fixed length, packing one or more data values into a single larger word, performing arithmetic operations on any of the data values, truncating a lexeme by a fixed amount on either or both ends, and/or truncating a lexeme by an amount determined by one or more of the data values on either or both ends. The organizing operations that may be performed by the M Output Formatters 470 may include rearranging the order in which the data values are stored, changing the byte order of multibyte words, adding null words to enforce a desired byte or word alignment, buffering output until the Input/Output Controller 410 can forward the Output Stream 475 to the receiver, and/or supplying as many bytes of output per clock cycle as required by the receiver of the Output Data 408. In another embodiment, the M Output Formatters 470 may maintain a bit vector in which there is one bit associated with each possible regular expression that could be matched. As part of the initialization that may occur before processing begins on a new input stream, every bit in the vector is set to 0. As each token is reported, the bit with which it is associated is set to 1. Those of skill in the art will recognize that the M Output Formatters 470 may be configured to format and organize data according to the specific implementation requirements of the State Machine Engine 400 or requirements of one or more specific data streams.

To better understand the processing required by regular expressions with trailing context, an example of a state machine 500 is shown in FIG. 5a for the regular expression ‘near/“□”+=’. Double quotation marks surround the space character for clarity, but are a common notation for specifying that all contained characters are to be given their literal meaning. State machine 500 consists of seven states numbered from state 0 to 6. This regular expression is intended to find the lexeme ‘near’, but only if it is followed by one or more spaces and an equal sign. State 4 is shown as a square to indicate that any non-failure out-transition from it will be caused by the trail head symbol, in this example, a space, shown by its hexadecimal ASCII value, ‘\x20’. For that reason, state 4 is referred to as a trail head state. In an advantageous embodiment, the state machine engine stores the location of the trail head symbol in case accepting state 6 is reached. State 6 is shown as a square inside a thick lined circle to signify that it is the accepting state for an expression with trailing context and must therefore be handled differently than an ordinary accepting state. This is referred to as a trailing context terminal state. When state 6 is reached, the lexeme ‘near’ is reported as output, the input stream is backed up to the location of the trail head symbol previously stored, and the next state is reset to the initial state 0. If the end location of the lexeme is reported as part of the output information, it may be calculated by subtracting one from the trail head location.

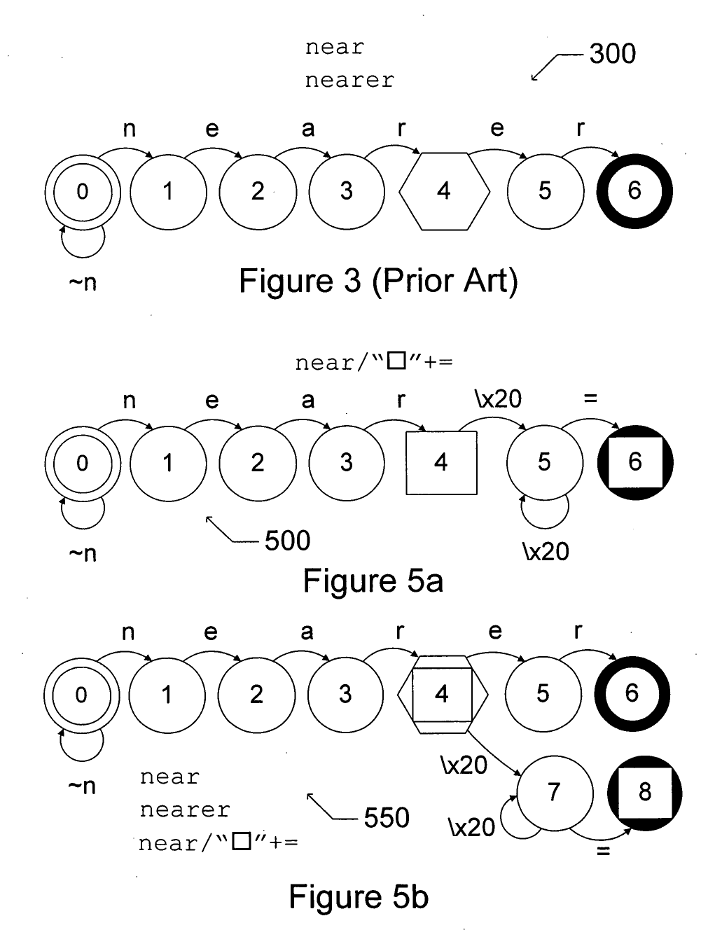

A more complex example is illustrated in FIG. 5b for state machine 550 which results from compiling the two regular expressions given in FIG. 3 with the one from FIG. 5a, namely ‘near’, ‘nearer’, and ‘near/“□”+=’. State machine 550, consisting of states 0 through 8, is able to distinguish between each of these closely related expressions. All three expressions have the same four characters to begin, so can share states 0 through 4. State 4 is shown as a square inside a hexagon to denote that state 4 is both a non-terminal accepting state and a trail head state. In an advantageous embodiment, when the state machine engine reaches state 4 a flag is set to indicate that state 4 is a last accepting state. The location of the next character may also be stored as well as the trail head location. If state 6 is reached, ‘nearer’ will be reported as the expression matched and the next character in the input stream will be processed without any backing up. However, if the trailing context terminal state 8 is reached, ‘near/“□”+=’, will be reported as the expression matched and the next character location will be retrieved by backing up to the stored trail head location. If a failure occurs in any of states 4, 5, or 7, ‘near’ will be reported as the expression matched and the next character location will be retrieved by backing up to the stored last accepting state location. In all cases, the next state is the initial state 0.

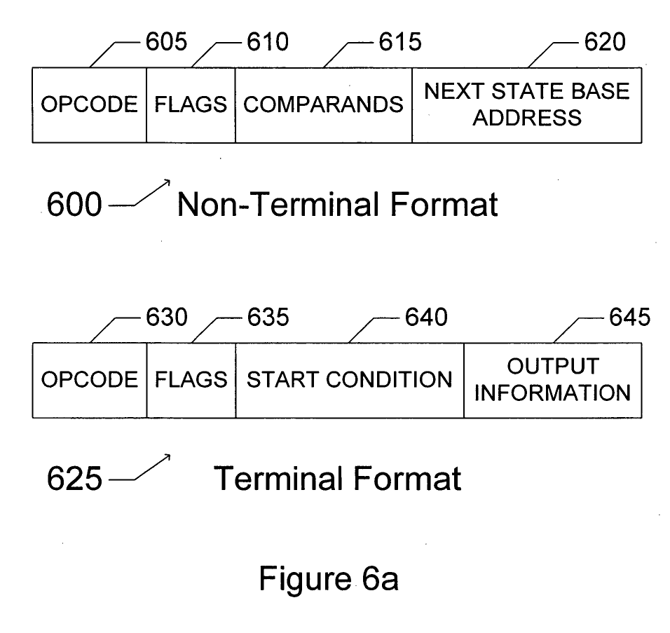

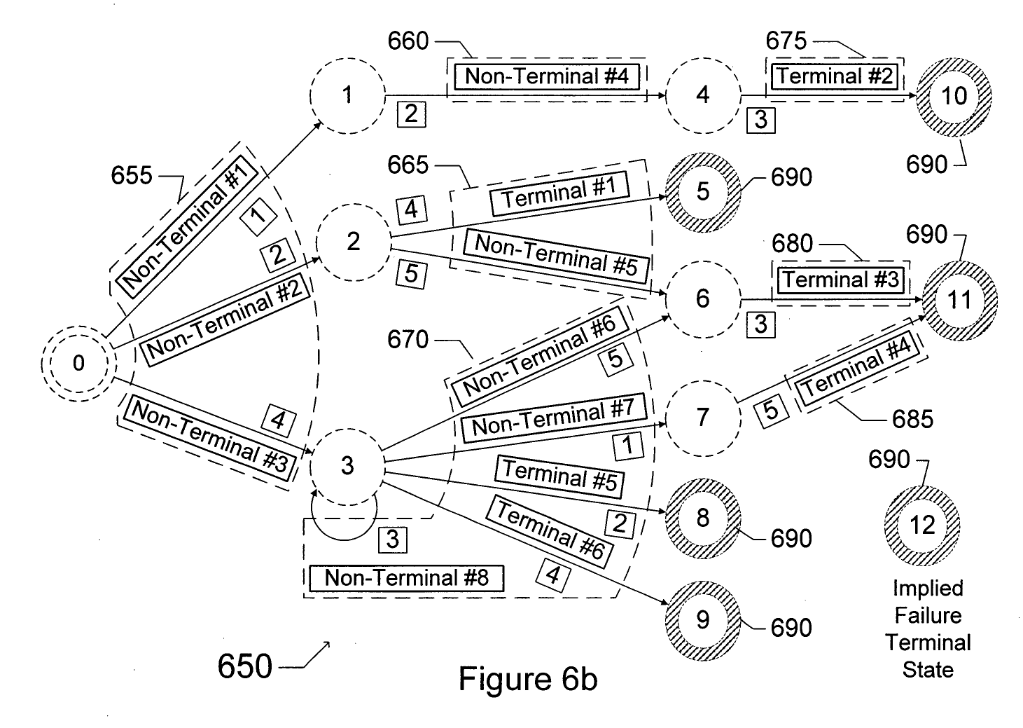

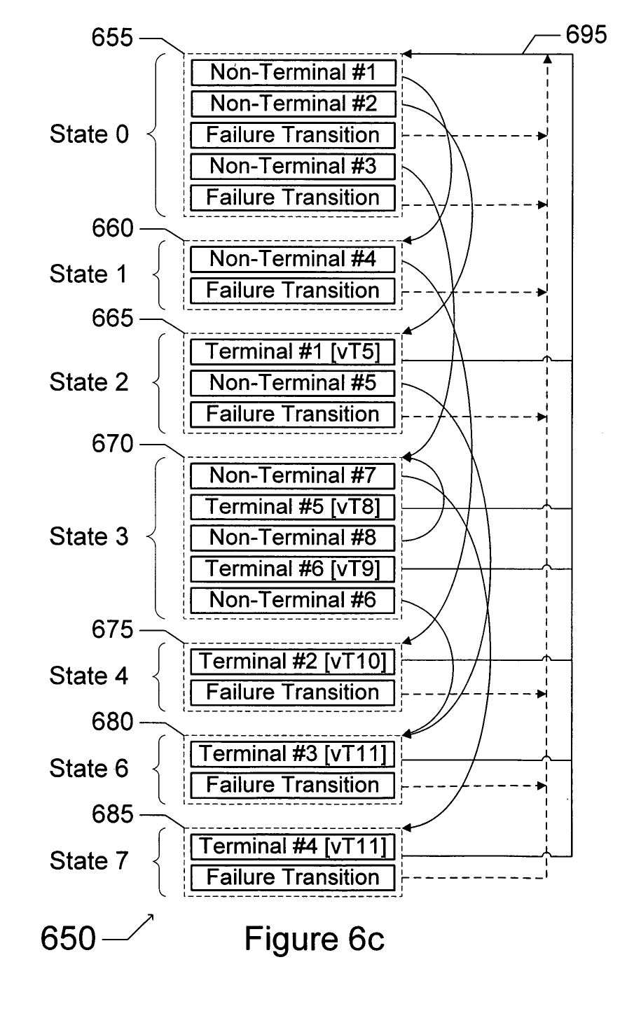

As indicated previously, a state machine to be executed by a state machine engine is represented by a sequence of instructions stored in a state transition table memory. The two basic instruction formats needed are illustrated in FIG. 6a. A Non-Terminal Format 600 is used to represent a transition to a state that has one or more out-transitions. A Terminal Format 625 is used to represent a transition to a terminal state. In one embodiment, an Opcode field 605 in the Non-Terminal Format 600 and an Opcode field 630 in the Terminal Format 625 distinguish the two formats from one another. Furthermore, the Opcode field 605 may also be used to distinguish between one or more variants of the non-terminal format type instruction. The Flags field 610 may consist of any combination of control bits and multi-bit subfields to signal the state machine engine to perform selectable operations, such as causing the last accepting state information to be stored, causing the trailing context information to be stored, selecting from multiple symbol class mappings, and/or specifying case sensitivity.

In the embodiment of FIG. 6a, the Non-Terminal Format 600 includes a Comparands field 615. The Comparands field 615 is optional and may not be used in some implementations. If included, the Comparands Field 615 may enumerate one or more symbol classes that correspond to the only out-transitions available from this state. Alternatively, the Comparands Field 615 may contain parameters that are used to determine which out-transition to take, given the current symbol class.

In one embodiment, a Next-State Base Address 620 points to a location in the state transition table memory that is the beginning of a block of instructions that indicate the disposition of every possible out-transition from this state, using at most one instruction per transition. Any of the instructions in the block may have any defined format. Any block that may be associated with a non-terminal accepting state also has provision for an additional terminal format instruction indicating what actions are to be taken if the state machine engine determines this state is to be treated as an accepting state. This special terminal format instruction is referred to as an accepting state transition instruction. Thus, at most, there are S+1 instructions in the block if there are S symbol classes.

As described above, in one embodiment, an Opcode field 630 of the Terminal Format 625 distinguishes an instruction in the terminal format from an instruction in the Non-Terminal Format 600. Furthermore, the Opcode 630 may be used to distinguish between one or more variants of the terminal format type instruction. The Flags field 635 may consist of any combination of control bits and multi-bit subfields to signal the state machine engine to perform selectable operations. These operations may include, for example, (1) backup in an input stream to the symbol immediately following the previous start location as a result of failing to identify a lexeme that begins with the symbol that was at that location, (2) backup in an input stream to a stored trail head location, (3) backup in an input stream to a stored last accepting state symbol location, (4) continue with the next symbol in an input stream without backing up, (5) change the start condition used to select an initial state, (6) use the previous start condition to select an initial state, (7) cause output information to be sent to an output formatter, (8) suppress sending output to an output formatter, (9) stop processing the current input stream, and (9) stall an input stream for one clock cycle and retrieve a terminal format accepting state transition instruction, included in a next-state block of instructions associated with a non-terminal accepting state. This operation can occur when the non-terminal accepting state is to be treated as a terminal state.

The Start Condition field 640 contains the number of a new start condition. In one embodiment, the Start Condition field 640 is accessed only if an associated flag enables it. The Output Information field 645 contains any data that is to be associated with this terminal state if it is reached. Upon being fetched and decoded, the state machine engine may transfer the contents of the Output Information 645 field to an output formatter. Optionally, this action may be controlled by a defined bit in the Flags field 635.

Each instruction, regardless of type, represents a transition from one state to another in a state machine. If more than one symbol class value can cause the transition, then there may be an instance of an instruction for each such symbol class. Alternatively, there may be a single instruction that represents all such symbol classes that can cause the transition. Use of both implementations may be mixed in a system. In all cases, the number of instances required is determined according to instruction type and the means used to choose a next state transition.

There is no single entity that represents a state. Rather, a state is represented by a set of instructions associated with transitions into the state (referred to herein as “in-transitions”) and a set of instructions associated with transitions out of the state (referred to herein as “out-transitions”). In an advantageous embodiment, each instruction associated with an in-transition to the same state, regardless of the origin of the transition, is identical to the others. The information contained in each such instruction includes next state information corresponding to the next state. This next state information enables a state machine engine to find the location of the instructions associated with the out-transitions and to select one of them based on the present input, such as a symbol class associated with the present input symbol. The set of instructions associated with out-transitions from a state is referred to as a next-state block. In one embodiment, the instructions in a next-state block contain information regarding the possible next states from the state whose out-transitions they are associated. However, the next-state block may contain information regarding the state whose out-transitions they are associated with if one or more particular instructions are associated with an in-transition back to that state. In an advantageous embodiment, the order in which the instructions are listed in the next-state block are in accordance with the state type and the information in an instruction associated with any in-transition to the state. The means prescribed by the in-transition instruction to select an out-transition based on the present input determines their order.

In the conceptual model of a state machine, a terminal state has no out-transitions, which implies that processing stops when it is reached. However, in an implementation, there is an implied transition back to an initial state. If there are multiple initial states, then a means should be provided for choosing one of them after reaching a terminal state. In one embodiment, a Terminal format instruction identifies the location of an initial state selection block of instructions associated with transitions from a terminal state to each possible initial state and information that a state machine engine can interpret to select one of the initial states. Each instruction in the initial state selection block identifies the location of a next-state block associated with an initial state. Thus the terminal state exists by virtue of the terminal format instructions associated with its in-transitions and the instructions associated with the implied out-transitions from it. In an advantageous embodiment, the terminal states are made virtual by combining the in-transitions with the implied out-transitions. This may be accomplished by including all the information needed for both the in-transitions and the out-transitions into a single terminal format instruction associated with an in-transition of a terminal state. The instruction associated with an in-transition contains information pertaining to any output that would be produced as a result of reaching its associated terminal state. The information pertaining to the location of an initial state selection block that was required in the previously described embodiment, is replaced with the information needed to choose an initial state directly, which was previously associated with the out-transitions. Thus, by executing a single terminal format instruction so constructed, a transition is made directly to an initial state and at the same time, all events associated with reaching the terminal state occur. This has the advantage of eliminating one execution clock cycle in a state machine engine each time a terminal format instruction is executed. A state machine represented by sets of instructions where terminal format instructions are defined this way is said to have virtual terminal states. In effect, a state machine engine spends zero time in a terminal state, but in transitioning from a non-terminal state to an initial state, the result is the same as if it had visited the terminal state.

When a state machine engine is fetching and executing instructions from a state transition table memory, which represents a state machine, the engine may be said to be in state x of the state machine after an in-transition associated with state x has been executed and while one of the out-transition instructions associated with the next-state block of state x resides in an instruction register and is in the process of being executed. In one embodiment, in which terminal states are not virtual, the state machine engine is said to be in terminal state y after execution of a terminal format instruction associated with state y and while an out-transition of an initial state selection block resides in an instruction register and is in the process of being executed. In an advantageous embodiment, where terminal states are virtual, the state machine engine is in terminal state y for zero time between being in a non-terminal state x, whose next-state block contained the terminal format instruction associated with terminal state y and in an initial state z, by virtue of having fetched an instruction from a start-state block associated with initial state z. Alternatively, a state machine engine may be thought of as simultaneously in non-terminal state x and terminal state y. Due to the parallel processing nature of a hardware implementation, a state machine engine in state x with the terminal format instruction associated with state y in an instruction register, may simultaneously produce output information according to the instruction as if it were in terminal state y and calculates a next state address that will cause transition to initial state z. From the point of view of a state machine, at a point in time, the machine is in one of its states, it receives a symbol input, and it transitions to another state. From the discussion above, there is an established one-to-one correspondence between the conceptual operation of a state machine and the execution of instructions in a state machine engine. In all of the discussion that follows, for clarity, the point of view of a conceptual state machine is used, in which it is understood that there is a corresponding condition in a state machine engine executing instructions that represent the state machine.

An example is shown in FIG. 6b that illustrates the relationship between a state machine 650 and a set of instructions that represent the machine using the advantageous embodiment just described. FIG. 6c is a redrawn version of state machine 650 showing only the instructions, which have been arranged as they might be stored in a State Transition Table Memory 440 (FIG. 4). FIG. 6c explicitly includes the implied failure transitions not shown in FIG. 6b. The implicit failure transitions are to an implied 13^{th} state (state 12) which is the failure terminal state. Thus, all failure transitions shown are identical and have a terminal format. Without loss of generality, for this example there are assumed to be five symbol classes numbered 1 through 5 which are shown near each transition arc in FIG. 6b in square boxes. This discussion is equally applicable to implementations that do not use symbol classes. In such a case, each state should have an explicit or implicit transition for every symbol in the alphabet used.

State machine 650 (FIG. 6b) is composed of thirteen states numbered from 0 to 12. State 0 is the initial state, states 1 through 4, 6, and 7 are non-terminal states, and states 5, and 8 through 12 are terminal states 690. All states are shown with dashed lines to indicate that they are not entities unto themselves. Rather, they exist by virtue of the collection of instructions 655, 660, 665, 670, 675, 680, and 685 (FIGS. 6b & 6c). There is a one to one correspondence between each transition in a state machine and an instruction, including the implied failure transitions to failure terminal state 12. For example, the initial state 0 is represented by a set of instructions 655. The set is composed of three instructions, Non-Terminal #1 through #3. Symbol class 1 causes a transition from state 0 to state 1, so when symbol class 1 is the present input to the state machine which is in state 0, a state machine engine should fetch and execute instruction Non-Terminal #1. Similarly, symbol class 2 should cause the execution of Non-Terminal #2 and symbol class 4 the execution of Non-Terminal #3. Since there are five symbol classes, every state should have a set of associated instructions that indicate what is to occur when any of the possible symbol class values is a present input. In the case of initial state 0, since only three out-transitions are shown, it is implied that there are two failure transitions corresponding to symbol classes 3 and 5, to the implied failure state 12. In FIG. 6c, the complete set of instructions 655 that comprise the state 0 next-state block are shown with the implicit failure transitions included. The order in which the instructions are placed is according to the value of the present input, i.e., symbol class. This organization allows a state machine engine to calculate the address of the instruction to fetch by adding the symbol class minus one to the base address of the next-state block, assuming each instruction occupies one memory location. An equally simple calculation results as long as all instructions types require the same number of memory locations for storage. In general, if each instruction requires k words of memory for storage, s is the symbol class value, and BA is the base address, the location of the first word of the instruction to fetch is BA+k*(s−1). This next-state block organization is an example of using multiple instances of the same instruction, the failure transition, so there is one instruction per symbol class.

State 3 in FIG. 6b has five out-transitions with associated instruction set 670, consisting of Non-Terminals #6 through #8 and Terminals #5 and #6. In this case there is one explicit instruction per symbol class. The organization of next-state instructions 670 shown in FIG. 6c is the same as that for initial state 0 where they are placed in order according to corresponding symbol class value. The transition for symbol class 3 is back to state 3, so Non-Terminal #8 is identical to Non-Terminal #3. Each defines state 3 to be a non-terminal type and that the next state selection means is to use the present input symbol class as an offset from the base address of state 3's next-state block. In FIG. 6c, each terminal type instruction is additionally labeled with the virtual terminal state it implicitly contains in square brackets. Hence, the next-state block 670 shows Terminal #5 with [vT8] which corresponds to state 8 in FIG. 6b, and Terminal #6 with [vT9] which corresponds to state 9.

State 1 in FIG. 6b has one explicit out-transition and four implicit failure transitions with associated instruction set 660, consisting of Non-Terminal #4 and the implicit failure transitions. In this case, symbol class 2 is the only one of interest. This suggests an alternative memory organization for the next-state block 660 which is illustrated in FIG. 6c. In this case only one instance of the implicit failure transition is stored along with the explicit Non-Terminal #4 instruction. In this embodiment, the Non-Terminal #1 instruction that describes state 1 has a different format from Non-Terminal #3. In particular, an opcode indicates a different next state selection means is to be used and the value of a symbol class of interest, in this case, 2, is stored in an operand field. When a state machine engine executes this instruction, if the present input matches the symbol class of interest, an offset of 0 is used relative to the base address of the next-state block of state 1, otherwise the offset is 1. States 4, 6, and 7 could also take advantage of this memory organization and addressing mechanism. If the addressing mechanism of instruction Non-Terminal #3 were used, then each of next-state blocks 660, 675, 680, and 685 would have five entries, four of which would be implicit failure transitions. In next-state block 660, Non-Terminal #4 would be in the second position corresponding to symbol class 2; in next-state block 675, Terminal #2 would be in the third position corresponding to symbol class 3; in next-state block 680, Terminal #3 would be in the third position corresponding to symbol class 3; and in next-state block 685, Terminal #4 would be in the fifth position corresponding to symbol class 5.

State 2 in FIG. 6b has two explicit out-transition and three implicit failure transitions with associated instruction set 665, consisting of Terminal #1, Non-Terminal #5 and the implicit failure transitions. In this case, there are two symbol classes, 4 and 5, of interest. This suggests yet another memory organization for the next-state block 665 which is illustrated in FIG. 6c. In this case, as with the previous one, only one instance of the implicit failure transition is stored along with the two explicit instructions. The Non-Terminal #2 instruction that describes state 2 has a different opcode and format from both Non-Terminal #1 and Non-Terminal #3. The opcode indicates a third next state selection means is to be used and the values of two symbol classes of interest, in this case, 4 and 5, are stored in an operand field. When a state machine engine executes this instruction, if the present input matches the first symbol class of interest, an offset of 0 is used relative to the base address of the next-state block of state 2, if the second symbol class of interest is matched, the offset is 1, otherwise the offset is 2. The approach of enumerating the classes of interest in fields in an instruction can be extended as long as there are enough bits available in the instruction to store the number of class values desired.

In FIG. 6c, the curved arcs indicate the presence of a base address field in the non-terminal instructions that points to the memory location of the first instruction in a next-state block of the state to which the transition is being made. Each terminal instruction has a solid straight line segment arrow that indicates a transition 695 back to the initial state. Because these instructions contain information unique to the terminal states to which they're associated, they are not all identical. Only those terminal format instructions associated with transitions to the same terminal state are identical, such as Terminal #3 and Terminal #4 in FIG. 6b which both cause transition to (virtual) terminal state 11. Each failure transition, all of which are identical, has a dashed straight line segment arrow that indicates a transition 695 back to the initial state.

When designing instruction formats, consideration should be given to selecting a maximum number of bits that may be used by any given instruction. This constraint may be determined by the bit width of a state transition table memory from which the instructions will be fetched and the number of clock cycles required to access one instruction from that memory. In a high speed design, it is desirable to be able to fetch one instruction in a single cycle. Generally available memory devices have a maximum configurable bit width. In an advantageous embodiment, the state transition table memory is implemented with a fixed width of 36 bits, which is a common size. Thus, in this embodiment, to assure that each instruction may be fetched in a single access of the memory, the instruction formats are constrained to 36 bits.

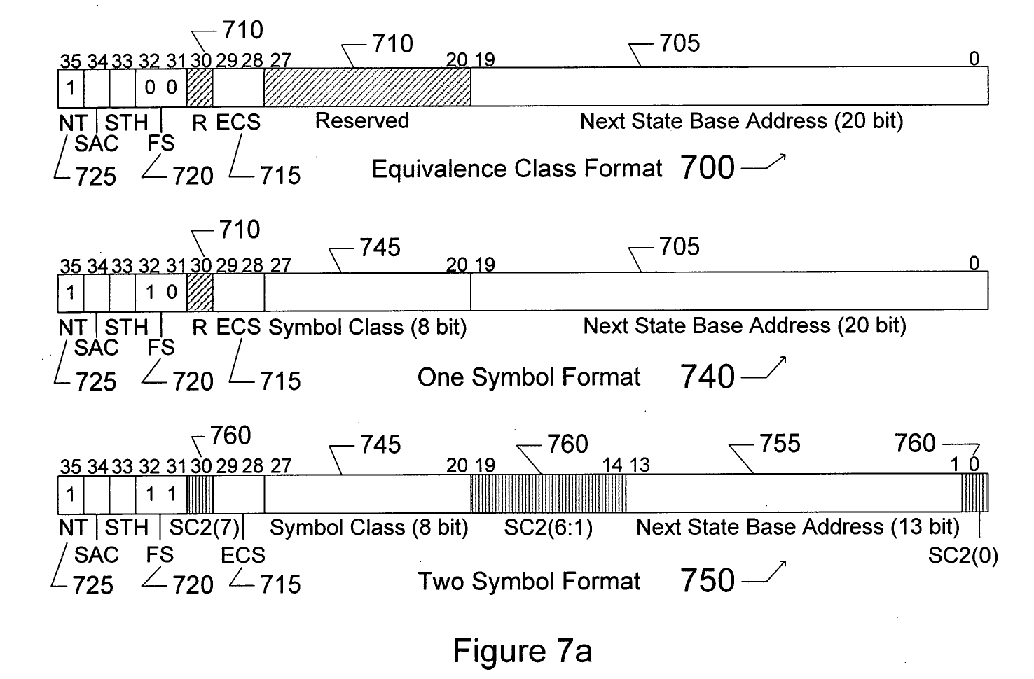

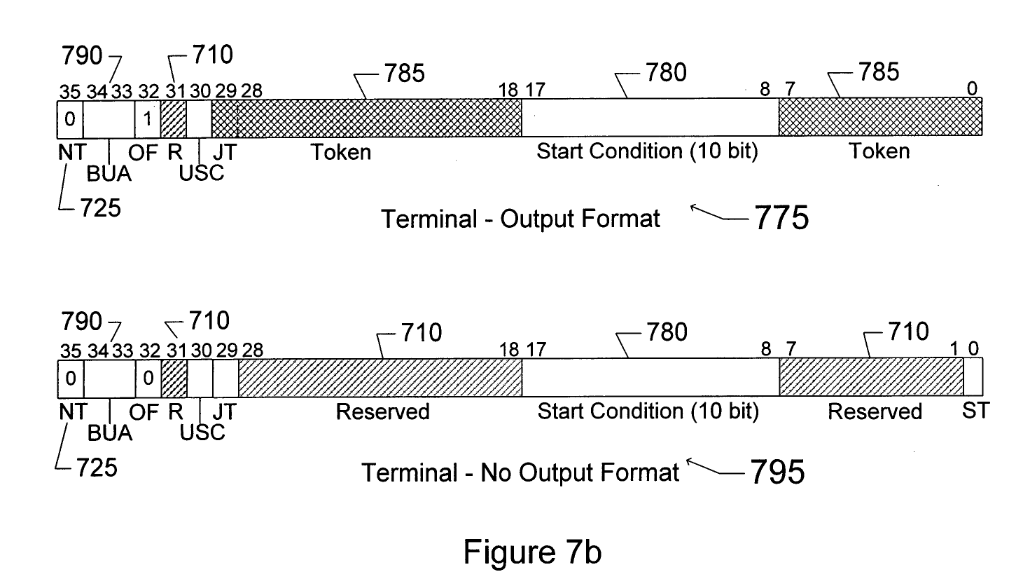

Five exemplary instruction formats are illustrated in FIGS. 7a and 7b. In particular, FIG. 7a illustrates an Equivalence Class Format 700, a One-Symbol Format 740, and a Two-Symbol Format 750, which are each examples of the general Non-Terminal Format 600 of FIG. 6a. A Terminal—Output Format 775 and a Terminal—No Output Format 795, shown in FIG. 7b, are examples of the general Terminal Format 625 of FIG. 6a.

The Equivalence Class Format 700 is the most flexible and general of all the non-terminal formats since it can accommodate any number of symbol classes and arbitrary transitions from the non-terminal state to which its associated in-transition points. In the example of FIG. 6b, it is suitable to represent every in-transition to every non-terminal state shown. The One-Symbol Format 740 is special purpose and used only for states with a single symbol class of interest, such as states 1, 4, 6, and 7 in FIG. 6b. Thus, Non-Terminals #1, and #4 through #7 (FIGS. 6b & 6c) could use the One-Symbol Format 740. The Two-Symbol Format 750 is also special purpose and is suitable for use with states that have no more than two symbol classes of interest, such as state 2 in FIG. 6b. Thus, Non-Terminal #2 (FIGS. 6b & 6c) could use Two-Symbol Format 750. It could also be used in place of the One-Symbol Format 740, but would be a less efficient use of state transition table memory. In the example of FIG. 6b, if one and two symbol format instructions are used where ever possible, then the Equivalence Class Format 700 should be used for Non-Terminal #3 (FIGS. 6b & 6c) to represent state 3. Each terminal instruction requiring output in FIGS. 6b & 6c would use Terminal—Output Format 775. Those not requiring output would use Terminal—No Output Format 795.

In an advantageous embodiment, a null instruction is defined to be all zeros, so the bit and field values chosen for each of the instruction types should be selected to ensure that every legal instruction contains at least one bit whose value is 1. By filling every unused location in a state transition table memory with the null instruction, a state machine engine can readily detect any error condition that causes the null instruction to be fetched from a state transition table memory.

In the exemplary embodiment of FIG. 7a, each of the three non-terminal format instruction types 700, 740, and 750, include a NT (non-terminal) bit 725, in bit position 35 and a 2 bit FS (function select) field 720, in bit positions 31 and 32, which together comprise the Opcode 605 of FIG. 6a. The NT bit 725 has a value of 1 to distinguish these non-terminal format type instructions from the terminal type instructions Terminal—Output Format 775 and Terminal—No Output Format 795 which each also have a NT bit 725. Each non-terminal format instruction, 700, 740, and 750, has NT=1, whereas each terminal format instruction, 775 and 795 has NT=0. The FS field 720 distinguishes among the non-terminal format instruction types. When FS=00, the Equivalence Class Format 700 is indicated. When FS=10, the One-Symbol Format 740 is indicated. When FS=11, the Two-Symbol Format 750 is indicated. In one embodiment, the fourth combination, 01, is reserved for a fourth instruction format that may be added. If not used, the presence of that value in a non-terminal format instruction may signal an error to a state machine engine. Those of skill in the art will appreciate that the bit settings for these, and other, fields could be changed in various ways according to specific implementations.

In the exemplary embodiment of FIG. 7a, each of the three non-terminal format instruction types 700, 740, and 750, includes a SAC (save accepting) bit 34, a STH (save trail head) bit 33, and a 2 bit ECS (equivalence class select) field 715, in bit positions 28 and 29, which together compose the Flags 610 of FIG. 6a. The SAC bit 34 signals to a state machine engine that all information associated with the last accepting state should be stored in registers allocated to that purpose. The STH bit 33 signals to a state machine engine that all information associated with trailing context (e.g., the trail head location) should be stored in registers allocated to that purpose. The ECS field 715, provides for selection from among up to four symbol class mappings.

In the exemplary embodiment of FIG. 7a, the Equivalence Class Format 700 and the One-Symbol Format 740 have a 20 bit Next-State Base Address field 705, located in bits 0 through 19 inclusive, which corresponds to the Next-State Base Address 620 of FIG. 6a. In one embodiment, an address of 20 bits may be used to directly access over one million (1,048,576) words of a state transition table memory. In another embodiment using 2ⁿ word alignment of next-state blocks, where n is a positive integer, an address of 20 bits may be used to allow access to 2ⁿ million words (2ⁿ×1,048,576) of state transition table memory. An effective next-state base address may be determined by a state machine engine by concatenating the next-state base address with n low order 0's. The effective address corresponds to a physical address in a state transition table memory. In the preferred embodiment, n=1 so that two million (2,097,152) words of state transition table memory may be accessed.

In the exemplary embodiment of FIG. 7a, the Equivalence Class Format 700 does not use the optional Comparands field 615 of FIG. 6a. In an advantageous embodiment, a state machine engine may compute a next state address by adding a selected symbol class value from an input stream to the effective next-state base address constructed from the Next-State Base Address 705 from an Equivalence Class Format 700 type instruction in a system where next-state blocks are two word aligned. In another embodiment, a state machine engine may compute a next state address by adding a selected symbol class value from an input stream to the Next State Base Address 705 from an Equivalence Class Format 700 type instruction. In general, a state machine engine may compute a next state address by adding a selected symbol class value from an input stream to 2ⁿ times the Next State Base Address 705 from an Equivalence Class Format 700 type instruction in a system where next-state blocks are 2ⁿ word aligned and n is a positive integer.

In the exemplary embodiment of FIG. 7a, the One-Symbol Format 740 instruction has an 8 bit Symbol Class field 745, located in bits 20 through 27 inclusive, that corresponds to the optional Comparands field 615 of FIG. 6a. In an advantageous embodiment, a state machine engine may determine the value of a next state address by comparing a selected symbol class value from an input stream to the Symbol Class field 745 of a One-Symbol Format 740 type instruction. If the comparison does not find a match, an offset is set equal to 0. If the comparison does find a match, the offset is set equal to 1. In one embodiment, a next state address may be computed by adding the offset to the effective next-state base address constructed from the Next-State Base Address 705 from a One Symbol Format 740 type instruction in a system where next-state blocks are two word aligned. In another embodiment, a next state address may be computed by adding the offset to the Next State Base Address 705 from a One Symbol Format 740 type instruction. In general, a next state address may be computed by adding the offset to 2ⁿ times the Next State Base Address 705 from a One Symbol Format 740 type instruction in a system where next-state blocks are 2ⁿ word aligned and n is a positive integer.

In the exemplary embodiment of FIG. 7a, the Two-Symbol Format 750 instruction has an 8 bit Symbol Class field 745, located in bits 20 through 27 inclusive, and an 8 bit SC2 (second symbol class) field 760 located in bit 0, 14 through 19 inclusive, and bit 30, that together comprise the optional Comparands field 615 of FIG. 6a. The least significant bit of SC2 is taken from bit 0 of the instruction, bits 1 through 6 inclusive in SC2 are taken from bits 14 through 19 inclusive respectively, in the instruction, and the most significant bit of SC2 is taken from bit 30 is the instruction. The 13 bit Next-State Base Address 755, located in bits 1 through 13 inclusive, corresponds to the Next-State Base Address 620 of FIG. 6a. In one embodiment, an address of 13 bits may be used to directly access 8,192 words of a state transition table memory. In general, an embodiment using 2ⁿ word alignment of next-state blocks, where n is a positive integer, may be used to allow access to 2ⁿ×8,192 words of state transition table memory. An effective next-state base address may be determined by a state machine engine by concatenating the next-state base address with n low order 0's. The effective address corresponds to a physical address in a state transition table memory. In an advantageous embodiment, n=2 so that 32,768 words of state transition table memory may be accessed. In general, if a state transition table memory in an implementation is larger than 2ⁿ×8,192 words, instructions using the Two-Symbol Format 750 and two-symbol next-state blocks should be placed within a state transition table memory in a region that is 2ⁿ×8,192 words in size and the region is aligned to a 2ⁿ×8,192 word boundary. If the size of the state transition table memory is 2^{p} words, p>n+13, there are R=2^{(p-n-13)} possible regions. Numbering the regions from 0 to R-1, if J is the p−n−13 bit assigned region, the effective next-state base address may be determined by concatenating J with the next-state base address and with n low order 0's. For example, assume four word alignment and that the state transition table memory has 2 Mega-words of storage. Then p=21 and n=2, so J is a 6 bit value ranging from 0 to 63. If two-symbol format instructions are assigned to region number 5, the binary value of J is 000101. If X represent the 13 bit address of the next-state base address, then the 21 bit effective next-state base address is 000101X00.

In an advantageous embodiment, n=4, thus, instructions using the Two Symbol Format 750 and two symbol next-state blocks should be placed within a state transition table memory in a region that is 32,768 words in size and aligned to a 32,768 word boundary. If a given state machine exceeds the number of two symbol next-state blocks that meet the stated addressing requirements, Equivalence Class Format 700 instructions may be substituted for the excess Two-Symbol Format 750 instructions and equivalence class blocks may be substituted for the excess two symbol blocks.

In an advantageous embodiment, a state machine engine may compute a next state address for a Two-Symbol Format 750 instruction by comparing a selected symbol class value from an input stream to the Symbol Class field 745 and to the SC2 field 760. If the comparison does not find a match with either of the fields, an offset is set equal to 0. If the comparison finds a match with the Symbol Class field 745, the offset is set equal to 1. If the comparison finds a match with the SC2 field 760, the offset is set equal to 2. A next state address may then be determined by adding the offset to an effective next-state base address computed as described above using the Next-State Base Address 755 from a Two Symbol Format 750 type instruction in a system where next-state blocks are four word aligned. In another embodiment, a next state address may be computed by adding the offset to the Next State Base Address 755 from a Two Symbol Format 750 type instruction. In general, a next state address may be computed by adding the offset to 2ⁿ times the Next State Base Address 755 from a Two Symbol Format 740 type instruction in a system where next-state blocks are 2ⁿ word aligned and n is a positive integer.

In the exemplary embodiment of FIG. 7b, each of the terminal instruction types 775 and 795, includes the NT (non-terminal) bit 725, in bit position 35 and an OF (output flag) bit 32, which together comprise the Opcode 630 of FIG. 6a. The OF bit 32 distinguishes among the terminal format instruction types. In one embodiment, when OF=1 the Terminal—Output Format 775 is indicated and when OF=0 the Terminal—No Output Format 795 is indicated. The OF bit 32 may also signal to a state machine engine that an output should be sent to an output formatter which includes a Token 785. In the embodiment of FIG. 7b, each of the terminal type instructions 775 and 795 include a 2 bit BUA (backup action) field 790, located in bits 33 and 34, a USC (use start condition) bit 30, and a JT (job terminate) bit 29, which together comprise some of the Flags 635 of FIG. 6a. The BUA field 790 indicates to a state machine engine from where it should access a next input symbol from an input stream. In an advantageous embodiment, the two bits of the BUA field 790 are used to meet the requirements for supporting a null instruction. For example, BUA=00 may be reserved for the null instruction, leaving three legal values that the state machine engine may decode as follows: BUA=01 means a last accepting state backup (backup and change the current location pointer to a value stored in a last accepting state location register); BUA=10 means a trail head backup (backup and change the current location pointer to a value stored in a trail head location register); and BUA=11 means no backup (read the next symbol in sequence by incrementing a current location pointer by one). The USC bit 30 signals to a state machine engine that a Start Condition 780 should be loaded into a start condition register. In one embodiment of the Terminal—Output Format 775, a JT bit 29 signals to a state machine engine to stop processing a present input stream if its value is 1. In another embodiment, the JT bit 29 is configured as part of a Token 785. In an advantageous embodiment, the JT bit 29 is either interpreted as a job termination signal or as part of a Token 785 according to a configuration bit in an input/output controller register, such as might be included in the Input/Output Controller 410 of FIG. 4. In one embodiment of the Terminal—No Output Format 795, the JT bit 29 signals to a state machine engine to stop processing a present input stream if its value is 1. In another embodiment, the Terminal—No Output Format 795 does not include the JT bit 29. In an advantageous embodiment, the JT bit 29 is either disabled or enabled to signal job termination according to a configuration bit in an input/output controller register. In the Terminal—No Output Format 795, a ST (stall) bit 0, which is one of the constituents of the Flags 635 of FIG. 6a, signals to a state machine engine to stall an input stream for one clock cycle and retrieve a terminal format accepting state transition instruction, included in a next-state block of a non-terminal accepting state. This action can occur when the non-terminal accepting state is to be treated as a terminal state.

In the exemplary embodiment of FIG. 7b, the Terminal—Output Format 775 instruction has a Token field 785 that may contain a value associated with an accepting state that also corresponds to a regular expression that has been accepted. In one embodiment, the Token field 785 is 20 bits wide, comprised of bits 0 through 7 inclusive and bits 18 through 29 inclusive. In another embodiment, the Token field 785 is 19 bits wide, comprised of bits 0 through 7 inclusive and bits 18 through 28 inclusive. In an advantageous embodiment, the bit-width of the Token field 785 is selectable by a configuration bit in an input/output controller register. For example, in one embodiment the width of the Token field 785 is 19 or 20 bits, as determined by an input/output controller register.

In the exemplary embodiment of FIG. 7a, the Equivalence Class Format 700, has a Reserved field 710 in bit 30 and bits 20 through 27 inclusive, and the One-Symbol Format 740, has a Reserved field 710 in bit 30. In the exemplary embodiment of FIG. 7b, the Terminal—Output Format 775 has a Reserved field 710 in bit 31, and the Terminal—No Output Format 795 has a Reserved field 710 in bit 31, bits 18 through 28 inclusive, and bits 1 through 7 inclusive. The bits that comprise the Reserved field 710 may be unused and should be set to a known value, such as all zeros. However, other embodiments could take advantage of the Reserved field 710 in one or more of the formats illustrated in FIGS. 7a and 7b without increasing the instruction word size. For example, the Reserved field 710 may contain data that expands existing fields, adds one or more new fields, defines additional flag bits, and/or creates new instruction types.

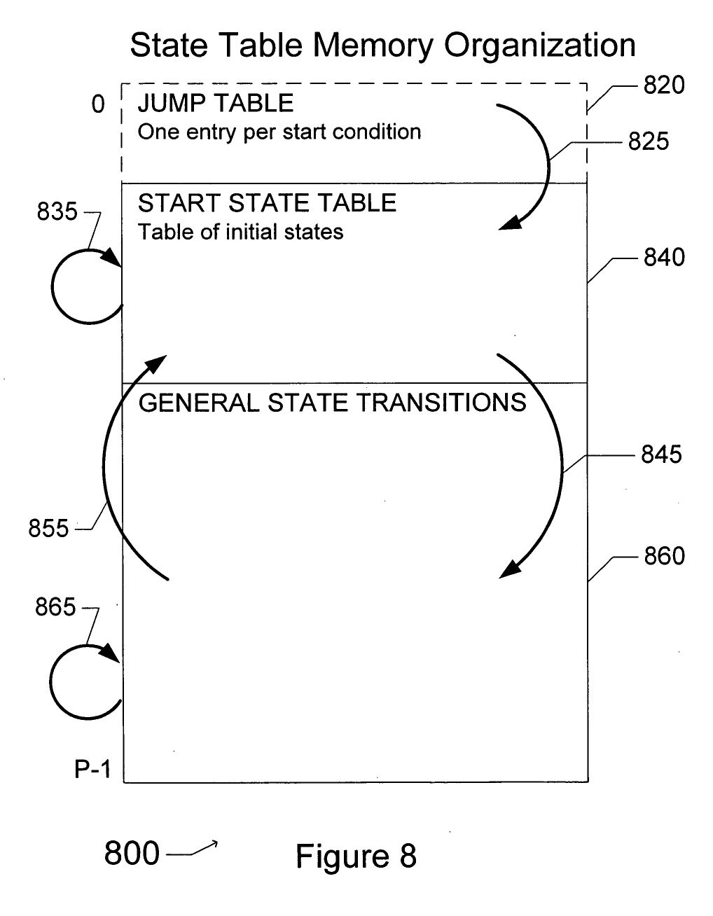

FIG. 8 is a block diagram illustrating the basic organization of a State Table Memory 800. An optional Jump Table 820, so indicated by dashed lines in FIG. 8, provides a fixed entry point for a new input stream in which there is one entry per start condition. Using the Jump Table 820, a compiler may have greater flexibility in the assignment of locations for initial states within the memory 440 (FIG. 4).

In one embodiment, as part of an initialization step, a start condition value accompanies a new input stream. The inclusion of a Jump Table 820 allows a start condition value to be used as the first memory address from which a first instruction is fetched by a state machine engine. In one embodiment, each entry in the table is a Terminal Format 625 instruction that enables the state machine engine to determine an address of an initial state that corresponds to the start condition, using start condition fields contained therein. In another embodiment, a start condition is assumed to have a value of 0. In that case, the Jump Table 820 only contains one entry which enables a state machine engine to determine an address of a first instruction. In an advantageous embodiment, the Jump Table 820 is only accessed once per input stream, thus all transitions 825 lead out of the Jump Table 820 and into a Start State Table 840, which contains all initial states of a state machine. In another embodiment, there is no Jump Table 820 and an entry point is assumed to be address 0. In another embodiment, there is no Jump Table 820 and a new input stream provides a first memory address to a state machine engine which enables selection among multiple initial states.

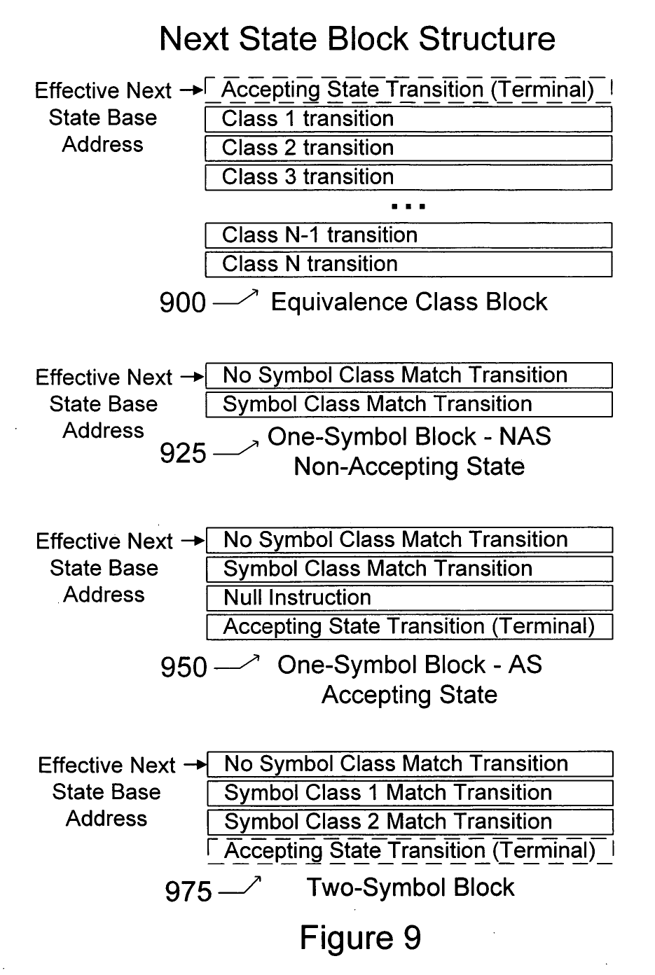

The Start State Table 840 is a collection of all initial states of a state machine. In one embodiment, each initial state is implemented using an Equivalence Class Block 900 (FIG. 9), but with one variation. In this exemplary embodiment, an initial state can never be a non-terminal accepting state; therefore a zero-offset location of a next-state block never contains an accepting state transition. In one embodiment, the zero-offset location contains a null instruction. In an advantageous embodiment, the zero-offset location may contain an instruction for an out-transition with the next state address calculation performed by a state machine engine, suitably modified. This is described in more detail later. A modified equivalence class block used to implement an initial state is referred to as a start-state block. In one embodiment, the Start State Table 840 contains a single start-state block for a start condition. In another embodiment, the Start State Table 840 contains two start-state blocks for a start condition, to allow beginning-of-line anchors to be processed. Beginning-of-line anchors were described earlier in which a caret symbol, ‘\hat{ }’, for example, is placed at the beginning of an expression to signify the anchoring. All expressions associated with the start condition that do not contain beginning-of-line anchors have identical entries in both start-state blocks since they are independent of beginning-of-line considerations. Any expression associated with the start condition that does have a beginning-of-line anchor has an entry only in the second of the two start-state blocks. The corresponding location in the first start-state block contains a failure transition terminal format entry. The first start-state block is referred to as a floating start-state block. The second start-state block is referred to as an anchored start-state block. Using a means provided for detecting end-of-line symbols, the anchored start-state block is chosen if the last symbol was an end-of-line symbol and the floating start-state block is chosen if it was not.

In another embodiment, the Start State Table 840 contains a single floating start-state block for those start conditions associated with a set of regular expressions containing no beginning-of-line anchors. In another embodiment, the Start State Table 840 comprises two start-state blocks, one floating and one anchored, referred to as a start-state block pair, for those start conditions associated with a set of regular expressions containing any beginning-of-line anchors. A means of detecting end-of-line symbols is used only for those start conditions having a start-state block pair. In an advantageous embodiment, every start condition has a start-state block pair. Those start conditions associated with a set of regular expressions containing no beginning-of-line anchors are arranged so that the set of instructions in the anchored start-state block is identical to the set in the floating start-state block. This has the advantage of simplified address calculation which facilitates highs speed operation and will be explained in more detail later. If none of the regular expressions associated with any of the start conditions contain beginning-of-line anchors, then a configuration bit in an input/output controller may be set to disable use of beginning-of-line processing and other next-state blocks associated with non-initial states, may be placed in the memory regions that would have been used for anchored start-state blocks.

All start-state blocks in the Start State Table 840 may contain any defined instruction format. All terminal format instructions cause a new initial state to be selected by a state machine engine. Thus, in effect, they cause transitions 835 which never leave the start state table region. All non-terminal format instructions cause transitions 845 to the General State Transitions region 860. In one embodiment, there is only one initial state and all terminal format instructions cause a transition to it. In another embodiment, there are multiple initial states and means are provided to store a current start state and to change its contents when so indicated by a terminal format instruction containing start condition related fields. In one embodiment, a state machine engine bases its selection of a start state on the value of the stored current start state.

The General State Transitions region 860 contains as many next-state blocks as are needed to implement a state machine compiled from a collection of regular expressions. The blocks are assigned to locations in the region 860 by the compiler, observing any word alignment constraints imposed by a chosen addressing scheme for each of the next-state block types. In an advantageous embodiment, all transitions caused by non-terminal format instructions 865 remain within the General State Transitions region 860 and all transitions caused by terminal format instructions 855 return to the Start State Table 840.

To implement a state table memory organization, the structure of the next-state blocks associated with each non-terminal format instruction type should be defined. FIG. 9 is a block diagram illustrating four exemplary structures for the three non-terminal format instruction types: Equivalence Class Format 700, One-Symbol Format 740, and Two-Symbol Format 750 shown in FIG. 7a. In an advantageous embodiment, an Equivalence Class Block 900 contains N+1 entries if there are N symbol classes. Symbol class identifiers begin with 1 and increase sequentially by 1. In this exemplary embodiment, zero is not assigned to represent a symbol class. As such, the first entry in the block, to which an effective base address points, is referred to as a zero-offset location and is reserved. If the equivalence class block represents a non-terminal accepting state, an accepting state transition instruction in the terminal format is placed in the zero-offset location. The instruction will cause a state machine engine to take the appropriate action if this state is to be treated as an accepting state. If the block is not for a non-terminal accepting state, this location is filled with the null instruction. In an advantageous embodiment, state machines are constructed so that a state machine engine does not access this location when it contains a null instruction.

In the exemplary embodiment of FIG. 9, a One-Symbol Block—NAS structure 925 is used for one-symbol blocks that do not represent non-terminal accepting states. In this structure, the zero-offset location holds the transition for the failure case in which the incoming symbol class did not match the only symbol class of interest. The next location contains the instruction to be fetched if the symbol class did match. In the embodiment illustrated in FIG. 9, the One-Symbol Block—NAS structure 925 is the smallest possible non-terminal block. Many regular expression applications have corresponding state machines with a preponderance of states with single out-transitions that can use this format to great advantage. Such applications include those configured to locate literal strings, for example anti-SPAM and anti-virus applications.

In the exemplary embodiment of FIG. 9, a One-Symbol Block—AS structure 950 is used for one-symbol blocks that represent non-terminal accepting states. The first two entries of this structure are identical to the One-Symbol Block—NAS structure 925. For compatibility with a Two-Symbol Block 975 structure that is described next, the third entry of this block is padded with a null instruction and the fourth entry contains an accepting state transition instruction. In an advantageous embodiment, all One-Symbol Block—AS structure 950 next-state blocks are at least two word aligned, so there is no difference in the number of state transition table memory locations required to store this block structure compared with the Two-Symbol Block structure 975.

In the exemplary embodiment of FIG. 9, the Two-Symbol Block structure 975 uses four instruction locations. In this structure, the zero-offset location holds the transition for the failure case in which the incoming symbol class did not match either of the two symbol classes of interest. The next location contains the instruction to be fetched if a first symbol class matches. The third location contains the instruction to be fetched if a second symbol class matches. If this next-state block represents a non-terminal accepting state, the fourth location contains an accepting state transition instruction. Otherwise, a null instruction is placed in the last location. In one embodiment, since this structure and the one-symbol block structure both use offset 3 for an accepting state transition instruction, for either instruction type, a state machine engine may perform the same next state address calculation when a stall occurs in order to fetch the required accepting state transition instruction.

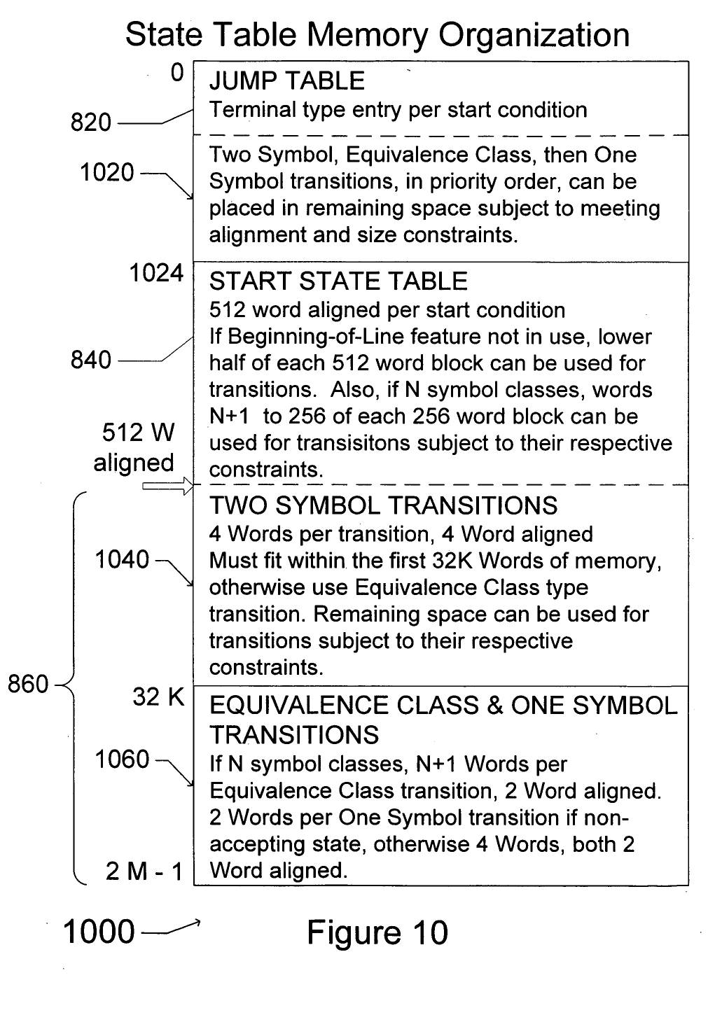

FIG. 10 is a block diagram illustrating an exemplary organization of data within the structure illustrated in FIG. 8. More particularly, with reference to FIG. 10, an example of an implementation of a State Table Memory Organization 1000 is discussed, in which the instruction formats of FIG. 7 and the next-state block structures of FIG. 9 are assumed.

As illustrated in FIG. 10, a Jump Table 820 contains a single Terminal—No Output Format 795 instruction per start condition. For example, each such instruction would have BUA 790 set to 11, USC bit 30 set to 1, JT bit 29 set to 0 and ST bit 0 set to 0, so that a state machine engine would be instructed to read the next symbol in an input stream, change the contents of a current start condition register to a value in the Start Condition field 780, not terminate this job, and not stall. The state machine engine is also instructed to determine an effective next state address based on the new value in the current start condition register.

In an advantageous embodiment, an effective next-state base address for a start-state block is constructed by concatenating two high order 0 bits followed by a ten bit start condition value, SC, followed by a one bit beginning-of-line flag, B, followed by eight low order 0 bits. Thus, the 21 bit effective address has the form 00-SC-B-00000000. With a new input stream, the beginning-of-line flag, B, is initialized to 1 since the first symbol in the stream is by definition at the beginning of a line. Subsequently, B is only set to 1 for the first symbol following any end-of-line symbol and otherwise has a value of 0. Constructing the address this way has the advantage of requiring minimal logic in the state machine engine because no arithmetic operations are involved. This facilitates high speed operation of the hardware. However, it requires all start-state blocks in a Start State Table 840 to be aligned properly which will be described below.

In an advantageous embodiment, a Start Condition field 780 (FIG. 7b) contains 10 bits, permitting a maximum of 1024 start conditions and 1024 entries in a Jump Table 820. However, the start condition addressing scheme described above would place a first two start-state block pairs in the region designated for the Jump Table 820. To reserve that region, start condition values of 0 and 1 are prohibited. Numbering of start conditions begins with 2 and a maximum of 1022 values are permitted when the optional Jump Table 820 is implemented. To avoid wasting the state transition table memory locations, to the extent that jump table entries are not needed, next-state blocks not associated with initial states may be placed in the memory region 1020. The next-state blocks must meet their respective size, alignment, and address range constraints to be so placed.

As discussed previously, start-state blocks are a modified form of an Equivalence Class Block 900 of FIG. 9. In an advantageous embodiment, 8 bit symbols are implemented. In one embodiment, there may be 256 symbol classes, with only one symbol in each class, thus using 257 locations in state transition table memory for each equivalence class block. Since a symbol class value of 0 is not permitted, a Symbol Classes Lookup Table 430 (FIG. 4) is a multiple of 9 bits wide, with 9 bits per symbol class. In an advantageous embodiment, the Compiler 220 (FIG. 2) assigns the null symbol, 0, to symbol class 256 whenever all 256 symbol classes are required. By so doing, a state machine engine may compute an initial state memory address by stripping off the ninth bit of the symbol class so assigned, and adding the resulting 8 bit value to an effective next-state base address of a start state. Using this calculation method only for start conditions, the zero-offset location of each start-state block may contain a transition instruction for the null symbol. By exploiting the availability of the zero-offset location in start-state blocks, the worst case size of the block is held to 256, which meets the requirements of the defined start condition addressing scheme in which power of 2 size regions are needed. Without this exploitation, start-state block pairs would have to be aligned to 1024 word boundaries, and each start-state block to a 512 word boundary.

In an advantageous embodiment, entries in a Start State Table 840 begin at address 1024. Each start-state block pair is aligned to a 512 word boundary to be compatible with the modified start condition addressing scheme described above. A contained floating start-state block in the pair is placed first and a contained anchored start-state block is aligned to a following 256 word boundary. By virtue of its location in bit 9 of the effective next-state base address defined above, a beginning-of-line flag, B, selects the correct start-state block. Those start conditions associated with a set of regular expressions containing no beginning-of-line anchors are arranged so that the set of instructions in the anchored start-state block is identical to the set in the floating start-state block. This then makes the initial state transitions independent of the value of B. If none of the regular expressions associated with any of the start conditions contain beginning-of-line anchors, then a configuration bit in an input/output controller may be set to disable use of beginning-of-line processing. In that case, none of the anchored start-state blocks that would be created, should be stored in the Start State Table 840. However, the 512 word alignment must still be observed for each floating start-state block. To avoid wasting the state transition table memory locations, other next-state blocks associated with non-initial states, may be placed in the memory regions that would have been used for each of the anchored start-state blocks. Furthermore, to the extent that the number of symbol classes in a given state machine is less than 256, unused memory locations at the end of each start-state block, both floating and anchored if in use, may be used for other next-state blocks associated with non-initial states. The other next-state blocks must meet their respective size, alignment, and address range constraints to be so placed. In a different embodiment, beginning-of-line anchors are not supported in regular expressions. The beginning-of-line flag, B, is dropped from the effective next-state base address so that it takes the form 000-SC-00000000. Each start condition has only one floating start-state block associated with it, and those blocks are aligned to 256 word boundaries. To the extent that the number of symbol classes in a given state machine is less than 256, unused memory locations at the end of each floating start-state block may be used for other next-state blocks associated with non-initial states. The other next-state blocks must meet their respective size, alignment, and address range constraints to be so placed.

In the exemplary embodiment of FIG. 10, a Two Symbol Transition region 1040 and an Equivalence Class and One Symbol Transition region 1060 compose the General State Transitions region 860 (FIG. 8). The Two Symbol Format 750 (FIG. 7a) provides a Next-State Base Address field 755 with 13 bits. Since the exemplary Two Symbol Block structure 975 of FIG. 9 requires three or four locations depending on the need for an accepting state transition instruction, there is minimal loss of flexibility in aligning these blocks to four word boundaries (requiring the least significant two bits of each effective next-state base address to be 0). That gives an addressing range of 2²×2¹³ or 32K words. This range is less than the two million word range of the equivalence class and one-symbol formats, so two-symbol blocks are given highest placement priority. Once it is no longer possible to use the two-symbol blocks, any remaining states that could use the two-symbol format are instead assigned to equivalence class format instructions and equivalence class blocks.

In an advantageous embodiment, a Two Symbol Transition region 1040 begins immediately after the Start State Table 840 on a first available 512 word boundary if, despite sharing this first 32K word region in state transition table memory with a Jump Table 820 and a Start State Table 840, there is sufficient memory to hold all two-symbol blocks. If so, then two-symbol blocks may be packed into any suitable unused portions of both the Jump Table region 820 and the Start State Table region 840. If not, then the next 32K word memory region is assigned that is either large enough despite overlapping with the start state table or beyond the start state table and therefore available for the maximum possible number of two-symbol blocks. The index of the selected 32K region, as previously described, serves as the high order bits of an effective next-state base address of these two-symbol blocks. A compiler may make all these placement determinations.

In the exemplary embodiment of FIG. 10, an Equivalence Class and One Symbol Transition region 1060 follows a Two Symbol Transition region 1040, if any. Given a state machine that has N symbol classes, an Equivalence Class Block 900 (FIG. 9) requires N+1 locations in a state transition table memory. In an advantageous embodiment, two word alignment is used. If N is even, an extra location following the block will be unusable due to being at an odd address, compared with the case where N is odd. In one embodiment, the unusable location is filled with a null instruction. If the region 1060 becomes filled with equivalence class blocks, they may optionally be placed within any other region where there are sufficient memory locations and the two word alignment can be met. After all equivalence class blocks have been assigned memory locations, the one-symbol blocks may be assigned. An exemplary One-Symbol Block—NAS 925 (FIG. 9) requires exactly 2 locations and a One-Symbol Block—AS 950 (FIG. 9) requires exactly 4. In an advantageous embodiment, both block types are two word aligned.

In an advantageous embodiment, the larger one-symbol accepting state type blocks are placed first. If there is insufficient space in the region 1060, they may optionally be placed within any other region where there are sufficient memory locations and the two word alignment can be met. This process is repeated last for the one-symbol non-accepting state type blocks, which have lowest assignment priority because their size gives them the highest probability of being packed in elsewhere.

In a different embodiment, an Equivalence Class Block 900 (FIG. 9), is of a size that is 2ⁿ, where n is an integer, and should be aligned on 2ⁿ word boundaries. If S is the actual number of symbol classes needed, 2ⁿ should be greater than or equal to S+1. Such a symbol class is represented with n bits. The advantage to this implementation is simplification of a next state address calculation may require less hardware and may be performed faster. This advantage is due to only needing to concatenate an n bit symbol class with the high order (21-n) bits of a State Base Address 705 in an Equivalence Class Format 700 instruction to obtain the next state address. Every equivalence class block so constructed will have S+1−2ⁿ unused locations at the end of the block. These locations may be filled with any combination of two-symbol and one-symbol blocks that will fit and meet their respective word alignment constraints.

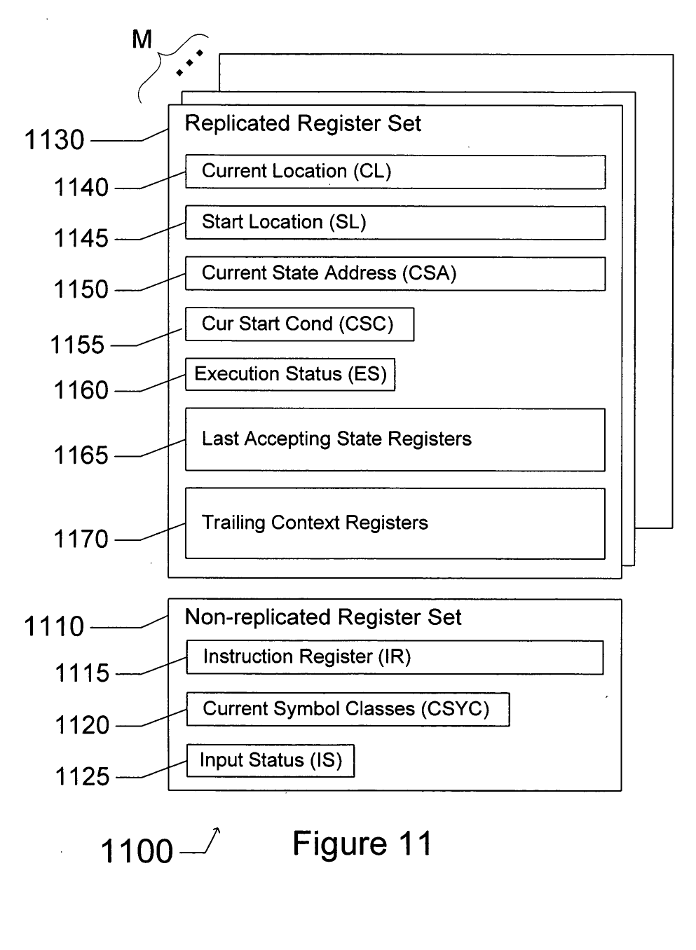

FIG. 11 is a block diagram illustrating a basic register set 1100 that may be contained in a Core Execution Unit 460 (FIG. 4). The register set 1100 includes a Non-replicated Register Set 1110 and a Replicated Register Set 1130. The Non-replicated Register Set 1110 serves as the entry point in the Core Execution Unit 460 (FIG. 4) for all Input Streams 425 (FIG. 4) and corresponding instruction streams fetched from the State Transition Table Memory 440 (FIG. 4). The Replicated Register Set 1130 maintains all context needed for each input stream separately so that the Core Execution Unit 460 may process them in a round robin fashion, one instruction at a time.

In an exemplary embodiment, the Non-replicated Register Set 1110 is independent of the number of Input Streams 425 and a multiplicity of M Replicated Register Sets 1130 in which a set is dedicated to a particular Input Stream. The Non-replicated Register Set 1110 is comprised of an Instruction Register (IR) 1115, a Current Symbol Classes (CSYC) register 1120, and an Input Status (IS) register 1125. In general, the Instruction Register 1115 stores a most recent instruction fetched from the State Transition Table Memory 440 (FIG. 4), the Current Symbol Classes register 1120 stores a most recent one or more symbol classes of a most recent symbol fetched from a Backup Buffer 420 associated with the same input stream as the instruction in the Instruction Register 1115, and the Input Status register 1125 contains one or more flag bits indicative of a state of the same input stream. In one embodiment, the Input Status register 1125 may include an end of file (EOF) bit indicating that the end of the input stream has been reached. In another embodiment, the end of file (EOF) bit may indicate that the CSYC register 1120 contains symbol classes of an EOF meta-symbol. In another embodiment, the Input Status register 1125 may include a beginning of a line (BOL) bit indicating that the symbol in the Current Symbol Class register 1120 is at the beginning of a line. In another embodiment, the Input Status register 1125 may include any combination of the previously described two flag bits, in addition to others someone practiced in the art would define.

In one embodiment, if M is greater than one, then the context of the information in the Non-replicated Register Set 1110 changes every clock cycle from one input stream to the next, in a round robin fashion. Thus, the progress of any given input stream proceeds at the rate of one instruction processed every M clock cycles. The processing of a single instruction corresponds to the execution of one state transition in a state machine stored in the state transition table memory. In another embodiment, individual registers or portions of registers in the Replicated Register Set 1130 change context every clock cycle from one input stream to the next in round robin fashion, but in a given clock cycle, various registers or portions of registers may be in the contexts of different input streams, for example, to facilitate pipelining in the Core Execution Unit 460 (FIG. 4).

In the exemplary embodiment of FIG. 11, the Replicated Register Set 1130 is comprised of a Current Location (CL) register 1140 that points to the current symbol in a Backup Buffer 420 (FIG. 4), a Start Location (SL) register 1145 that stores the position of a first symbol in a lexeme, a Current State Address (CSA) register 1150 that stores a location in the State Transition Table Memory 440 (FIG. 4) of the most recent instruction fetched, a Current Start Condition (CSC) register 1155 that stores the start condition value to be used the next time an initial state is to be fetched, an Execution Status (ES) register 1160 containing flag bits for remembering earlier occurring events, Last Accepting State (LAS) Registers 1165 that store contextual information related to the occurrence of a last accepting state, and Trailing Context (TC) Registers 1170 that store contextual information related to the occurrence of a trail head state.

In one embodiment, the Execution Status register 1160 may include a flag bit indicating whether or not a last accepting state has been encountered. In another embodiment, the Execution Status register 1160 may include a flag bit indicating when the last symbol of the input stream has been processed by the Core Execution Unit 460 (FIG. 4), and processing of the input stream should terminate. In another embodiment, the Execution Status register 1160 may include any combination of the previously described two flag bits in addition to others someone practiced in the art would define. In one embodiment, Last Accepting State Registers 1165 may include a register to store a pointer to an accepting state transition instruction in the next-state block corresponding to a non-terminal accepting state which is the last accepting state. The pointer enables a core execution unit to retrieve an accepting state transition instruction in the event the state is to be treated as a terminal state. In another embodiment, Last Accepting State Registers 1165 may include a register to store a pointer to a location of a symbol in a backup buffer that will determine the next out-transition from an initial state, after the last accepting state has been treated by a core execution unit as a terminal state. In another embodiment, Last Accepting State Registers 1165 may include a register to store a symbol and/or one or more symbol classes that will determine the next out-transition from an initial state, after the last accepting state has been treated by a core execution unit as a terminal state. In another embodiment, Last Accepting State Registers 1165 may include a flag bit to indicate if a stored symbol, or a symbol referenced by a pointer, is at the beginning of a line. In another embodiment, Last Accepting State Registers 1165 may include a flag bit to indicate if a stored symbol, or a symbol referenced by a pointer, is the last one in an input stream. In another embodiment, the Last Accepting State Registers 1165 may include any combination of the previously described three registers and two flag bits in addition to other registers and flag bits someone practiced in the art would define.

In one embodiment, Trailing Context Registers 1170 may include a register to store a pointer to an effective next-state base address of a next-state block corresponding to a trail head state. In another embodiment, Trailing Context Registers 1170 may include a register to store a pointer to a location of a symbol in a backup buffer that will determine the next out-transition from an initial state, after a core execution unit has reached a (virtual) trailing context terminal state. In another embodiment, Trailing Context Registers 1170 may include a register to store a symbol that will determine the next out-transition from an initial state, after a core execution unit has reached a (virtual) trailing context terminal state. In another embodiment, Trailing Context Registers 1170 may include a flag bit to indicate if a stored symbol, or a symbol referenced by a pointer, is at the beginning of a line. In another embodiment, Trailing Context Registers 1170 may include a flag bit to indicate if a stored symbol, or a symbol referenced by a pointer, is the last one in an input stream. In another embodiment, the Trailing Context Registers 1170 may include any combination of the previously described three registers and two flag bits in addition to other registers and flag bits someone practiced in the art would define.

As previously stated, the Core Execution Unit 460 (FIG. 4) executes instructions stored in the State Transition Table Memory 440 (FIG. 4). Consider the execution of a given current instruction. This current instruction is to be executed upon a current symbol, in the context of a current input stream from which the current symbol came. Furthermore, the current instruction corresponds to a transition from a current state to a next state.

The Non-Replicated Register Set 1110 serves as input to this instruction execution. In particular, the Instruction Register 1115 holds the current instruction to be executed, the Current Symbol Classes register 1120 holds one or more current symbol classes of the current symbol which the instruction is to be executed upon, and the Input Status register 1125 holds current input status information corresponding to the current symbol and/or the current input stream. The current instruction came from the State Transition Table Memory 440 (FIG. 4) via the Memory Interface 450 (FIG. 4), which read the current instruction from a state address communicated to it by the Core Execution Unit 460 (FIG. 4) during the execution of the previous instruction in the context of the current input stream. The current symbol classes and current input status information came as a result of retrieving the current symbol from the current location in the current input stream from the Backup Buffer 420 (FIG. 4) and looking up that current symbol in the Symbol Classes Lookup Table 430 (FIG. 4), this location having been communicated to the Backup Buffer 420 by the Core Execution Unit 460 during the execution of the previous instruction in the context of the current input stream.

A current one of the M Replicated Register Sets 1130 serves as persistent state for the execution of instructions in the context of the current input stream. The current Replicated Register Set 1130 has a set of contents that were retained from the execution of previous instructions in the context of the current input stream. The contents may be modified by the execution of the current instruction and are then retained for execution of further instructions in the context of the current input stream.

Executing the current instruction comprises several tasks: optionally sending output information to the current Output Formatter 470 (FIG. 4) corresponding to the current input stream; communicating the next state address to the Memory Interface 450 (FIG. 4); communicating the next location in the current input stream to the Backup Buffer 420 (FIG. 4); updating the contents of the current Replicated Register Set 1130 with new values; and determining whether processing of the current input stream should terminate.

Output information may be sent to the current Output Formatter 470 if the current instruction is in the Terminal Format 625 (FIG. 6a), and an output action is indicated by the Opcode field 630 (FIG. 6a) and/or Flags field 635 (FIG. 6a). An output action may be so indicated if the next state is a (virtual) accepting terminal state, because a lexeme has satisfied a regular expression. As noted previously, the output information sent may comprise any one or more of various possible components. Some components, such as a token value corresponding to the regular expression that was accepted, and/or a parameter associated with the lexeme that may facilitate further processing of the output stream, can be taken from the current instruction's Output Information field 645 (FIG. 6a). If the start location of the identified lexeme is to be included in the output information sent, this may be taken from the Start Location (SL) register 1145 of the current Replicated Register Set 1130. In one embodiment, it may be necessary to add or subtract a constant, such as subtracting one, from the contents of this register, in order to produce the actual start location of the lexeme, due to pipelining considerations particular to an implementation. If the end location of the identified lexeme is to be included, the current instruction's Flags field 635 (FIG. 6a) may indicate the source to be used in determining this end location. For example, if the next state accepts a lexeme ending with the last symbol scanned, the Flags field 635 may indicate that the end location of the identified lexeme is to be taken from the Current Location (CL) register 1140 of the current Replicated Register Set 1130. Alternatively, if the next state accepts a lexeme whose end was scanned previously by a non-terminal accepting state, the Flags field 635 may indicate that the end location of the identified lexeme is to be taken from the Last Accepting State Registers 1165 of the current Replicated Register Set 1130. Alternatively, if the next state accepts a lexeme with trailing context, the Flags field 635 could indicate that the end location of the identified lexeme is to be taken from the Trailing Context Registers 1170 of the current Replicated Register Set 1130. In one embodiment, it may be necessary to add or subtract a constant or various constants from the contents of these various registers in order to produce the actual end location of the lexeme, due to pipelining considerations particular to an implementation. If a count of the number of symbols in the accepted lexeme is to be included in the output information sent, this may be calculated by subtracting the start location from the end location plus one, even though the start location and/or end location may not be included in the output sent.

In an advantageous embodiment, the next state address to be communicated to the Memory Interface 450 (FIG. 4) is determined by adding a computed next offset to a computed next base address. The next base address is computed to be a pointer to the beginning of the next-state block corresponding to the next state. The next offset is computed to select the instruction from the next-state block corresponding to the out-transition from the next state which corresponds to the current symbol and current input status.

If the current instruction is in a Non-Terminal Format 600, then the next base address is determined directly from the Next State Base Address field 620 (FIG. 6a). It may be necessary to append n ‘0’ bits to the Next State Base Address field 620 in order to yield the full next base address, if next-state blocks are constrained to lie on 2ⁿ-word boundaries in the State Transition Table Memory 440 (FIG. 4). If the current instruction is in a Terminal Format 625, then the next base address may be determined from the Start Condition field 640 (FIG. 6a), or from the Current Start Condition register 1155 of the current Replicated Register Set 1130. Whether the Start Condition field 640 or the Current Start Condition register 1155 is to be used may be indicated by the Flags field 635 (FIG. 6a) of the current instruction. Whichever of these values is used provides a next start condition, which is converted into a next base address that is a pointer to the beginning of the corresponding start state block or start state block pair. For example, the next base address may be formed by appending n low-order ‘0’ bits to the next start condition, where start state blocks or block pairs are constrained to lie on 2ⁿ-word boundaries in the State Transition Table Memory 440 (FIG. 4).

If the current instruction is in a Non-Terminal Format 600 (FIG. 6a), then the next offset may be determined in various ways depending on the Opcode field 605 (FIG. 6a). For example, the next offset may be set equal to one of the Current Symbol Classes 1120, selected (if there is more than one) using information from the Flags field 610 (FIG. 6a). Alternatively, the next offset may be set to 1, 2, etc., according to which of one or more elements of the Comparands field 615 (FIG. 6a) matches one of the Current Symbol Classes 1120, selected using information from the Flags field 610, or to 0 if none of the elements of the Comparands field 615 matches. Alternatively, the next offset may be set to the value obtained by subtracting an element of the Comparands field 615 from a selected one of the Current Symbol Classes 1120 if that symbol class falls exclusively or inclusively between two elements of the Comparands field 615, and otherwise to a fixed default offset. Alternatively, the next offset may be set to the result of any logical, arithmetical and/or other operation performed on one or more of the Current Symbol Classes 1120 and one or more elements of the Comparands field 615. If the current instruction is in a Terminal Format 625, then the next offset is determined directly from the Current Symbol Classes 1120. Advantageously, the next offset may be set equal to a symbol class selected from the Current Symbol Classes 1120 in a fixed manner (such as selecting the first one), or using information from the Flags field 635.

Regardless of the current instruction format, computation of the next state address may be modified by other factors, including information in the current instruction's Flags field 610 or 635 (FIG. 6a), the Input Status register 1125, the Execution Status register 1160, the Last Accepting State Registers 1165, and/or the Trailing Context Registers 1170. In one embodiment, elements of the Execution Status register 1160 and/or the Flags field 610 or 635 may indicate that a base address corresponding to a last accepting state and stored in the Last Accepting State Registers 1165 is to be substituted for the next base address. In another embodiment, elements of the Execution Status register 1160 and/or the Flags field 610 or 635 may indicate that a symbol class and input status information stored in the Last Accepting State Registers 1165 or the Trailing Context Registers 1170 is to be substituted for the Current Symbol Classes register 1120 and Input Status register 1125 when computing the next offset. In another embodiment, if work on the current input stream needs to delay temporarily, such as because input or output in the context of the current input stream is stalled, the contents of the Current State Address register 1150 may be re-sent to the Memory Interface 450 (FIG. 4) as the next state address.

The next location in the current input stream to be communicated to the Backup Buffer 420 (FIG. 4) is usually one plus the Current Location 1140 in the current Replicated Register Set 1130. However, if the current instruction is in a Terminal Format 625 (FIG. 6a), the Flags field 635 (FIG. 6a) and/or the Execution Status register 1160 may direct a backup in the current input stream. Such a backup may be to the symbol after the end of a lexeme which has been accepted; and the location of this lexeme end location may be determined from the Current Location (CL) register 1140, the Last Accepting State Registers 1165, or Trailing Context Registers 1170 as described above.

Some elements of the current Replicated Register Set 1130 are updated with new values whose determination has already been described. The Current Location register 1140 is updated with the next location in the current input stream being communicated to the Backup Buffer 420 (FIG. 4). The Current State Address register 1150 is updated with the next state address being communicated to the Memory Interface 450 (FIG. 4).

The Start Location register 1145 is updated to point to the beginning of a new lexeme only when the state machine enters an initial state to begin processing a new lexeme. This may be done either (1) when the current instruction is in a terminal format 625 (FIG. 6a) so that the next state is an initial state, or (2) when the current state is an initial state. In case (1), the Start Location register 1145 is updated using the next location in the current input stream being communicated to the Backup Buffer 420 (FIG. 4). In case (2), the Start Location register 1145 is updated using the Current Location register 1140. In either case, a fixed value may be added or subtracted, such as subtracting one, according to pipelining considerations particular to an implementation.

The Current Start Condition register 1155 is only updated when the current instruction is in a terminal format 625 (FIG. 6a), and the next state address being communicated to the Memory Interface 450 (FIG. 4) is being constructed using a next base address determined from the current instruction's Start Condition field 640 (FIG. 6a), rather than from the current value of the Current Start Condition register 1155. As stated above, the use of the Start Condition field 640 may be indicated by the Flags field 635 (FIG. 6a) of the current instruction. In such a case, the Current Start Condition register 1155 is updated with the value of the Start Condition field 640.

The Execution Status register 1160 may be updated under various conditions, depending on the elements it comprises. If the Execution Status register 1160 includes a flag bit indicating whether or not a last accepting state has been encountered, this flag may be set if the current instruction represents a transition to a non-terminal accepting state, or cleared if the current instruction is in a terminal format 625 (FIG. 6a). If the Execution Status register 1160 includes a flag bit indicating when the last symbol of the input stream has been processed by the Core Execution Unit 460 (FIG. 4), and processing of the input stream should terminate, the flag may be set when the Input Status register 1125 indicates that the current symbol is the last one in the current input stream (or is an EOF meta-symbol), or cleared when processing of a new input stream begins. Such a flag may not be set, even though the current symbol is the last one in the current input stream, when it is determined that there is further processing to be done on the current input stream, such as when the next location in the current input stream being communicated to the Backup Buffer 420 (FIG. 4) represents a backup in the current input stream.

The Last Accepting State Registers 1165 are updated when the next state is a non-terminal accepting state. Elements of the Last Accepting State Registers 1165 may be updated with information from the Current Symbol Classes 1120 and/or Input Status 1125 registers, such as one or more symbol classes of the current symbol, a flag indicating whether the current symbol is at the beginning of a line, and/or a flag indicating whether the current symbol is the last one in the current input stream. If the Last Accepting State Registers 1165 include a register to store a pointer to a location of a symbol in a backup buffer, this register may be updated with the pointer in the Current Location register 1140, possibly adding or subtracting a constant, such as adding one, according to pipelining considerations particular to an implementation. If the Last Accepting State Registers 1165 include a register to store a pointer to an accepting state transition instruction, this register may be updated with an address which is the sum of a special offset and the next base address being used to construct the next state address being communicated to the Memory Interface 450 (FIG. 4). The special offset is the offset of the accepting state transition instruction within the next-state block corresponding to the next state, and corresponds to the format of that next-state block, which may be determined from the current instruction format and Opcode field 605 or 630.

The Trailing Context Registers 1170 are updated when the next state is a trail head state. Elements of the Trailing Context Registers 1170 may be updated with information from the Current Symbol Classes 1120 and/or Input Status 1125 registers, such as one or more symbol classes of the current symbol, a flag indicating whether the current symbol is at the beginning of a line, and/or a flag indicating whether the current symbol is the last one in the current input stream (or is an EOF meta-symbol). If the Trailing Context Registers 1170 include a register to store a pointer to a location of a symbol in a backup buffer, this register may be updated with the pointer in the Current Location register 1140, possibly adding or subtracting a constant, such as adding one, according to pipelining considerations particular to an implementation.

Various methods may be used by someone skilled in the art to determine if processing of the current input stream should terminate. If the Execution Status register 1160 includes a flag bit indicating when the last symbol of the input stream has been processed by the Core Execution Unit 460 (FIG. 4), processing may terminate immediately after this bit is set, or after one or more additional execution steps. If the Input Status registers 1125, the Last Accepting State Registers 1165, and/or the Trailing Context Registers 1170 include flags indicating whether corresponding symbols are the last in the current input stream (or are EOF meta-symbols), such flags being set may cause processing of the current input stream to terminate under some circumstances. In some embodiments, it may be important to allow processing of the current input stream to continue even after such conditions, such as when a backup in the input stream will cause one or more last symbols in the current input stream to be scanned again. The method used to determine when processing of the current input stream should terminate may depend heavily on pipelining and other architectural considerations.

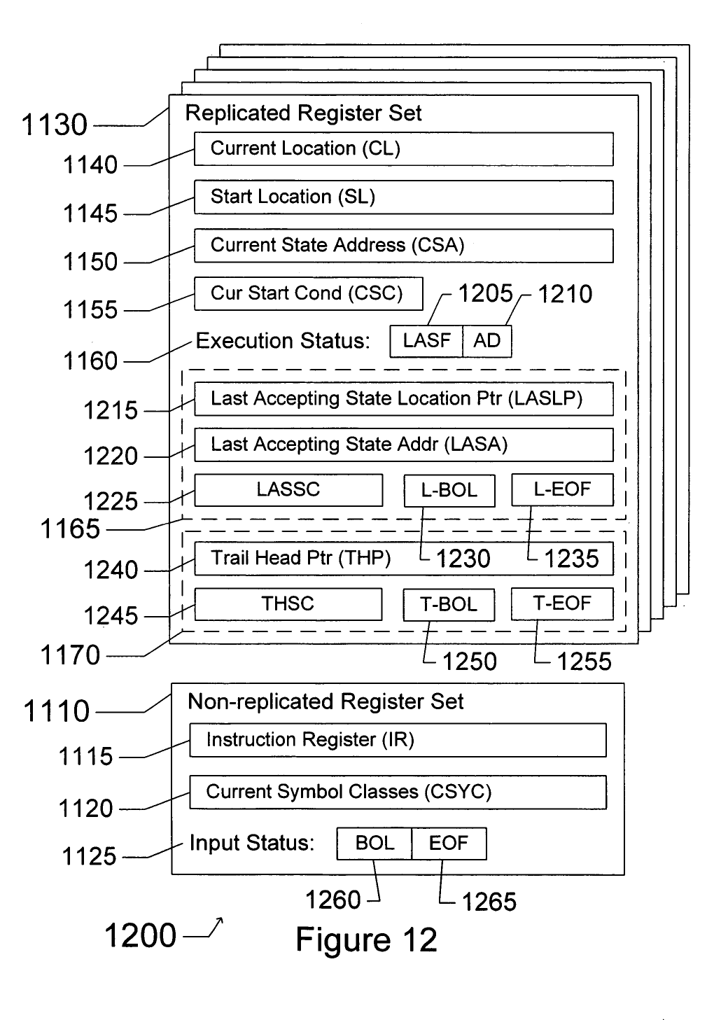

FIG. 12 is a block diagram illustrating an exemplary embodiment 1200 of the basic register set 1100 (FIG. 11) that may be contained in a Core Execution Unit 460 (FIG. 4). FIG. 12 introduces and provides description of registers that may be part of the registers described above with respect to FIG. 11. These registers, as described below, provide an example of how the systems and methods described herein may be implemented. Specific registers are described for purpose of explanation, and are not meant to limit the scope of the methods and systems described herein. Accordingly, other embodiments, having fewer or more registers, with the registers arranged in alternative configuration are expressly contemplated.

The following discussion of FIG. 12 assumes that instructions stored in the State Transition Table Memory 440 (FIG. 4) are formatted as shown in FIGS. 7a and 7b, and that the out-transitions from each state (except virtual terminal states) are represented by instructions grouped into next-state blocks as shown in FIG. 9.

As in FIG. 11, the exemplary basic register set 1200 includes a Non-replicated Register Set 1110 and a Replicated Register. Set 1130. In the exemplary basic register set 1200, several registers are shown just as in FIG. 11, and retain their numbering from FIG. 11. However, it is important to understand the registers of FIG. 12 in the context of the exemplary embodiments of FIGS. 7a, 7b, 9 and 10. Each of the registers shown in FIG. 11 will therefore be reviewed below.

The Instruction Register (IR) 1115 (FIG. 12) is formatted as shown in FIGS. 7a and 7b. Thus, this register comprises 36 bits, which are to be interpreted depending on the Non-Terminal (NT) flag 725 (FIGS. 7a, 7b) as either non-terminal format instructions of FIG. 7a, or terminal format instructions of FIG. 7b. Non-terminal format instructions are to be interpreted depending on the Function Select (FS) field 720 (FIG. 7a) as having the Equivalence Class Format 700 (FIG. 7a), the One Symbol Format 740 (FIG. 7a), or the Two Symbol Format 750 (FIG. 7a). Terminal format instructions are to be interpreted depending on their Output Flag (OF) bit 32 as having the Terminal—Output Format 775 (FIG. 7b) or the Terminal—No Output Format 795 (FIG. 7b). Additional instruction formats remain possible, such as by the use of unused Function Select (FS) codes and/or reserved fields.

The Current Symbol Classes (CSYC) register 1120 (FIG. 12) comprises up to four symbol class values. The non-terminal instruction formats of FIG. 7a select one of these symbol class values using the 2-bit Equivalence Class Select (ECS) field 715 (FIG. 7a) to be used in determining the next state address. In this embodiment, each symbol class is represented using 9 bits, so that the CSYC register is 36 bits wide.

In the Replicated Register Set 1130 (FIG. 12), the Current Location (CL) register 1140 (FIG. 12) points to the current symbol in a Backup Buffer 420 (FIG. 4), as described with respect to FIG. 11.

The Start Location (SL) register 1145 (FIG. 12) stores the position of a first symbol in a lexeme, as described with respect to FIG. 11.

The Current State Address (CSA) register 1150 (FIG. 12) stores a location in the State Transition Table Memory 440 (FIG. 4) of the most recent instruction fetched. This register is wide enough to hold the largest instruction address in the State Transition Table Memory 440 (FIG. 4). In the exemplary embodiment, the Current State Address (CSA) register 1150 (FIG. 12) comprises 21 bits, which is sufficient to hold an effective base address formed by appending a low order zero bit to a 20-bit Next State Base Address instruction field 705 (FIG. 7a).

The Current Start Condition (CSC) register 1155 (FIG. 12) stores the default start condition value to be used the next time an initial state is to be fetched. This register comprises 10 bits, corresponding to the width of a Start Condition instruction field 780 (FIG. 7b).

Several other registers in FIG. 12, which are given 1200-series numbers, compose more general registers in FIG. 11. The composition is clarified by also showing the 1100-series numbers of the corresponding general registers of FIG. 11. These registers are described next.

The Input Status register 1125 in FIG. 12 comprises a Beginning-of-Line (BOL) flag register 1260 and an End-of-File (EOF) flag register 1265. The Beginning-of-Line flag 1260 indicates whether the current symbol is at the beginning of a line within its input stream. The End-of-File flag 1265 indicates whether the current symbol is the last symbol of an input stream.

The Execution Status registers 1160 in FIG. 12 comprise a Last Accepting State Flag (LASF) register 1205 and an Almost Done (AD) flag register 1210. The Last Accepting State Flag 1205 indicates whether or not a non-terminal accepting state has been encountered since the most recent initial state. The Almost Done flag 1210 indicates when the last symbol of the input stream has been processed by the Core Execution Unit 460 (FIG. 4), and processing of the input stream should terminate.

The Last Accepting State Registers 1165 in FIG. 12 comprise a Last Accepting State Location Pointer (LASLP) register 1215, a Last Accepting State Address (LASA) register 1220, a Last Accepting State Symbol Class (LASSC) register 1225, a Last Accepting State Beginning-of-Line flag (L-BOL) register 1230, and a Last Accepting State End-of-File flag (L-EOF) register 1235. All of these registers store contextual information related to the occurrence of a last accepting state. The Last Accepting State Location Pointer register 1215 stores a pointer to a location of a symbol in a backup buffer that will determine the next out-transition from an initial state, after the last accepting state has been treated by a core execution unit as a terminal state. The Last Accepting State Address register 1220 stores an address of an accepting state transition instruction in the next-state block corresponding to a non-terminal accepting state which is the last accepting state. The Last Accepting State Symbol Class register 1225 stores a symbol class that will determine the next out-transition from an initial state, after the last accepting state has been treated by a core execution unit as a terminal state. The Last Accepting State Beginning-of-Line flag 1230 indicates whether the symbol whose symbol class is stored in the LASSC register 1225 is at the beginning of a line. The Last Accepting State End-of-File flag 1235 indicates whether the symbol whose symbol class is stored in the LASSC register 1225 is the last one in an input stream.

The Trailing Context Registers 1170 in FIG. 12 comprise a Trail Head Pointer (THP) register 1240, a Trail Head Symbol Class (THSC) register 1245, a Trail Head Beginning-of-Line flag (T-BOL) register 1250, and a Trail Head End-of-File flag (T-EOF) register 1255. All of these registers store contextual information related to the occurrence of a trail head state. The Trail Head Pointer register 1240 stores a pointer to a location of a symbol in a backup buffer that will determine the next out-transition from an initial state, after a core execution unit has reached a (virtual) trailing context terminal state. The Trail Head Symbol Class register 1245 stores a symbol class that will determine the next out-transition from an initial state, after a core execution unit has reached a (virtual) trailing context terminal state. The Trail Head Beginning-of-Line flag 1250 indicates whether the symbol whose symbol class is stored in the THSC register 1245 is at the beginning of a line. The Trail Head End-of-File flag 1255 indicates whether the symbol whose symbol class is stored in the THSC register 1245 is the last one in an input stream.

As previously stated, the Core Execution Unit 460 (FIG. 4) executes instructions stored in the State Transition Table Memory 440 (FIG. 4). Consider the execution of a given current instruction in the exemplary embodiment of FIG. 12. This current instruction is to be executed upon a current symbol, in the context of a current input stream from which the current symbol came. Furthermore, the current instruction corresponds to a transition from a current state to a next state.

The Non-Replicated Register Set 1110 (FIG. 12) serves as input to this instruction execution. In particular, the Instruction Register 1115 (FIG. 12) holds the current instruction to be executed, the Current Symbol Classes register 1120 (FIG. 12) holds up to 4 current symbol classes of the current symbol which the instruction is to be executed upon, the Beginning-of-Line flag register 1260 holds a beginning-of-line flag indicating whether the current symbol is at the beginning of a line within the current input stream, and the End-of-File flag 1265 holds a current end of file flag indicating whether the current symbol is the last symbol of the current input stream. The current instruction came from the State Transition Table Memory 440 (FIG. 4) via the Memory Interface 450 (FIG. 4), which read the current instruction from a state address communicated to it by the Core Execution Unit 460 (FIG. 4) during the execution of the previous instruction in the context of the current input stream. The current symbol classes and current input status (comprising the current beginning-of-line flag and current end of file flag) came as a result of retrieving the current symbol from the current location in the current input stream from the Backup Buffer 420 (FIG. 4) and looking up that current symbol in the Symbol Classes Lookup Table 430 (FIG. 4), this location having been communicated to the Backup Buffer 420 by the Core Execution Unit 460 during the execution of the previous instruction in the context of the current input stream.

A current one of the M Replicated Register Sets 1130 (FIG. 12) serves as persistent state for the execution of instructions in the context of the current input stream. The current Replicated Register Set 1130 (FIG. 12) has a set of contents that were retained from the execution of previous instructions in the context of the current input stream. The contents may be modified by the execution of the current instruction and may then be retained for execution of further instructions in the context of the current input stream.

Executing the current instruction comprises several tasks: optionally sending output information to the current Output Formatter 470 (FIG. 4) corresponding to the current input stream; communicating the next state address to the Memory Interface 450 (FIG. 4); communicating the next location in the current input stream to the Backup Buffer 420 (FIG. 4); and updating the contents of the current Replicated Register Set 1130 (FIG. 12) with new values.

Several aspects of these tasks depend on the current instruction's format, which can be any of the five instruction formats shown in FIGS. 7a and 7b. An instruction's format can be determined by examining just a few of its bits. First, the Non-Terminal (NT) flag 725 (FIGS. 7a and 7b) is examined; if NT=1, the instruction is in one of the non-terminal formats of FIG. 7a, and NT=0, the instruction is in one of the terminal formats of FIG. 7b. If the instruction is in a non-terminal format (NT=1), then the Function Select (FS) field 720 (FIG. 7a) determines the precise instruction format: if FS=00, the instruction is in the Equivalence Class Format 700 (FIG. 7a); if FS=10, the instruction is in the One Symbol Format 740 (FIG. 7a); and if FS=11, the instruction is in the Two Symbol Format 750 (FIG. 7a). (FS=01 is reserved for additional instruction formats.) If the instruction is in a terminal format (NT=0), then the Output Flag (OF) bit 32 (FIG. 7b) determines the precise instruction format: if OF=1, the instruction is in the Terminal—Output Format 775 (FIG. 7b); and if OF=0, the instruction is in the Terminal —No Output Format 795 (FIG. 7b). Since the three non-terminal instruction formats of FIG. 7a share many common features, and likewise the two terminal instruction formats of FIG. 7b share many common features, some instruction execution decisions rely only on the Non-Terminal (NT) flag 725 (FIGS. 7a and 7b), not on the precise instruction format.

Output information is sent to the current Output Formatter 470 if the current instruction has the Terminal—Output Format 775 (FIG. 7b). An output action may be so indicated if the next state is a (virtual) accepting terminal state, because a lexeme has satisfied a regular expression. As noted previously, the output information sent may comprise any one or more of various possible components. Some components, such as a token value corresponding to the regular expression that was accepted, and/or a parameter associated with the lexeme that may facilitate further processing of the output stream, can be taken from the current instruction's Token field 785 (FIG. 7b). If the start location of the identified lexeme is to be included in the output information sent, this may be taken from the Start Location (SL) register 1145 (FIG. 12) of the current Replicated Register Set 1130 (FIG. 12). In one embodiment, it is necessary to add or subtract a constant, such as subtracting one, from the contents of this register, in order to produce the actual start location of the lexeme, due to pipelining considerations particular to an implementation. If the end location of the identified lexeme is to be included, the current instruction's Backup Action (BUA) field 790 (FIG. 7b) indicates the source to be used in determining this end location. If a last accepting state backup is indicated (i.e., BUA=01), the end location of the identified lexeme is to be taken from the LASLP register 1215; if a trail head backup is indicated (i.e., BUA=10), the end location of the identified lexeme is to be taken from the THP register 1240; and if no backup is indicated (i.e., BUA=11), the end location of the identified lexeme is to be taken from the CL register 1140 (FIG. 12). It may be necessary to add or subtract a constant or various constants from the contents of these various registers, in order to produce the actual end location of the lexeme, due to pipelining considerations particular to an implementation. If a count of the number of symbols in the accepted lexeme is to be included in the output information sent, this may be calculated by subtracting the start location from the end location plus one, even though the start location and/or end location may not be included in the output sent.

The next state address to be communicated to the Memory Interface 450 (FIG. 4) is determined by adding a computed next offset to a computed next base address. The next base address is computed to be a pointer to the beginning of the next-state (or start-state) block corresponding to the next state. The next offset is computed to select the instruction from the next-state block corresponding to the out-transition from the next state that corresponds to the current symbol and current input status.

If the current instruction is in the Equivalence Class Format 700 (FIG. 7a), then the next base address is to be a pointer to the beginning of an Equivalence Class Block 900 (FIG. 9), and the next offset is to be an index into this block. The 21-bit next base address is determined by appending a low order zero bit to the 20-bit Next State Base Address field 705 (FIG. 7a). This appended zero bit is used because all Equivalence Class Blocks 900 (FIG. 9) begin at even-numbered addresses in the State Transition Table Memory 440 (FIG. 4), which allows the least significant base address bit to be omitted from the Equivalence Class Format 700 (FIG. 7a). The next offset is set equal to a symbol class from the Current Symbol Classes register 1120 (FIG. 12), selected according to the current instruction's Equivalence Class Select (ECS) field 715 (FIG. 7a). Thus, referring to the Equivalence Class Block 900 (FIG. 9), the next state address will point to the Class C transition, where C is the selected equivalence class value. Note that since equivalence class values are never zero (enforced by a compiler), the next state address will not point to the Accepting State Transition (Terminal); this address is only used during a stall condition (discussed later).

If the current instruction is in the One Symbol Format 740 (FIG. 7a), then the next base address is to be a pointer to the beginning of a One-Symbol Block—NAS 925 (FIG. 9) or a One-Symbol Block—AS 950 (FIG. 9), and the next offset is to be an index into this block. In one embodiment, the 21-bit next base address is determined by appending a low order zero bit to the 20-bit Next State Base Address field 705 (FIG. 7a). In this embodiment, the appended zero bit is used because all One Symbol Blocks 925 or 950 (FIG. 9) begin at even-numbered addresses in the State Transition Table Memory 440 (FIG. 4), which allows the least significant base address bit to be omitted from the One Symbol Format 740 (FIG. 7a).

In order to determine the next offset, the current instruction's Symbol Class field 745 (FIG. 7a) is compared to a symbol class from the Current Symbol Classes register 1120 (FIG. 12), selected according to the current instruction's Equivalence Class Select (ECS) field 715 (FIG. 7a). If these two symbol class values are equal, then the next offset is set to 1; otherwise the next offset is set to 0. Thus, referring to the One-Symbol Blocks 925 and 950 (FIG. 9), the next state address will point to either the Symbol Class Match Transition, or the No Symbol Class Match Transition, depending on whether the selected current symbol class matched the current instruction's Symbol Class field 745 (FIG. 7a). Although the next base address may point to the beginning of a One-Symbol Block—AS 950 (FIG. 9), in an advantageous embodiment the next state address will not point to the Accepting State Transition (Terminal); this address is only used during a stall condition (discussed later).

If the current instruction is in the Two Symbol Format 750 (FIG. 7a), then the next base address is to be a pointer to the beginning of a Two-Symbol Block 975 (FIG. 9), and the next offset is to be an index into this block. In one embodiment, the 21-bit next base address is determined by appending 6 high-order special bits and 2 low-order zero bits to the 13-bit Next State Base Address field 755 (FIG. 7a). The two zero bits are used because all Two-Symbol Blocks 975 (FIG. 9) begin at multiple-of-4 addresses in the State Transition Table Memory 440 (FIG. 4), which allows the two least significant base address bits to be omitted from the Two Symbol Format 750 (FIG. 7a). The 6 high-order special bits, which may be all zeros or another fixed or configurable value, locate all Two-Symbol Blocks 975 (FIG. 9) in a convenient region of the State Transition Table Memory 440 (FIG. 4); these special bits are used because the Two Symbol Format 750 (FIG. 7a) only has room for a 13-bit Next State Base Address field 755 (FIG. 7a) in a 36-bit instruction format, due to the presence of the 8-bit SC2 field 760 (FIG. 7a). For example, if the 6 high-order special bits are all zeros, then all Two-Symbol Blocks are located in the first 32K words of the State Transition Table Memory 440 (FIG. 4), as per the Two Symbol Transitions 1040 in FIG. 10. In order to determine the next offset, the current instruction's Symbol Class field 745 (FIG. 7a) and SC2 (Symbol Class 2) field 760 (FIG. 7a) are each compared to a symbol class from the Current Symbol Classes register 1120 (FIG. 12), selected according to the current instruction's Equivalence Class Select (ECS) field 715 (FIG. 7a). If the Symbol Class field 745 (FIG. 7a) matches, then the next offset is set to 1; if the SC2 field 760 (FIG. 7a) matches, then the next offset is set to 2; and if neither matches, the next offset is set to 0. Thus, referring to the Two-Symbol Block 975 (FIG. 9), the next state address will point to the No Symbol Class Match Transition, the Symbol Class 1 Match Transition, or the Symbol Class 2 Match Transition depending on the comparison results. In an advantageous embodiment, the next state address will not point to the Accepting State Transition (Terminal); this address is only used during a stall condition (discussed later).

If the current instruction is in the Terminal—Output Format 775 (FIG. 7b), then the next base address is to be a pointer to the beginning of a start-state block, and the next offset is to be an index into this block. In order to determine the next base address, a next start condition is first determined. If the current instruction's Use Start Condition (USC) flag bit 30 (FIG. 7b) is set, then the next start condition is equal to the current instruction's Start Condition field 780 (FIG. 7b); otherwise the next start condition is equal to the Current Start Condition 1155 (FIG. 12) of the current Replicated Register Set 1130 (FIG. 12). In an advantageous embodiment, the next base address is formed by appending 9 low-order ‘0’ bits to the next start condition. The next offset is set according to the current instruction's Backup Action (BUA) 790 (FIG. 7b). If a last accepting state backup is indicated (i.e., BUA=01), the next offset is set equal to the Last Accepting State Symbol Class (LASSC) 1225; however, 256 is added to this value if the L-BOL flag 1230 is set and start-state block pairs are in use for the next start condition. This selects the anchored start-state block from a start state block pair when the next lexeme to be scanned starts at the beginning of a line. If a trail head backup is indicated (i.e., BUA=10), the next offset is set equal to the Trail Head Symbol Class (THSC) 1245; but 256 is added to this value if the T-BOL flag 1250 is set and start-state block pairs are in use for the next start condition. If no backup is indicated (e.g., BUA=11), the next offset is set equal to a symbol class selected from the Current Symbol Classes 1120 (FIG. 12) in a fixed manner, such as selecting the first one; but 256 is added to this value if the BOL flag 1260 is set and start-state block pairs are in use for the next start condition. In other embodiments, a symbol class may be selected from the Current Symbol Classes 1120 according to configuration data or according to an ECS field added to the terminal formats 775 and 795 (FIG. 7b). Because LASSC 1225 and THSC 1245 hold symbol classes that were stored in a last accepting non-terminal state or a trail head state, respectively; these are used when the Backup Buffer 420 (FIG. 4) is directed to backup in the current input stream, in order to avoid waiting for the Backup Buffer 420 (FIG. 4) to perform that backup and retrieve a symbol from the backup point. That is, the symbol class used from LASSC 1225 or THSC 1245, as well as the beginning-of-line flag used from L-BOL 1230 or T-BOL 1250, correspond to the symbol at the directed backup point, and were stored for this purpose when the current input stream was previously at that backup point.

If the current instruction is in the Terminal—No Output Format 795 (FIG. 7b), then the next state address is generally computed in the same manner as for the Terminal—Output Format 775 (FIG. 7b), as described above. However, if the current instruction's Stall (ST) flag is set, and the Last Accepting State Flag (LASF) 1205 is set, then a stall occurs. When a stall occurs, a last accepting non-terminal state is treated as an accepting terminal state, and the Accepting State Transition (Terminal) of the last accepting state's next-state block structure (see FIG. 9) is executed. When a stall occurs, the next base address and next offset are not used; rather, the next state address is set equal to the address stored in the Last Accepting State Address (LASA) register 1220. This LASA register 1220 contains the address of an Accepting State Transition (Terminal) instruction, which was stored during a previous transition to the last accepting state. An instruction in which the Stall (ST) flag is set should have a Backup Action (BUA) 790 (FIG. 7b) indicating a last accepting state backup (e.g., BUA=01), which will govern if the Last Accepting State Flag (LASF) 1205 is not set.

Regardless of the current instruction format, if work on the current input stream needs to delay temporarily, such as because input or output in the context of the current input stream is delayed, the contents of the Current State Address register 1150 (FIG. 12) may be re-sent to the Memory Interface 450 (FIG. 4) as the next state address.

The next location in the current input stream to be communicated to the Backup Buffer 420 (FIG. 4) is usually one plus the Current Location 1140 (FIG. 12) in the current Replicated Register Set 1130 (FIG. 12). However, if the current instruction is in a terminal format (NT=0), the Backup Action (BUA) field 790 (FIG. 7b) may direct a backup in the current input stream. If a last accepting state backup is indicated (e.g., BUA=01), then the next location in the current input stream to be communicated to the Backup Buffer 420 (FIG. 4) is taken from the LASLP register 1215; if a trail head backup is indicated (e.g., BUA=10), then the next location in the current input stream to be communicated to the Backup Buffer 420 (FIG. 4) is taken from the THP register 1240; and if no backup is indicated (e.g., BUA=11), then the next location in the current input stream to be communicated to the Backup Buffer 420 (FIG. 4) is one plus the Current Location 1140 (FIG. 12), as usual. In one embodiment, it is necessary to add or subtract a constant or various constants from the contents of these various registers, in order to produce the actual next location in the current input stream, due to pipelining considerations particular to an implementation.

Some elements of the current Replicated Register Set 1130 (FIG. 12) are updated with new values whose determination has already been described. The Current Location register 1140 (FIG. 12) is updated with the next location in the current input stream being communicated to the Backup Buffer 420 (FIG. 4). The Current State Address register 1150 (FIG. 12) is updated with the next state address being communicated to the Memory Interface 450 (FIG. 4).

The Start Location register 1145 (FIG. 12) is updated to point to the beginning of a new lexeme only when the state machine enters an initial state to begin processing a new lexeme. This may be done either (1) when the current instruction is in a terminal format (NT=0) so that the next state is an initial state, or (2) when the current state is an initial state. In case (1), the Start Location register 1145 (FIG. 12) is updated using the next location in the current input stream being communicated to the Backup Buffer 420 (FIG. 4). In case (2), the Start Location register 1145 (FIG. 12) is updated using the Current Location register 1140 (FIG. 12). In either case, a fixed value may be added or subtracted, such as subtracting one, according to pipelining considerations particular to an implementation.

The Current Start Condition register 1155 (FIG. 12) is only updated when the current instruction has a terminal format (NT=0), and the current instruction's Use Start Condition (USC) flag bit 30 (FIG. 7b) is set. In this case, the Current Start Condition register 1155 (FIG. 12) is updated with the value of the Start Condition field 780 (FIG. 7b).

The Last Accepting State Flag (LASF) 1205 is set if the current instruction has a non-terminal format (NT=1) and the current instruction's Save Accepting (SAC) bit 34 (FIG. 7a) is set. This type of instruction represents a transition to a non-terminal accepting state. The Last Accepting State Flag 1205 is cleared if the current instruction has a terminal format (NT=0).

The Almost Done flag 1210 is cleared when processing of a new input stream begins. The Almost Done flag 1210 is set when the EOF flag 1265 indicates that the current symbol is the last one in the current input stream (or is an EOF meta-symbol). However, the Almost Done flag 1210 is not set during a stall or backup condition—that is, when the current instruction has a terminal format, and the Backup Action (BUA) 790 (FIG. 7b) indicates either a last accepting state backup (e.g., BUA=01) or a trail head backup (e.g., BUA=10).

The Last Accepting State Registers 1165 (FIG. 12) are updated when the current instruction has a non-terminal format (NT=1) and the current instruction's Save Accepting (SAC) bit 34 (FIG. 7a) is set. This type of instruction represents a transition to a non-terminal accepting state. The Last Accepting State Location Pointer (LASLP) register 1215 is updated with the pointer in the Current Location register 1140 (FIG. 12), possibly adding or subtracting a constant, such as adding one, according to pipelining considerations particular to an implementation. The Last Accepting State Address (LASA) register 1220 is updated with the address of the Accepting State Transition (Terminal) instruction in the next-state block of the next state. Thus, if the current instruction has the Equivalence Class Format 700 (FIG. 7a), so that the next base address points to the beginning of an Equivalence Class Block 900 (FIG. 9), then the LASA register 1220 receives the next base address (the implied offset is 0); if the current instruction has the One Symbol Format 740 (FIG. 7a), so that the next base address points to the beginning of an One-Symbol Block—AS 950 (FIG. 9), then the LASA register 1220 receives the next base address plus an offset of 3; and if the current instruction has the Two Symbol Format 750 (FIG. 7a), so that the next base address points to the beginning of a Two-Symbol Block 975 (FIG. 9), then the LASA register 1220 receives the next base address plus an offset of 3. The value stored in the LASA register 1220 may be used during a subsequent stall condition. The Last Accepting State Symbol Class (LASSC) register 1225 is updated with the value of a symbol class selected from the Current Symbol Classes register 1120 (FIG. 12) in a fixed manner, such as selecting the first symbol class. In other embodiments, a symbol class may be selected from the Current Symbol Classes 1120 according to configuration data or according to information in the current instruction, such as the ECS field 715 (FIG. 7a). The Last Accepting State Beginning-of-Line (L-BOL) flag 1230 is updated with the value of the current symbol's BOL flag 1260. The Last Accepting State End-of-File (L-EOF) flag 1235 is updated with the value of the current symbol's EOF flag 1265.

The Trailing Context Registers 1170 (FIG. 12) are updated when the current instruction has a non-terminal format (NT=1) and the current instruction's Save Trail Head (STH) bit 33 (FIG. 7a) is set. This type of instruction represents a transition to a trail head state. The Trail Head Pointer (THP) register 1240 is updated with the pointer in the Current Location register 1140 (FIG. 12), possibly adding or subtracting a constant, such as adding one, according to pipelining considerations particular to an implementation. The Trail Head Symbol Class (THSC) register 1245 is updated with the value of a symbol class selected from the Current Symbol Classes register 1120 (FIG. 12) in a fixed manner, such as selecting the first symbol class. In other embodiments, a symbol class may be selected from the Current Symbol Classes 1120 according to configuration data or according to information in the current instruction, such as the ECS field 715 (FIG. 7a). The Trail Head Beginning-of-Line (T-BOL) flag 1250 is updated with the value of the current symbol's BOL flag 1260. The Trail Head End-of-File (T-EOF) flag 1255 is updated with the value of the current symbol's EOF flag 1265.

Various methods may be used by someone skilled in the art to determine if processing of the current input stream should terminate. Processing may terminate immediately after the Almost Done (AD) flag 1210 is set, or after one or more additional execution steps. Processing may also terminate under some circumstances when the current symbol's EOF flag 1265, or the L-EOF 1235 or T-EOF 1255 flags are set, with consideration to whether these flags indicate the last symbol in an input stream, or indicate EOF meta-symbols inserted after the end of the input stream. Processing may also terminate if the current instruction has a terminal format, and the Job Terminate (JT) bit 29 is set (see FIG. 7b). In some embodiments, use of the JT bit may be disabled by configuration data. In some embodiments, it may be important to allow processing of the current input stream to continue even after such conditions, such as when a backup in the input stream will cause one or more last symbols in the current input stream to be scanned again. The method used to determine when processing of the current input stream should terminate may depend heavily on pipelining and other architectural considerations.

In an advantageous embodiment, the Backup Buffers 420 (FIG. 4) may be configured to insert EOF meta-symbols after the end of the current input stream, and the EOF 1265, L-EOF 1235 and T-EOF 1255 flags may indicate the presence of such EOF meta-symbols. Processing of the current input stream may then be allowed to continue some distance beyond its last actual symbol, which may facilitate careful detection of termination conditions. Various behaviors of the Core Execution Unit 460 (FIG. 4) may be defined by someone skilled in the art to govern how EOF meta-symbols are processed. In one embodiment, EOF meta-symbols cause failure transitions in the implied state machine. In one embodiment, One Symbol Format 740 (FIG. 7a) and Two Symbol Format 750 (FIG. 7a) instructions executed on EOF meta-symbols cause the next state address to be the address of the No Symbol Class Match Transition of the next-state block 925, 950 or 975 (FIG. 9). In one embodiment, Equivalence Class Format 700 (FIG. 7a) instructions rely on distinctive symbol classes assigned to EOF meta-symbols by the Symbol Classes Lookup Table 430 (FIG. 4) to cause a failure transition. Processing may be terminated as early as it can be determined that no further regular expressions can be matched by an input stream. Processing should not terminate if the current instruction indicates a backup in the input stream to the location of an actual symbol. Processing should not terminate if the next instruction to be fetched could indicate such a backup. Processing should not terminate if a stall condition may cause an Accepting State Transition (Terminal) instruction to be fetched, which may indicate such a backup.

In one embodiment, if the current instruction has a terminal format, and the current symbol's EOF flag 1265 is set, and the Backup Action (BUA) 790 (FIG. 7b) indicates no backup, then processing of the current input stream may terminate. In one embodiment, if the Almost Done (AD) flag 1210 is set, and the current instruction has a non-terminal format, then processing may terminate. In one embodiment, if the Almost Done (AD) flag 1210 is set, and the current instruction has a terminal format, and the Backup Action (BUA) 790 (FIG. 7b) indicates no backup, then processing may terminate. In one embodiment, if the current instruction has a terminal format, and the Backup Action (BUA) 790 (FIG. 7b) indicates a last accepting state backup, and the L-EOF flag 1235 is set, then processing may terminate. In one embodiment, if the current instruction has a terminal format, and the Backup Action (BUA) 790 (FIG. 7b) indicates a trail head backup, and the T-EOF flag 1255 is set, then processing may terminate.

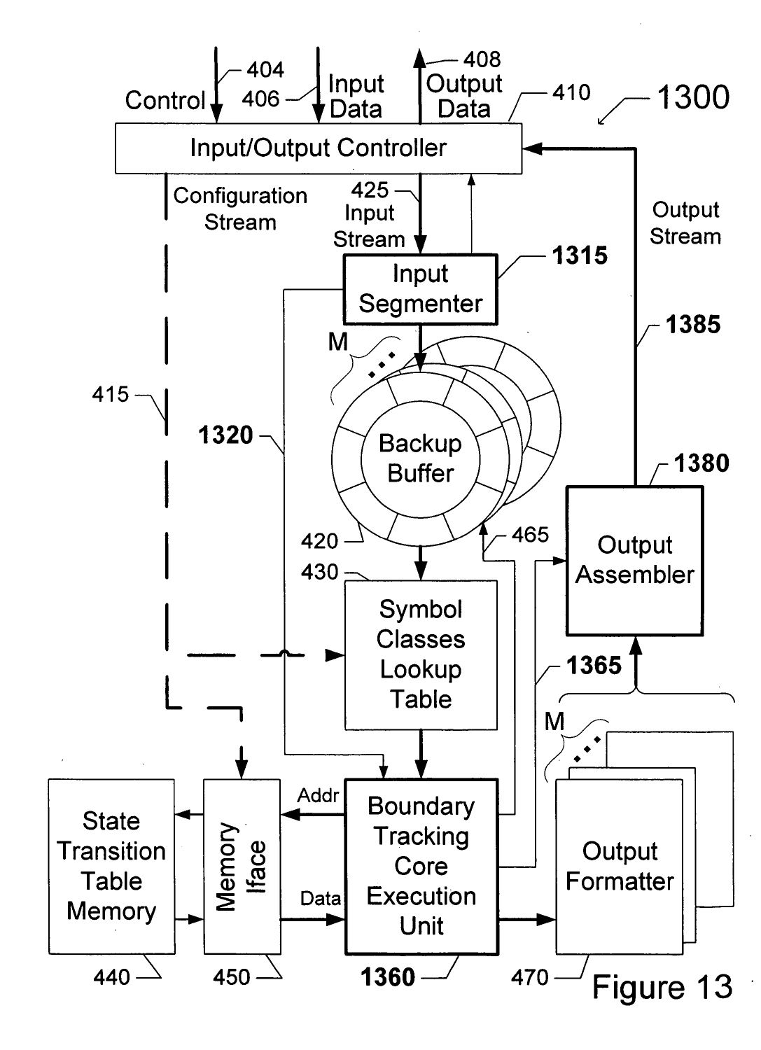

In each of the embodiments discussed above, systems and methods have been described for processing a multiplicity of independent input streams simultaneously. In addition to this feature, the systems and methods described herein may also be applied to the processing of a single input stream, wherein the input stream may be processed faster and more efficiently than prior art systems. In particular, FIG. 13 illustrates an exemplary State Machine Engine 1300 for processing a single Input Stream 425 up to M times faster than each of the M individual streams of FIG. 4 by using a modified version of the State Machine Engine 400 (FIG. 4) referenced herein as State Machine Engine 1300. In the embodiments described herein, this capability is performed by first making an entire input stream available for random access in a memory. Such a stored input stream is referred to here as a file. In general, the modifications to State Machine Engine 400 consist of adding an Input Segmenter 1315 between an Input/Output Controller 410 and a plurality of M Backup Buffers 420, an Output Assembler 1380 between a plurality of M Output Formatters 470 and the Input/Output Controller 410, and a boundary tracking mechanism to a core execution unit to create a Boundary Tracking Core Execution Unit 1360.

In one embodiment, the Input Segmenter 1315 contains memory for buffering a single input stream. In one embodiment, processing commences on a file as soon as the data stream for the file is received and stored. A next stream may then be received and buffered while the file is being processed. Alternatively, processing may commence on a file before the entire file is buffered, and as soon as a predetermined amount of the data stream is received and stored, where the predetermined amount may be different in various systems and may be a factor in the efficiency of the State Machine Engine 1300. In one embodiment, when a file is ready for processing, the Input Segmenter 1315 divides the size of the file by M to define M regions and to locate M corresponding offsets within the file so that M substreams can be created, each containing approximately 1/M^{th} of the file, one per region. In this embodiment, regions represent portions of the file with fixed boundaries, while substreams represent portions of a file that may extend across region boundaries. Thus, while analysis of an i^{th} substream may begin at the start boundary of the i^{th} region, analysis of the substream may continue into subsequent regions, such as the i+1^{st} region, i+2^{nd} region, and the M^{th} region. For example, for a file of size M*P, a first offset of a first region assigned to a first substream is 0, a second offset of a second region assigned to a second substream is P, a third offset of a third region assigned to a third substream is 2*P, an i^{th} offset of an i^{th} region is assigned to an i^{th} substream is (i−1)*P, and a last offset of a last region assigned to an M^{th} substream is (M-1)*P. In one embodiment, these offsets are each stored in one of M registers. In an advantageous embodiment, the first offset is 0, so it does not need to be stored in a register. However, in some embodiments there may be an implied or virtual Offset register 1 that contains the 0 offset and the remaining M-1 offsets may be stored in M-1 Offset registers numbered from 2 through M. In this embodiment, Offset register i points to the beginning of substream i, where 1≦i≦M.

In another embodiment, a memory containing files to be scanned is external to the State Machine Engine 1300 and connected to the Input/Output Controller 410 via the Input Data 406, Control 404, and Output Data 408 busses. In this embodiment, during an initialization process, a plurality of M-1 Offset registers in an Input Segmenter 1315 are loaded with externally computed offset locations relative to the beginning of the file, that divide the file into M sections. Using the offset information, the Input/Output Controller 410 fetches M substreams from M different regions of the same input file simultaneously and the Input Segmenter 1315 directs each to an associated Backup Buffer 420.

Independent of the memory arrangement, due to the method to be described for determining when to stop processing an input substream, selection of the division points between segments is unconstrained. In one embodiment, if the input file size is not evenly divisible by M, each computed offset may be rounded down to the nearest integer. In another embodiment, if the input file size is not evenly divisible by M, each computed offset may be rounded up to the nearest integer. In another embodiment, if the input file size is not a multiple of a power of two, each computed offset may be adjusted to the nearest multiple of a power of two. This embodiment may have the advantage of reducing the amount of logic required to implement this feature. As a practical matter, it is advantageous to choose a sequence of boundaries that increase in value and are approximately equally spaced. The greatest speedup is most likely to be achieved if each segment is, as close as practicable, equal in size to the others. Equal spacing does not, however, guarantee equal processing times as will be explained later. In one embodiment, processing of a next file in the input stream cannot begin until processing of the last segment of the current file is complete. Various design considerations and trade-offs, such as someone practiced in the art would make, may be implemented in order to perfect the equal spacing of file segments in the memory. These various design considerations may be employed without impacting the other elements of this single file processing capability.

The State Machine Engine 1300 also includes a Core Execution Unit with Boundary Tracking 1360 that is configured to process portions of adjacent substreams in order to properly identify lexemes that cross boundaries between substreams, in addition to performing the other features described with respect to Core Execution Unit 460. In an advantageous embodiment, when the State Machine Engine 1300 is processing substream i, some symbols in the i+1^{st} region (that is processed by the i+1^{st} substream) may also processed in order to ensure that any lexeme crossing the border between the i^{th} and i+1^{st} regions is identified. However, only some of the symbols in the i+1^{st} region are typically needed for processing in connection with the i^{th} substream. In the event that the boundary corresponds to a correct lexical boundary, the State Machine Engine 1300 may determine that none of the symbols in the i+1^{st} region need to be examined. Accordingly, in an advantageous embodiment, the State Machine Engine 1300 determines if any symbols in the i+1^{st} region needs to be examined and, if so, when it is safe to stop processing each substream, as each substream crosses borders of one or more subsequent region. Safe, as used herein, is defined as being certain that enough processing has been performed so that it is possible to produce the same result as if the file were processed sequentially by a single state machine engine. In one embodiment, it is safe to stop processing the i^{th} substream after the processing has reached the beginning of the i+1^{st} region, and when either (1) the next transition is to a start state of the initial start condition; or (2) an output result from processing the i+1^{st} region is the same as an output result already produced by processing the i+1^{st} substream. The purpose of re-processing symbols in the i+1^{st} region in combination with those from the i^{th} region is to identify lexemes that may cross the border of the substreams. However, when the re-processing of the i+1^{st} region in combination with the ith substream reaches a point where it is returning the same results as were already identified in processing of the i+1^{st} substream, the re-processing of symbols in the i+1^{st} region may stop. In case of disagreement, the results associated with processing the i^{th} stream, in which the first symbols of the i+1^{st} region were reprocessed, take precedence over those previously produced during the original processing of the i+1^{st} region by the i+1^{st} substream. The later produced results are correct because they take into account the necessary context from the i^{th} region that may be missing from the beginning of the i+1^{st} stream, which starts processing at the beginning of the i+1^{st} region. For example, this occurs when the boundary between the i^{th} and the i+1^{st} regions falls in the middle of a lexeme, as is explained in more detail below. Any embodiment that behaves in the above-described manner will be able to produce the same result as if the file were processed sequentially by a single state machine engine.

The divisions that result from arbitrarily subdividing an input file typically do not correspond to correct lexical boundaries in the file. The following example illustrates the situation. A given set of regular expressions may include an expression for recognizing variable names, such as ‘[A-Za-z][A-Za-z0-9_-]*’. If the variable name ‘myCounter’ falls across a boundary in an input file, so that a character in the middle of the word, ‘o’ for example, is the first character of the i+1^{st} region, ‘ounter’, which may be a legitimate variable name, will be identified as the first lexeme in the i+1^{st} substream. Additionally, if processing of the i^{th} substream were to stop at ‘C’, which is the last character of the i^{th} region before the boundary, ‘myC’, also a legitimate variable name, would be identified as the last lexeme in the i^{th} substream. Thus, identifying lexemes that cross boundaries between segments requires processing of the i^{th} substream to continue as far past the i^{th} region as necessary to establish the real, lexically correct boundary. Furthermore, false outputs from the beginning of the i+1^{st} substream should be ignored when the M output segments are integrated into a single output result. Hence, in an implementation that meets the earlier-stated requirements, the last lexeme reported as output by the processing of the ith substream will be ‘myCounter’, which includes symbols from the end of the i^{th} region and the beginning of the i+1^{st} region. This will replace the first output reported by the processing of the i+1^{st} substream, ‘ounter’. Once a lexeme is reported, the state machine engine returns to a start state. If processing of the i^{th} substream returns to the original start state in effect when processing of the current file began, after outputting ‘myCounter’, and processing of the i+1^{st} substream returns to the same state after outputting ‘ounter’, the subsequent output streams of both processes will be identical. Thus, the processing for the i^{th} substream can stop at that point.

In one embodiment, the above-described challenges of properly identifying lexemes in a segmented file are met by recording two pieces of information each time a symbol is processed in the second through M^{th} substreams. In particular, (1) a one bit indication that output was initiated and (2) a one bit indication that a start state of the initial start condition is going to be entered, are recorded as each symbol is processed. M-1 history memories, numbered from 2 through M, may be used for this purpose. In one embodiment, boundary tracking logic associated with the i+1^{st} substream (taken from the i+₁ t region of the input file) writes its 2 bit information per symbol into the i+1^{st} memory, recording a history trace, and boundary tracking logic associated with the i^{th} substream (taken from the i^{th} region of the input file) reads that history from i+1^{st} memory and compares it with its own version of same, once it has crossed the boundary between the i^{th} and the i+1^{st} regions, where 1≦i<M. In an advantageous embodiment, all substreams are processed in parallel so that the history trace associated with the i+1^{st} substream is already recorded in the i+1^{st} history memory when the processing for substream i reaches the boundary. In this embodiment, if the final symbol of region i did not cause a transition to a start state of the initial start condition, processing of the i^{th} substream should continue into the i+1^{st} region. As the processing associated with substream i begins to reprocess the symbols at the beginning of region i+1, processing of substream i generates the same two pieces of information, but in the context of the state it was in when it entered the i+1^{st} region. Comparison is made between this current information and the previously recorded history associated with substream i+1. When a current symbol from the i+1^{st} region, accessed during the processing associated with substream i, indicates a transition to the initial start condition (in effect at start of processing for the current file) will be made and the recorded history indicates that the same symbol previously caused the same transition during the original processing of the i+1^{st} substream, processing of substream i stops. Accumulating the number of recorded occurrences of output, prior to the stop criteria being met, indicates the number of output entries to skip in the original output associated with substream i+1. Those entries are replaced with the correct entries at the end of the output associated with substream i. Substream M simply stops when the end of the file is reached.

Independent of all the variations in the above-described embodiments for storing input files and initializing Offset registers, the Input Segmenter 1315 contains an Initial Start Condition register that stores a start condition that is in effect when processing of a current input file commences. This information and the offset information is communicated to the Boundary Tracking Core Execution Unit 1360 via bus 1320 and enables it to determine when to stop processing each of the substreams.

In the embodiment of FIG. 13, the Boundary Tracking Core Execution Unit 1360 contains M-1 memories numbered from 2 through M for recording boundary tracking information. In this embodiment, the i^{th} memory is associated with the i^{th} substream and no memory is needed for the first substream. In an advantageous embodiment, each memory is implemented with independent read and write ports. In one embodiment, each memory is two bits wide and as deep as the largest file segment supported by the implementation. This approach allows a determination of the correct lexical boundary to be made regardless of where it occurs within a segment, but limits the maximum size of a file that can be scanned to M times the maximum segment size. In another embodiment, each memory is two bits wide and of a fixed depth selected to correspond to a maximum range of overlap. Regular expressions are written to generally match lexemes no larger than the maximum range of overlap. However, if a correct lexical boundary is not identified before the available memory is exhausted, the Boundary Tracking Core Execution Unit 1360 continues processing symbols associated with the i^{th} substream at least until the i+2^{nd} boundary is reached, and then uses the information recorded in the i+2^{nd} memory to continue looking for a correct lexical boundary. This process is repeated until either the stop criteria is met or the end of the file is reached. This exemplary embodiment advantageously imposes no limits on the maximum size of a file that can be scanned, but a performance penalty is incurred if the correct lexical boundary cannot be identified within the maximum region of overlap allowed. In most practical applications, someone practiced in the art can write the regular expressions needed so that the penalty is avoided.

In one embodiment, the Boundary Tracking Core Execution Unit 1360 contains means to compute a write and a read address for the i^{th} memory, 2≦i≦M. In one embodiment, the write address computation means consists of logic to subtract the contents of the i^{th} Offset register from the contents of a Current Location register 1140 (FIG. 11) associated with the i^{th} substream. The i^{th} substream's Current Location register is initialized with the value stored in the i^{th} Offset register, so the sequence of write addresses begins at zero and increments by one as each symbol is processed. If the depth of each boundary tracking memory is less than the maximum supported segment size, means are also provided to detect when the last memory location has been written and prevent further writing into the memory. In one embodiment, the read address computation means consists of logic to subtract the contents of the i^{th} Offset register from the contents of a Current Location register 1140 (FIG. 11) associated with the i−1^{st} substream. As processing proceeds on substream i−1, the value computed for the read address will be negative before the i^{th} substream boundary is reached. Thus, additional logic may be provided for detecting when the computed read address becomes zero, signaling that the i^{th} substream boundary is reached and that the process for detecting the location of the actual lexical boundary may commence. If the depth of the memory is less than the maximum supported file segment size, means may also be provided to detect when the last memory location has been read and prevent further reading from the memory.

In another embodiment, every substream file segment size is selected so that it is the nearest multiple of a power of two that is greater than or equal to 2^{m}. This results in every substream boundary having a value in which the m low order bits are zero. In such an embodiment, the depth of each boundary tracking memory is less than or equal to 2^{m}. The m low order bits of a Current Location register 1140 (FIG. 11) associated with the i^{th} substream are used as a write address for the i^{th} boundary tracking memory, 2≦i≦M. If the depth of each boundary tracking memory is less than the maximum supported segment size, means may also be provided to detect when the last memory location has been written and prevent further writing into the memory. The read address is taken from the m low order bits of a Current Location register 1140 (FIG. 11) associated with the i−1^{st} substream. If each current location register has p bits, means may be provided to compare the p-m high order bits of the i−1^{st} substream's Current Location register 1140 the corresponding bits of the i^{th} Offset register. When equality is detected, the i^{th} substream boundary has been reached and the process for detecting the location of the actual lexical boundary may commence. If the depth of each boundary tracking memory is less than the maximum supported segment size, means may also be provided to detect when the last memory location has been read and prevent further reading from the memory.

Independent of the means used to produce the read and write addresses for each boundary tracking memory, in one embodiment, the means to derive the information to be recorded is as follows. As each symbol is processed in the i^{th} substream, where 2≦i≦M, an S bit and an OT bit are recorded in the i^{th} boundary tracking memory. The value of S is 1 if a Start Condition field 780 (FIG. 7b) of a terminal format instruction 640 (FIG. 6a), 775 or 795 (FIG. 7b), fetched into an Instruction Register 1115 (FIG. 11) as a result of processing the current symbol, matches the value stored in an Initial Start Condition register in the Input Segmenter 1315 (FIG. 13). Otherwise the value of S is 0. The value of OT is 1 if a Terminal format 640 (FIG. 6a) instruction with an output flag bit from a Flags field 635 (FIG. 6a) is set or a Terminal Output format 775 (FIG. 7b) instruction was fetched into the Instruction Register 1115 (FIG. 11). Otherwise, the value of OT is 0. Once the i−1^{st} substream processing reaches its boundary with the i^{th} substream, a current S bit value is computed as described above and compared to a corresponding recorded S value in the i^{th} boundary tracking memory. When the current and recorded S values are both 1, processing of the i−1^{st} substream can stop, following completion of the execution of the terminal format instruction pending in the Instruction Register 1115. If execution of the terminal format instruction includes an output operation, the final and correct lexeme associated with the i−1^{st} substream is sent to its assigned Output Formatter 470 (FIG. 13). On each read access of the i^{th} boundary tracking memory, the value of the OT bit is added to an accumulated sum until the stop criteria is met. Each i^{th} sum is forwarded to the Output Assembler 1380 (FIG. 13) via bus 1365 (FIG. 13) where it is stored in an i^{th} Skip register.

The Output Assembler 1380 provides the means for assembling the correct single output stream. When the Boundary Tracking Core Execution Unit 1360 signals completion of all substreams, the Output Assembler 1380 retrieves the output information associated with each substream in sequential order and sends it to the Input/Output Controller 410 to produce the Output Data 408. After completing the output information associated with the first substream, the Output Assembler 1380 reads the i^{th} Skip register and begins retrieving the i^{th} output list at the offset indicated by the value in that register. Those of skill in the art will recognize that the above-described systems and methods for segmenting and analyzing a file may be implemented in many other ways. The above implementation details are provided for purposes of illustration and are not meant to limit the scope of the above-described systems and methods.

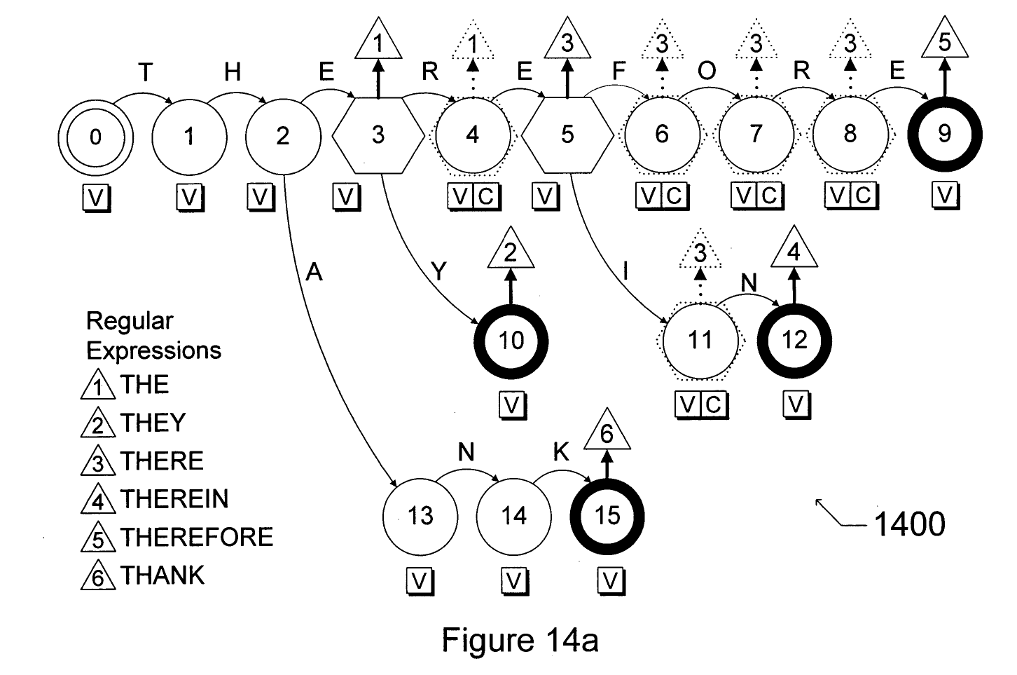

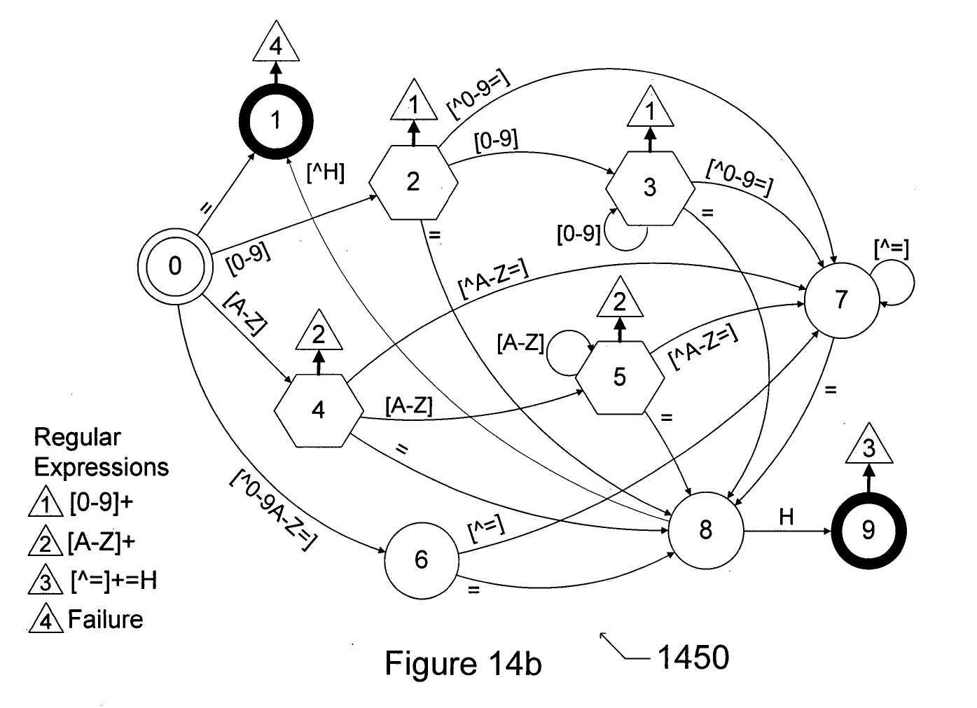

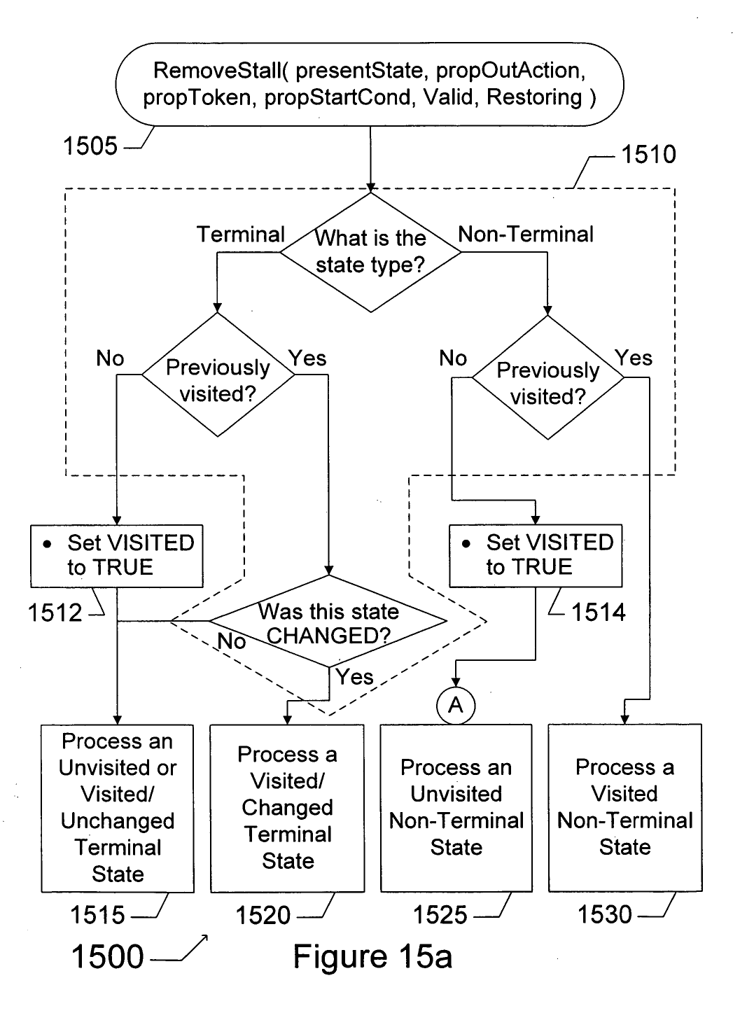

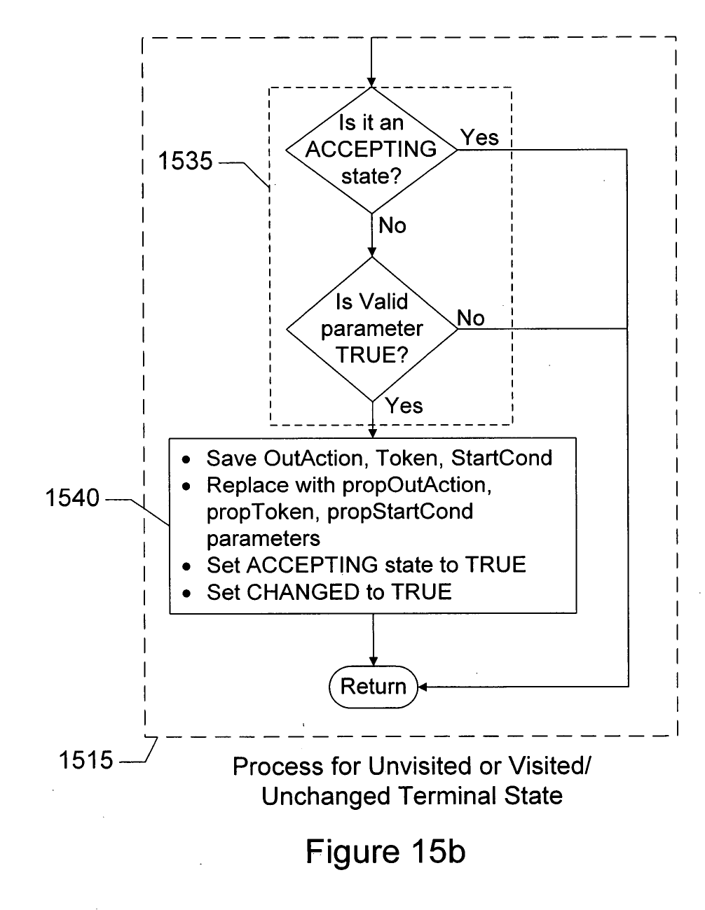

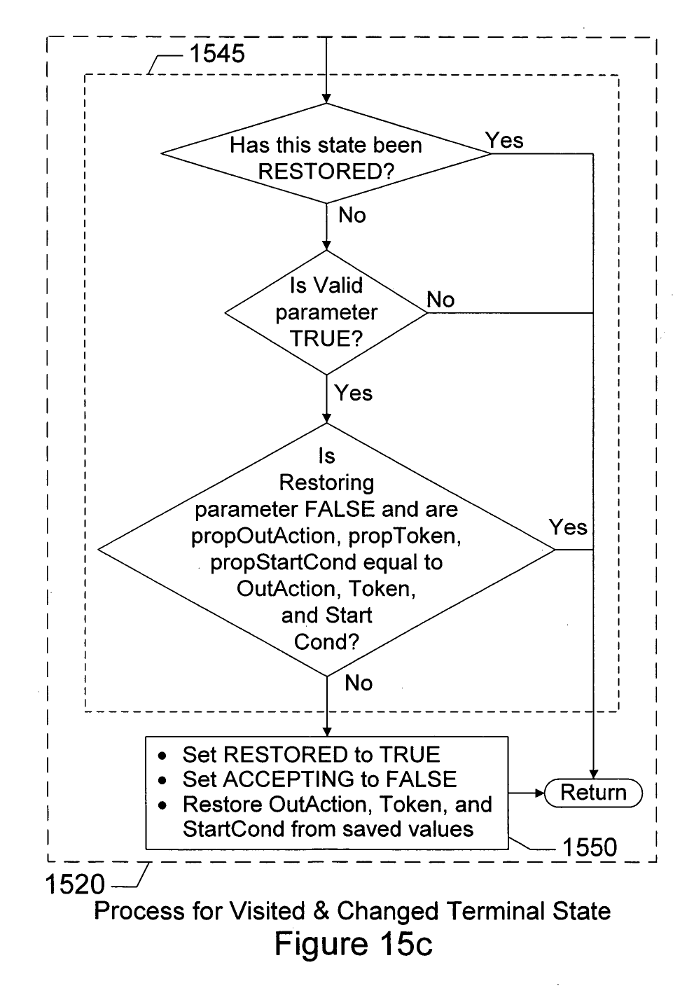

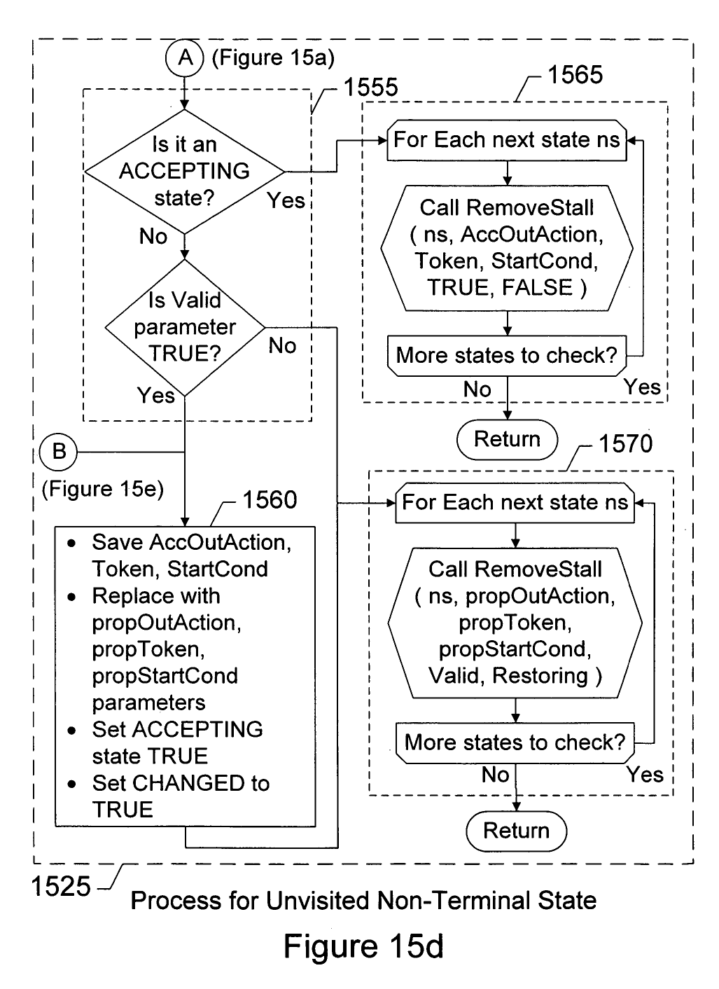

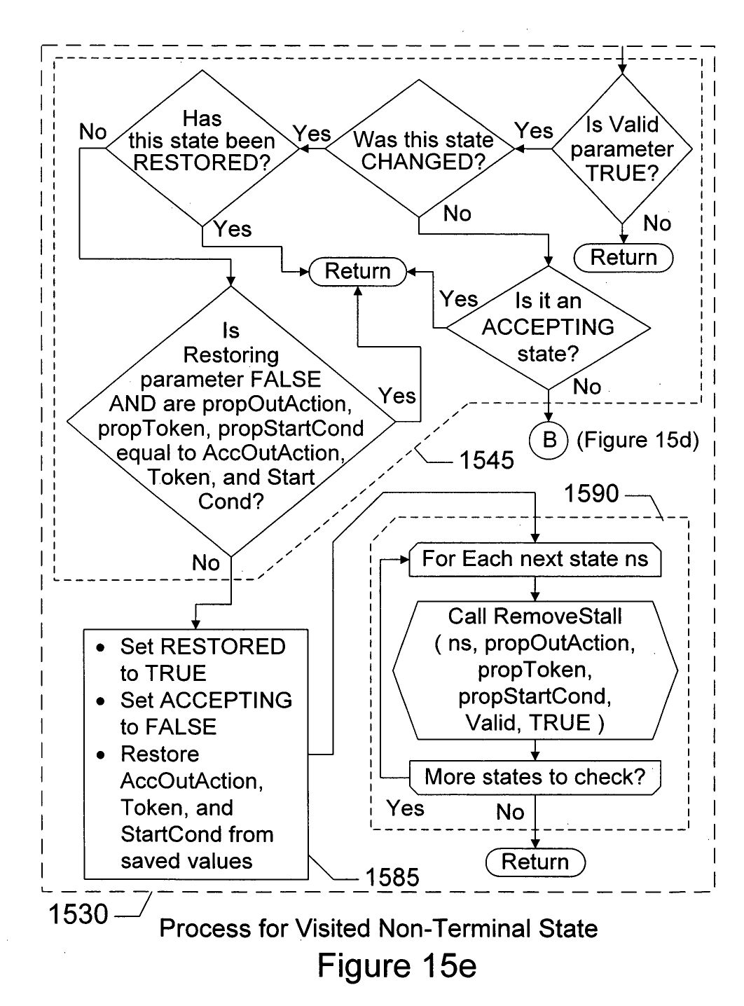

A number of previous references have been made to situations where a stall occurs while executing the instructions that represent a state machine. In general, a stall occurs when a clock cycle passes without accessing a symbol from an input stream. For example, a stall occurs when a state machine engine has to fetch an instruction from a state transition table memory without accessing a symbol from an input stream. One goal of high performance operation is to perform one instruction fetch per symbol access from a backup buffer. The state machines shown in FIG. 14 will be used to illustrate how stall conditions occur. FIG. 14a is used to characterize situations in which stall conditions can be eliminated whereas FIG. 14b characterizes situations in which they cannot. Then a stall removal algorithm 1500 (FIG. 15) will be explained and FIG. 14 will be used to illustrate how it works.

FIG. 14a illustrates a state machine 1400 with sixteen states numbered from 0 to 15 The exemplary state machine 1400 was generated by compiling the following six literal expressions: (1) ‘THE’; (2) ‘THEY’; (3) ‘THERE’; (4) ‘THEREIN’; (5) ‘THEREFORE’; and (6) ‘THANK’. For convenience, the characters are shown next to each transition arc. However, as described above, in an actual implementation each unique character is assigned a unique symbol class. In the figure, the regular expression number is shown inside a triangle. Each state that is either a non-terminal accepting state or a terminal accepting state is shown with an arrow pointing to a triangle containing the number of the regular expression that it accepts. For example, state 5 is a non-terminal accepting state for regular expression number (3). No stall can occur until after a non-terminal accepting state has been encountered. For example, upon reaching any of states 0, 1, 2, 13, or 14, a last accepting state flag 1205 (FIG. 12), which is cleared each time there is a transition into initial state 0, will indicate that all failure transitions from those states are to return to the initial state 0 and the next symbol may be fetched from the location in a backup buffer that is one past the value in a start pointer register 1145 (FIG. 12). Accordingly, a stall condition cannot occur as a result of processing any of states 0, 1, 2, 13, or 14. Likewise, a stall cannot occur when the state machine is in a terminal or non-terminal accepting state. For example, in FIG. 14a the non-terminal accepting states are 3 and 5. When a state machine engine reaches either state, it can determine in every instance what the next state is without stalling. A two-symbol block 975 (FIG. 9) could be used to represent the out-transition instructions for state 5, for example. If the next symbol is ‘F’ or ‘I’, one of the instructions at offset 1 or 2 from the base address of that block will be fetched. If any other symbol is next, due to the last accepting state flag 1205 (FIG. 12) having been set by the in-transition instruction to state 5, the accepting state transition instruction is fetched and executed. Otherwise, the failure transition at offset 0 would be used, causing transition back to initial state 0 or the implied failure terminal state, if there is one, and the next symbol in the input stream is processed. Each terminal state 9, 10, 12, and 15 is an accepting state so no stall condition can occur.

In the exemplary state machine 1400, stalling may occur in any of states 4, 6, 7, 8, and 11. In state 7, for example, if the next input is not an ‘R’ and the last accepting state flag is set, there is no information in the next-state block that the state machine engine can use to determine what the next state address should be, in a single clock cycle. The state machine engine has to go back to the next-state block associated with state 5 and fetch the accepting state transition instruction. In an advantageous embodiment, this stall condition may be eliminated by using the normally unused accepting state transition location in each of the next-state block types suitable for non-terminal accepting states (e.g., Equivalence Class Block 900, One-Symbol Block—AS 950, and Two-Symbol Block 975 of FIG. 9).

In one embodiment, the Compiler 220 (FIG. 2) traces through all the paths in a data structure representing the state machine and propagates the information in the accepting state transition instruction associated with each non-terminal accepting state to all downstream non-terminal states until the next non-terminal accepting state or a terminal state is encountered. Downstream states consist of a set of states that can be reached by some sequence of transitions from the current state. The set may contain any of the states in the machine including the current state. If this downstream propagation is done, then a state machine engine will have the information needed to determine the next state address when none of the symbols of interest is next and the last accepting state flag 1205 (FIG. 12) is set. In FIG. 14a, the effect of this would be to convert state 4 into a non-terminal accepting state for expression (1) and states 6, 7, 8, and 11 into non-terminal accepting states for expression (3). With each of states 4, 6, 7, 8, and 11 converted to non-terminal accepting states as described above, the state machine 1400 no longer includes any stall conditions. Accordingly, repeated execution of the state machine 1400 becomes faster and more efficient when compared to the same state machine in which stall conditions may occur at each of states 4, 6, 7, 8, and 11.

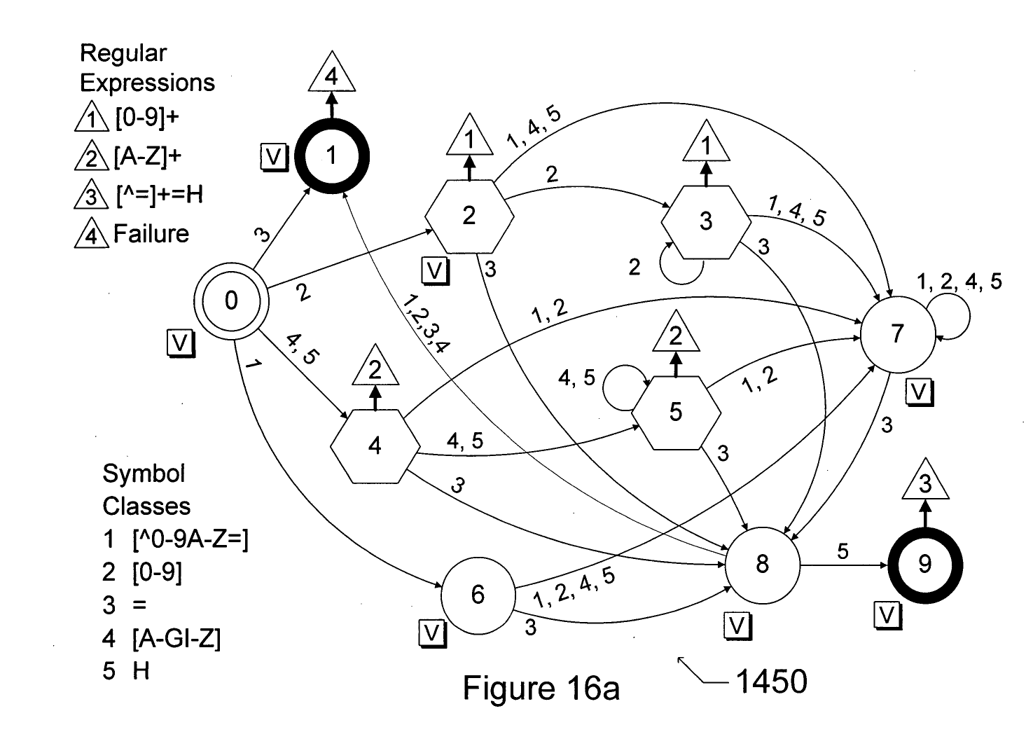

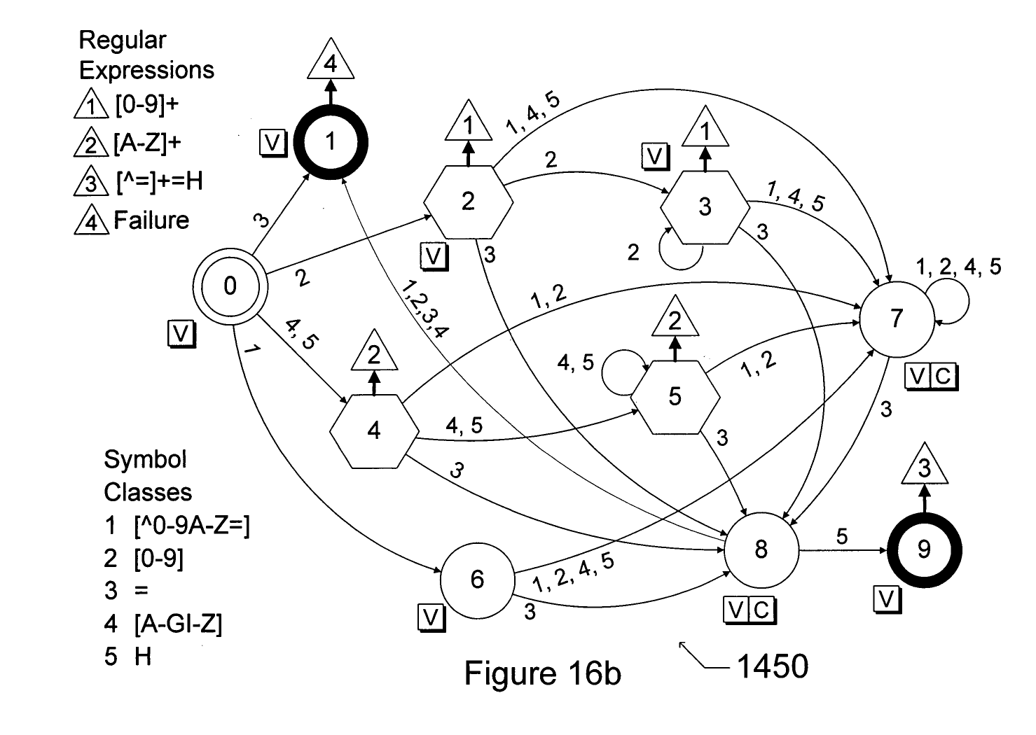

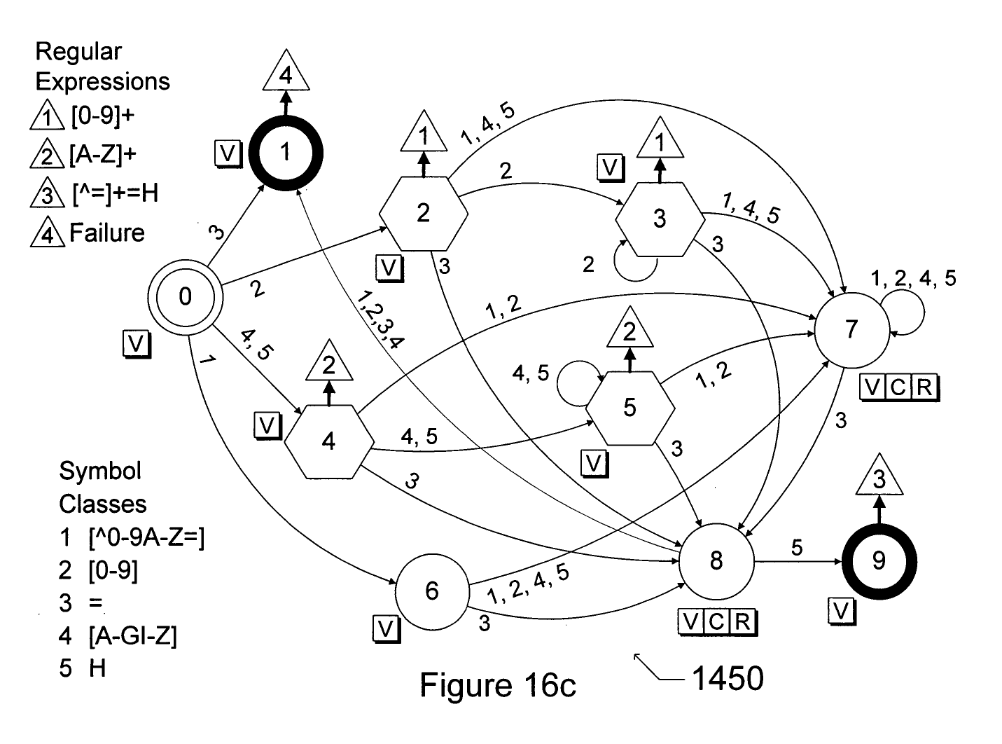

FIG. 14b shows state machine 1450 with ten states numbered from 0 to 9. State machine 1450 results when the following three regular expressions are compiled: <1>‘[0-9]+’; <2>‘[A-Z]+’; and <3>‘[\hat{ }=]+=H’. To make FIG. 14b easier to read, equivalence class expressions are shown on each transition arc. In the actual implementation, the following five symbol classes are used: (1) ‘[\hat{ }0-9A-Z=]’; (2) ‘[0-9]’; (3) ‘=’; (4) ‘[A-GI-Z]’; and (5) ‘H’. That is, class (1) represents every symbol that is not a digit, upper case letter, or equal sign; class (2) represents the digits; class (3) represents only the equal sign; class (4) represents all the upper case letters except ‘H’; and class (5) represents only the upper case letter ‘H’. Every transition shown in FIG. 14b can be represented by some combination of one or more of the five classes so defined. For example, the transition from state 5 to state 7, ‘[\hat{ }A-Z=]’, really consists of two transitions, one for class (1) and the other for class (2). The transition from state 5 to state 5, ‘[A-Z]’, really consists of two transitions, one for class (4) and the other for class (5). The complete set of transitions using symbol classes is shown in FIG. 16a. In FIG. 14b, the regular expression number is shown inside a triangle and each terminal or non-terminal accepting state has a reference to the expression it accepts. For example, states 2 and 3 are non-terminal accepting states for regular expression number <1>. Terminal state 1 is an accepting state for failures. It is assigned the special failure expression ID <4>. Terminal state 9 is an accepting state for regular expression number <3>. Since a stall condition cannot occur until after a non-terminal accepting state has been encountered, only states 7 and 8 are subject to stalling, and only if reached via a sequence of transitions that do not include state 6. Using the above-described methods, stalling is not avoided for any state in which at least two in-transitions are from non-terminal accepting states that accept different regular expressions. In one embodiment, determination at compile time of the path that will be taken by a given input file may not be determined. The path through the state machine is determined at run time and is precisely the situation the stall mechanism is designed to handle. The act of storing information when a last accepting state is encountered constitutes remembering which path was taken. For example, the transitions from states 3 and 5 to state 8 and the transitions from states 2 and 4 to state 7 meet that criteria. If a modified version of the state machine 1450 were such that the transitions from states 2 and 3 to state 8 did not exist, then the stall condition for that state could be avoided because states 4 and 5 accept the same regular expression, <2>, and the last accepting state flag 1205 (FIG. 12) differentiates between a series of transitions that reach state 8 via state 6, which is not an non-terminal accepting state, and those that reach state 8 via states 4 or 5, which are non-terminal accepting states. In another embodiment, instructions may be formatted differently, or may be larger in size, such that stall conditions may also be removed for states in which two or more in-transitions are from non-terminal accepting states that accept different regular expressions. For example, a longer instruction format may be configured to include information regarding multiple in-transitions from non-terminal accepting states that accept different regular expressions such that stall conditions may be entirely removed from a state machine.

FIG. 15a is a flowchart 1500 illustrating an exemplary algorithm for removing stall conditions from a state machine. The algorithm is capable of modifying every state in which a stall condition could occur and eliminating the stall condition in every instance where it is safe to do so. Safe is defined as having the same output behavior as an unmodified state machine. It is safe to remove a stall condition when the results produced by state machines with and without the stall condition would be identical for any possible input stream. In an advantageous embodiment, a state machine with one or more stall conditions removed produces the same results as would be produced by the state machine with the stall states, but in fewer cycles of execution. In one embodiment, the algorithm also detects every instance in which it is not safe to remove a stall condition and leaves such states unmodified. As described above, however, in one embodiment, all stall conditions may be removed. In one embodiment, the process illustrated in flowchart 1500 is executed by the Compiler 220 (FIG. 2) after Regular Expressions 210 have been converted into an intermediate data structure representing the corresponding state machine, but before the state transition table memory image, containing the instructions representing the state machine, is generated.

Conceptually, the algorithm starts at each initial state in a given state machine and starts searching downstream states in a depth first sequence, looking for non-terminal accepting states. Each time it finds one, it attempts to propagate that state's information needed to construct a terminal format instruction associated with accepting its corresponding regular expression. This is referred to as its accepting information. Every non-accepting, non-terminal downstream state is updated with that information if it has not previously been changed. Every time a non-terminal accepting state is encountered in this process, the accepting information being propagated is changed to match that of the newer accepting information. Propagation stops when any terminal state is reached. If the terminal is an accepting state, there is no update, otherwise there is. The process of searching for accepting states is referred to as Phase 1 of the stall removal algorithm. The process of propagating updates is Phase 2. While propagating an update, if a state is encountered that has already been updated and the current update information doesn't match the previous change, a conflict is detected and the algorithm enters Phase 3. Phase 3 seeks to restore all downstream states that were changed back to their original values. The algorithm uses three types of markers in the form of boolean flags, one per phase, to keep track of its progress and make decisions about how to proceed. Each state has associated with it a VISITED flag for Phase 1, a CHANGED flag for Phase 2, and a RESTORED flag for Phase 3. These flags are stored in the intermediate data structure that represents the state machine. All flags are initialized to FALSE when the algorithm begins. As each state is examined, depending on which phase is active, the flag associated with that phase will be updated to reflect the state's disposition after processing.

Many embodiments are possible for the intermediate data structure needed to represent a state machine. The data structure for each state needs variables to store the accepting information that can be used to create terminal format instructions to be used when the state is either an accepting state or converted into one by the propagation of such information from a non-terminal accepting state. In one embodiment, the propagation information may include a token value to output, such as would be contained in an Output Information field 645 (FIG. 6a) of a Terminal Format instruction 625 or more specifically, a Token field 785 (FIG. 7b) of a Terminal—Output Format instruction 775. In another embodiment, the propagation information may include a start condition, such as would be contained in a Start Condition field 640 (FIG. 6a) of a Terminal Format instruction 625 or more specifically, a Start Condition field 780 (FIG. 7b) of a Terminal—Output Format instruction 775 or a Terminal—No Output Format instruction 795. In another embodiment, propagation information may include output action flags, such as would be needed to appropriately set values in a Flags field 635 (FIG. 6a) of a Terminal Format instruction 625 or more specifically, a Backup Action (BUA) field 790 (FIG. 7b), an Output Flag bit 32, a Use Start Condition (USC) bit 30, a Job Terminate bit 29, and/or a Stall (ST) bit 0 of a Terminal—Output Format instruction 775 or a Terminal—No Output Format instruction 795. In another embodiment, the output information may include any combination of the previously described fields and flag bits in addition to other fields and flag bits someone practiced in the art would define. In addition to the above information, a representation of the next state transition information is needed. In one embodiment, an array of out-transitions contains a list of the next states, and associated with each next state, a list of symbols or symbol classes that cause a transition to that state. In another embodiment, an array indexed by symbol or symbol class (if classes are used) contains a pointer to the next state to which the corresponding symbol or symbol class causes a transition. Many possible embodiments would be obvious to and could be implemented by someone practiced in the art.

To illustrate how the algorithm works, without loss of generality, an intermediate data structure is defined below. This data structure is shared with other algorithms used by the compiler to convert regular expressions into a state machine representation. Thus, the variables listed do not necessarily representation everything in the data structure, only the subset relevant to the stall removal algorithm. Also, some of the variables listed may reflect the needs of those other algorithms and so are inherited by the stall removal algorithm. Others exist solely for use by the stall removal algorithm. In one embodiment, each of the items that follows is instantiated for each state:
(1) a Type variable that includes information indicating whether the state is terminal or non-terminal;
(2) a NextStateArray associating each possible symbol (or symbol class if classes are used), with a reference to the state to which it leads or an indication that it does not cause an out-transition;
(3) an OutAction variable containing information indicating what if any output actions are to be taken, indicated by flags to be set in an instruction, if this state is reached. For the purposes of stall removal, this variable is only relevant for terminal states;
(4) an AccOutAction variable containing information indicating what if any output actions are to be taken if this state is a non-terminal accepting state and it is to be treated as a terminal state;
(5) a StartCond variable storing a start condition if any;
(6) a Token value identifying an accepted regular expression if any;
(7) a savOutAction variable for remembering the value stored in OutAction or AccOutAction;
(8) a savStartCond variable for remembering the value stored in StartCond;
(9) a savToken variable for remembering the value stored in Token;
(10) a boolean “ACCEPTING” flag indicating if this is an accepting state or not;
(11) a boolean “VISITED” flag indicating if the state has been examined by the algorithm, initially FALSE;
(12) a boolean “CHANGED” flag indicating if the state was changed, initially FALSE; and
(13) a boolean “RESTORED” flag indicating if the state was changed and then restored, initially FALSE.

Items (1) through (6) and (10) are inherited by the stall removal algorithm of flow chart 1500. In one embodiment, prior to executing the algorithm, the Compiler 220 (FIG. 2) fills in the values of Type, NextStateArray, OutAction, AccOutAction, StartCond, Token, and ACCEPTING flag for each relevant instance of them in the data structure. Items (7) through (9) and (11) through (13) are for the exclusive use of the stall removal algorithm and should be initialized before the algorithm begins execution.

Many embodiments are possible for referencing a data structure associated with each state. In one embodiment, the state machine is represented as an array of data structures in which an index that references one of the data structures corresponds to the state number and the NextStateArray uses the array indices to reference the next states. In another embodiment, the state machine is represented as a linked list of data structures containing at least the thirteen elements described and the NextStateArray contains links to each next state. There are many different ways in which someone practiced in the art could choose to implement the data structure illustrated in flow chart 1500.

The algorithm of flow chart 1500 is recursive, such that it can call itself. Therefore, in an advantageous embodiment, the flow chart 1500 is implemented using a programming language that supports recursion, such as the C programming language. In one embodiment, the algorithm is implemented as a subroutine called RemoveStall. The usual style used by those practiced in the art for writing recursive routines is to first test for all conditions that halt the recursion by returning from the routine. These tests are then followed by one or more calls to the recursive routine with the input parameters set appropriately. This is the reverse of non-recursive routines in which the main work of the routine comes first, followed by possible tests for termination or simply a return. Thus in the description that follows, the discussion proceeds in the traditional backward-seeming manner. In the embodiment of FIG. 15, the entry point 1505 includes six parameters: (1) presentState, a reference to the state which is to be examined; (2) propOutAction, an output action that is part of the accepting information of a non-terminal accepting state that the algorithm is attempting to propagate to non-terminal states subject to stalling; (3) propToken, a token value that is part of the accepting information of a non-terminal accepting state that the algorithm is attempting to propagate to non-terminal states subject to stalling; (4) propStartCond, a start condition that is part of the accepting information of a non-terminal accepting state that the algorithm is attempting to propagate to non-terminal states subject to stalling; (5) Valid, a boolean flag indicating that propOutAction, propToken, and propStartCond have valid values if it is TRUE or their values are to be ignored if it is FALSE; and (6) Restoring, a boolean flag indicating that output action, start condition, and token values that were changed may need to be restored to their original values due to a detected conflict. The phase the algorithm is in is indicated by the combination of Valid and Restoring flags. For example, if both are FALSE, Phase 1 is in effect, if Valid is TRUE and Restoring is FALSE, Phase 2 is in effect, and if Valid is FALSE and Restoring is TRUE, Phase 3 is in effect.

For each start state in the state machine, RemoveStall is called with the parameters as follows: RemoveStall(StartState[i], 0, 0, 0, FALSE, FALSE). StartState[i] is a reference to the i^{th} start state, all propagation parameters are zero, the Valid flag is FALSE indicating that there is nothing yet to propagate, and the Restoring flag is FALSE since there is no need to restore anything.

Upon entering the algorithm, the data structure corresponding to presentState is examined by decision tree 1510. Depending on whether the state is a terminal or non-terminal type, whether it has been previously visited or not, and whether it was changed if a previously visited terminal, one of four processes is selected. An unchanged terminal state is handled by process 1515, a visited and changed terminal state is handled by process 1520, an unvisited non-terminal state is handled by process 1525, and a visited non-terminal state is handled by process 1530. Process 1525 has two entry points, A and B (FIG. 15d), so FIG. 15a indicates that entry A is to be used after setting the VISITED flag in block 1514. An unvisited terminal state has its VISITED flag set to TRUE in block 1512 before execution passes to process 1515. Block 1512 is bypassed if the terminal state has been visited but unchanged.

FIG. 15b is a flow chart 1515 illustrating an exemplary method for processing unchanged terminal states, including unvisited or visited but unchanged states. First, a termination decision sequence 1535 examines the data structure associated with presentState. If the boolean ACCEPTING flag is TRUE, this state should not be modified, so a Return is executed to terminate processing of the current call to RemoveStall and return control to the calling program, which may be another instance of RemoveStall. If this is not an accepting state, so ACCEPTING is FALSE, if the Valid parameter, which was passed in to this instance of RemoveStall, is FALSE, the algorithm is in Phase 1, so a Return is executed; nothing is being propagated.

If termination decision sequence 1535 determines that Valid is TRUE, the algorithm is in Phase 2. The three propagation parameters constitute accepting information, previously picked up from a non-terminal accepting state (see FIG. 15d), that needs to be used to change presentState's corresponding variables. At this point in executing the algorithm, it is safe (recall “safe” means no change in output behavior) to perform the update because this is a non-accepting terminal and either hasn't been previously visited or if it was visited, there was no attempt to change it, so the path leading to it from all prior visits did not contain any non-terminal accepting states; Accordingly, update block 1540 executes the following series of variable updates: First, OutAction, Token, and StartCond are copied to savOutAction, savToken, and savStartCond, respectively, in case those values need to be restored later. Then propOutAction, propToken, and propStartCond are copied into OutAction, Token, and StartCond, respectively. The boolean ACCEPTING flag is set to TRUE and the CHANGED flag is also set to TRUE.

FIG. 15c is a flow chart 1520 illustrating an exemplary method for processing terminal states that have been visited and changed. First, a termination decision sequence 1545 is executed, wherein the data structure associated with presentState is examined. If the RESTORED flag is TRUE, the disposition of this state has been previously determined so a Return is executed. This terminates processing of the current call to RemoveStall and returns control to the calling program, which may be another instance of RemoveStall. Otherwise, if RESTORED is FALSE, and if the Valid parameter, which was passed in to this instance of RemoveStall, is FALSE, a Return is also executed since nothing is being propagated; the algorithm is in Phase 1. The algorithm allows the previous change to remain intact because there is no conflict between arriving at this terminal state via a path through the state machine containing no non-terminal accepting states and a path that previously passed through a non-terminal accepting state and propagated its output information to this state (see FIG. 15d). Given that CHANGED is TRUE, if RESTORED is FALSE and the Valid parameter is TRUE, there is a second attempt in progress to propagate change values to this state. In that case, the final decision step is reached and the Restoring parameter passed into this instance of RemoveStall is tested. If Restoring is FALSE, the three propagation parameters, propOutAction, propToken, and propStartCond are compared to OutAction, Token, and StartCond, respectively. If all three match, then there is no conflict between the new propagation values and the previously changed values, so the previous change remains intact and Return is executed. The algorithm remains in Phase 2. If any of the three values do not match, so there is an update conflict, or if the Restoring parameter is TRUE so Phase 3 is in effect, then restoration block 1550 is executed. The boolean RESTORED flag is set to TRUE and the ACCEPTING flag is set to FALSE, which was its original state. The variables savOutAction, savToken, and savStartCond are copied to OutAction, Token, and StartCond, respectively, to restore the latter to their original values. When this state is reached by a state machine engine, it will be subject to stalling.

FIG. 15d is a flow chart 1525 illustrating an exemplary method for processing unvisited non-terminal states. Normal entry is through the point marked “A” with a circle around it. First, decision sequence 1555 is executed. The data structure associated with the incoming presentState parameter is examined. If the boolean ACCEPTING flag is TRUE, presentState is a non-terminal accepting state. Thus, an attempt needs to be made to propagate its output information to all downstream states. This is handled by propagation block 1565. For each next state listed in the NextStateArray, a call to RemoveStall is made. The presentState parameter is set to the value of the next state, ns, currently being processed; propOutAction is set to the value of AccOutAction; propToken is set to the value of Token; propStartCond is set to the value of StartCond; Valid is set to TRUE; and Restoring is set to FALSE. When there are no more next states to process, Return is executed. Execution of this propagation block causes Phase 2 to either go into effect or remain in effect.

If presentState is not an accepting state, so ACCEPTING is determined to be FALSE by the decision block 1555, and if the Valid parameter, which was passed in to this instance of RemoveStall, is FALSE, Phase 1 is in effect. This means that the recursion needs to continue to look for states with information to be propagated, because none of the next states in the NextStateArray have been approached from any transitions issuing from this state (presentState). Propagation block 1570 handles this by calling RemoveStall for each instance of a next state, ns, in the NextStateArray. The presentState parameter is set to the value of the next state, ns, currently being processed and all remaining parameters retain the value with which they entered this instance of RemoveStall, i.e., they are simply forwarded.

If presentState is an accepting state and the Valid parameter is TRUE, Phase 2 is in effect. The three propagation parameters constitute accepting information, previously picked up from a non-terminal accepting state, that needs to be used to change presentState's corresponding variables. Update block 1560 executes the following series of variable updates. First, AccOutAction, Token, and StartCond are copied to savOutAction, savToken, and savStartCond, respectively, in case those values need to be restored later. Then the parameters propOutAction, propToken, and propStartCond are copied into AccOutAction, Token, and StartCond, respectively. The ACCEPTING flag is set to TRUE and the CHANGED flag is also set to TRUE. Once this state has been updated, an attempt should be made to update all downstream states, which is accomplished by propagation block 1570 as has already been described.

FIG. 15e is a flow chart 1530 illustrating an exemplary method for processing visited non-terminal states. First, termination decision tree 1545 is executed. If the Valid parameter, which was passed in to this instance of RemoveStall, is FALSE, Phase 1 is in effect. Since this state was previously visited, no further downstream searching is needed, so Return is executed. If the Valid parameter is TRUE (Phase 2 is in effect), then the CHANGED flag is tested. If CHANGED is FALSE, the ACCEPTING flag is checked. If this is a non-terminal accepting state, the propagation of a change is stopped by executing a Return. Any accepting information propagation needed from this state has already occurred because this state has been previously visited. If this is not an accepting non-terminal state, even though it was previously visited, it was not changed, therefore it is presently safe for it to be changed. Thus, control is transferred to entry point “B” of flow chart 1525 (FIG. 15d). There update block 1560 is executed to accomplish the change. Furthermore, the change needs to be propagated, so propagation block 1570 is also executed. Operation of both blocks was previously explained.

Continuing with the operation of decision tree 1545, if Valid is TRUE and CHANGED is TRUE, then RESTORED needs to be tested. If it is TRUE, no further changes should be made to this state, so Return is executed. Otherwise if RESTORED is FALSE, the algorithm has to evaluate whether to honor a second attempt to propagate change values to this state. If the incoming Restoring parameter is FALSE, Phase 2 is in effect. If each of AccOutAction, Token, and StartCond matches to propOutAction, propToken, and propStartCond, respectively, the previous change is left intact and Return is executed. Otherwise, restoration block 1585 is executed followed by restoration propagation block 1590. Phase 3 goes into effect.

Restoration block 1585 is nearly identical to restoration block 1550 (FIG. 15c). The only difference is that AccOutAction is restored instead of OutAction. The boolean RESTORED flag is set to TRUE and the ACCEPTING flag is set to FALSE, which was its original state. The variables savOutAction, savToken, and savStartCond are copied to AccOutAction, Token, and StartCond, respectively, to restore them to their original values. Restoration propagation block 1590 calls RemoveStall for each instance of a next state, ns, in the NextStateArray. The presentState parameter is set to the value of the next state, ns, currently being processed, the Restoring parameter is set to TRUE, and all remaining parameters retain the value with which they entered this instance of RemoveStall. When restoration has been attempted on all next states, Return is executed.

With reference to FIG. 14a, an intermediate data structure representing state machine 1400 would contain sixteen entries, one for each state shown, for example. RemoveStall algorithm 1500 visits the states in the following order: 0, 1, 2, 13, 14, 15, 3, 4, 5, 6, 7, 8, 9, 11, 12, 10. This sequence is the result of following out-transitions in alphabetical order. The recursion proceeds in depth-first search order. At state 0, decision tree 1510 (FIG. 15a) identifies the state as an unvisited non-terminal state, sets its VISITED flag to TRUE in block 1514, and executes process block 1525, entering at point “A”. Since it is not a non-terminal accepting state, and the Valid parameter is FALSE on the first call to RemoveStall, decision sequence 1555 (FIG. 15d) causes only propagation block 1570 to be executed. This is a typical sequence when Phase 1 is in effect. As long as the incoming Valid flag is FALSE, propagation block 1570 effectively performs the search for non-terminal accepting states. For state 0, the only symbol in the NextStateArray with an associated next state is ‘T’ so propagation block 1570 calls RemoveStall with associated state 1 as the presentState parameter. The remaining parameters are passed through as they were received; in particular, Valid remains FALSE. State 1 presents the same situation to the algorithm as state 0, so the new instance of RemoveStall arrives at propagation block 1570 again. This time, the only next state to pursue is state 2 associated with the symbol ‘H’. A new instance of RemoveStall is called with presentState set to state 2. Again, the algorithm arrives at propagation block 1570. This time, however, there are two out-transitions to investigate that leave state 2, ‘A’ causes transition to state 13 and ‘E’ causes transition to state 3. Taking the transitions in alphabetical order, states 13, 14, and 15, are subsequently visited. No changes result because Phase 1 remains in effect. Upon reaching state 15, decision tree 1510 (FIG. 15a) identifies it as an unvisited terminal state, sets its VISITED flag to TRUE in block 1512, and executes process block 1515. Decision sequence 1535 (FIG. 15b) skips update block 1540 because this is an accepting terminal state and a Return is executed. Execution control comes back to propagation block 1570 (FIG. 15d) for the instance of RemoveStall in which state 14 is the presentState. There are no other out-transitions to explore, so that block completes and executes a Return. Similarly, execution control comes back to propagation block 1570 (FIG. 15d) for the instance of RemoveStall in which state 13 is the presentState and it too executes a Return. In the instance of RemoveStall in which state 2 is the presentState, there remains the out-transition associated with the symbol ‘E’ to explore. So a new instance of RemoveStall is called with state 3 as the presentState.

FIG. 14a illustrates the results of the algorithm using three status indicators. A “V” in a square box in the figure, which will be referenced in the text in square brackets, [V], means the state was visited. Similarly, a [C] means the state was changed and an [R] means the state was restored. Thus, in this example, so far states 0, 1, 2, 13, 14, and 15, are marked only with a [V]. State 3 is the first non-terminal accepting state to be encountered, so decision sequence 1555 (FIG. 15d), selected by decision tree 1510 (FIG. 15a), causes change propagation block 1565 to be executed. Each call to RemoveStall within this block has the Valid parameter set to TRUE and Restoring parameter set to FALSE, so this is the block that initiates Phase 2. ‘R’ comes before ‘Y’, so next state 4 is processed first. This causes a new instance of RemoveStall to be called with presentState set to state 4, propOutAction, propToken, and propStartCond to be set to the values of AccOutAction, Token, and StartCond, associated with state 3 respectively, Valid to be set to TRUE, and Restoring set to FALSE. State 4 is a non-accepting non-terminal state that hasn't been visited yet, so decision tree 1510 (FIG. 15a) causes its VISITED flag to be set to TRUE in block 1514 and process 1525 to be executed at entry point “A”. In this case, decision sequence 1555 (FIG. 15d) causes update block 1560 to be executed followed by propagation block 1570 since the incoming Valid parameter is TRUE. In Phase 2, propagation block 1570 is used to attempt to update all downstream states. The status of state 4 in the figure shows that it was visited and changed ([V][C]). There is only one possible next state, so another instance of RemoveStall is called with presentState set to state 5 and all other parameters unchanged. Since state 5 is a non-terminal accepting state, the attempt at propagating update values is disregarded by decision sequence 1555 (FIG. 15d) which instead selects propagation block 1565 to be executed. This has the effect of changing the values being propagated from those of state 3 to those of state 5. Phase 2 remains in effect, but the accepting information is updated to that of the last accepting state. The status of state 5 only shows that it was visited since no changes were made. Once the algorithm completes, states 4, 6, 7, 8, and 11, will have been updated with the output information corresponding to the regular expression numbers shown in dotted line triangles in FIG. 14a. Because of the tree structure of state machine 1400, there are no updating conflicts, so none of the portions of RemoveStall algorithm 1500 that detect conflict and handle restoration are used (e.g., FIGS. 15c and 15e).

State machine 1450 shown in FIG. 14b is more complex. To properly illustrate the algorithm in this case, an embodiment of the NextStateArray is assumed in which it is implemented as a simple array with one entry per symbol class and the entry is a reference to the next state with which the symbol class is associated. An entry of 0 is reserved to mean there is no out-transition associated with that symbol class. To investigate each next state, the algorithm processes each non-zero entry in the array in sequential order. Because more than one symbol class may cause transition to the same state, the RemoveStall algorithm may visit many of the states several times. The overhead to do that is minimized by the construction of the algorithm which attempts to discover as early as possible that no further processing is needed at each state.

FIG. 16a is the state machine 1450 (FIG. 14a) with the symbol class numbers on each transition relabeled. The symbol class definitions given earlier are shown in the figure for reference. In this example, every non-terminal state has five out-transitions which the algorithm follows in numerical order. Phase 1 is in effect and the algorithm begins searching for non-terminal accepting states. Beginning with state 0, decision tree 1510 (FIG. 15a), causes its VISITED flag to be set to TRUE in block 1514 and process block 1525 to be executed. Decision sequence 1555 (FIG. 15d) selects propagation block 1570 (this is not an accepting state and Valid is FALSE), which calls RemoveStall again, but with state 6 as the presentState value, since it is associated with the transition for symbol class 1 in the NextStateArray associated with state 0. This process is repeated again to arrive at state 7. In this new context associated with presentState set to state 7, symbol classes 1 and 2 are associated with transitions back to state 7. In both cases, where a new instance of RemoveStall is called by propagation block 1570 (FIG. 15d), with presentState remaining set to state 7, decision tree 1510 (FIG. 15a) selects process block 1530 for execution since the VISITED flag now is TRUE. Decision sequence 1545 (FIG. 15e) first tests the value of the incoming Valid parameter. It is FALSE since nothing is being propagated, and this state has already been visited so a Return is executed. Control passes back to propagation block 1570 (FIG. 15d) where the first instance of presentState set to state 7 continues execution. Next, the transition associated with symbol class 3 in the NextStateArray of state 7 is examined and RemoveStall is called with presentState set to state 8. From state 8, the first four out-transitions are to terminal state 1. The first time state 1 is visited, decision tree 1510 (FIG. 15a) causes the VISITED flag associated with state 1 to be set to TRUE in block 1512 and process block 1515 to be executed. State 1 is an accepting state for all failure transitions, so process block 1515 (FIG. 15b) Returns immediately. On all subsequent visits to state 1, decision tree 1510 (FIG. 15a) also selects process block 1515 because even though its VISITED flag is now TRUE, its CHANGED flag remains FALSE. Therefore, decision sequence 1535 executes a Return immediately after finding the ACCEPTING flag is TRUE. This process continues and no new parts of the algorithm are exercised until state 2 is reached. The complete sequence of states visited up to this point is 0, 6, 7, 7, 7, 8, 1, 1, 1, 1, 9, 7, 7, 7, 8, 7, 7, 2 and the status of all states so far is shown in FIG. 16a. Each of those states in the sequence is marked only with a [V].

State 2 is the first non-terminal accepting state to be visited. Decision tree 1510 (FIG. 15a) causes the VISITED flag associated with state 2 to be set to TRUE in block 1514 and process block 1525 to be executed. The ACCEPTING flag for state 2 is TRUE, so decision sequence 1555 (FIG. 15d) selects update propagation block 1565 to execute. Phase 2 goes into effect. The first out-transition is to state 7 so RemoveStall is called with the parameters set to attempt to propagate the terminal output information associated with state 2 to state 7 and the other next states in the NextStateArray. As on previous visits to state 7, decision tree 1510 (FIG. 15a) selects process block 1530 to execute. On this visit, the incoming Valid parameter is TRUE so decision tree 1545 (FIG. 15e) tests the CHANGED flag and finds it is FALSE. That leads to testing the ACCEPTING flag which is FALSE. Since state 7 is not an accepting state and has not previously been changed, it is safe to honor the update request indicated by the TRUE Valid parameter. So execution proceeds to entry point “B” of process 1525 (FIG. 15d) where update block 1560 saves the old output values, changes them to match the incoming propagation parameters, and updates the ACCEPTING and CHANGED flags. Then propagation block 1570 is executed. Now that a change is being propagated, all previously visited states downstream of state 7 should be revisited. None of those states were changed so an attempt is made to update them with the propagation values. When the third transition from state 7 to state 8 is processed, decision tree 1510 (FIG. 15a) selects process block 1530 to execute. This situation is identical to that of state 7, so the CHANGED flag associated with state 8 is also set to TRUE. On each of the four calls to RemoveStall from propagation block 1570 (FIG. 15d) corresponding to the four out-transitions to state 1, decision tree 1510 (FIG. 15a) selects process block 1515 to execute. That is because state 1 is a terminal accepting state, so decision sequence 1535 rejects the attempt to update the output variables and executes Return. The same result occurs for the same reason when state 9 is reached.

The sequence of states visited as a result of the first transition out of state 2, due to the invocation of Phase 2, is 7, 7, 7, 8, 1, 1, 1, 1, 9, 7, 7 before control returns to state 2 and the second transition is taken to state 3. This subsequence is a repeat of the third through thirteenth states of the original search sequence.

State 3 is the second non-terminal accepting state to be visited. Decision tree 1510 (FIG. 15a) causes the VISITED flag associated with state 3 to be set to TRUE and process block 1525 to be executed. The ACCEPTING flag for state 3 is TRUE, so decision sequence 1555 (FIG. 15d) selects update propagation block 1565 to execute. In this case as well, the first out-transition is to state 7. RemoveStall is called with the parameters set to attempt to propagate the terminal output information associated with state 3 to state 7 and the other next states in the NextStateArray. Again, as on previous visits to state 7, decision tree 1510 (FIG. 15a) selects process block 1530 to execute. The incoming Valid parameter is TRUE so decision tree 1545 (FIG. 15e) tests the CHANGED flag and finds it is now TRUE. That leads to testing the RESTORED flag which is FALSE. Decision tree 1545 then checks that the incoming Restoring parameter is FALSE and compares the three propagation parameters with the current corresponding output variables. Since they were previously updated to match the information from state 2, states 2 and 3 accept the same regular expression, <1>, and state 3's output variables are being propagated, a match is found. This state is consistent with the desired update, so Return is executed. Since this is the same change as was previously propagated, there is no need to revisit any of the states downstream of state 7. The status as of this point in the execution of the algorithm is shown in FIG. 16b. States 7 and 8 now indicate they have been changed and state 3 has been visited. Subsequently, the algorithm visits states 3, 8, 7, 7, 8, 7, 7, 1, and 4 before any new situations arise. The visit to states 1 and 4 results from execution control having returned to the context of state 0, so Phase 1 is back in effect.

State 4 is another non-terminal accepting state but it accepts a different regular expression, <2>, than the previous two non-terminal accepting states (states 2 and 3). Decision tree 1510 (FIG. 15a) causes the VISITED flag associated with state 4 to be set to TRUE with block 1514 and process block 1525 to be executed. The ACCEPTING flag for state 4 is TRUE, so decision sequence 1555 (FIG. 15d) selects update propagation block 1565 to execute. The first out-transition is to state 7 so RemoveStall is called with the parameters set to attempt to propagate the terminal output information associated with state 4 to state 7 and the other next states in the NextStateArray. For state 7, decision tree 1510 (FIG. 15a) selects process block 1530 to execute. The incoming Valid parameter is TRUE so decision tree 1545 tests the CHANGED flag and finds it is TRUE. That leads to testing the RESTORED flag which is FALSE. Decision tree 1545 then checks that the incoming Restoring parameter is FALSE and compares the three propagation parameters with the current corresponding output variables. Since they were previously updated to match the information from state 2, they will not match the propagation information from state 4 because state 4 accepts regular expression <2>. Thus, restoration block 1585 is executed. This copies the values from savOutAction, savToken, and savStartCond back to AccOutAction, Token, and StartCond, respectively, sets RESTORED to TRUE, and sets ACCEPTING back to FALSE. Next, Phase 3 goes into effect with the execution of restoration propagation block 1590. Every previously visited state downstream of state 7 should be revisited and restored if it had been changed previously. The first transition from state 7 is back to itself. Being a visited non-terminal state, process 1530 is selected by decision tree 1510 (FIG. 15a). Decision tree 1545 (FIG. 15e) finds that this state has previously been RESTORED, having found Valid to be TRUE and CHANGED to be TRUE, and executes a Return. It does this again for the second transition.

When the third transition from state 7 to state 8 is processed, decision tree 1510 (FIG. 15a) selects process block 1530 to execute. This situation is identical to that of the first restoration visit to state 7, so the RESTORED flag associated with state 8 is also set to TRUE along with restoring its three output values from the previously saved versions. On each of the four calls to RemoveStall from propagation block 1570 (FIG. 15d) corresponding to the four out-transitions to state 1, decision tree 1510 (FIG. 15a) selects process block 1515 to execute. That is because state 1 is a terminal accepting state, so decision sequence 1535 rejects the attempt to restore the output variables and executes Return. The same result occurs for the same reason when state 9 is reached.

The sequence of states visited as a result of the first transition out of state 4, due to the invocation of Phase 3, is 7, 7, 7, 8, 1, 1, 1, 1, 9, 7, 7 before control returns to state 4. The second transition is also to state 7, then the third transition is taken to state 8. This subsequence is a repeat of the change subsequence. Subsequently, states are visited in the sequence 5, 7, 7, 8, 5, 5, 5, and 4. No new situations are encountered in completing the algorithm. Upon completion, the status shown in FIG. 16c results. States 7 and 8 now indicate they have been visited, changed, and restored and states 4 and 5 have been visited.

The phases in effect and the complete sequence in which the algorithm visits the states (exclusive of returns) of FIG. 16c is: V{0, 6, 7, 7, 7, 8, 1, 1, 1, 1, 9, 7, 7, 7, 8, 7, 7}, 2, C{7, 7, 7, 8, 1, 1, 1, 1, 9, 7, 7, 3, 7, 3, 8, 7, 7, 8, 7, 7}, V{1}, 4, 7, R{7, 7, 8, 1, 1, 1, 1, 9, 7, 7}, C{7, 8, 5, 7, 7, 8, 5, 5, 5), V{4}. The first subsequence, enclosed in braces and preceded by a “V” represents states visited with Phase 1 in effect. State 2 is next in the sequence, but is not enclosed in braces because processing it results in transition from Phase 1 to Phase 2. The next subsequence, enclosed in braces and preceded by a “C” is the result of propagating accepting state output information, first from state 2 and then state 3. At the end of that subsequence, execution control is returned to the context of state 0 which follows its third transition to state 1 with Phase 1 in effect. Processing state 4 results in transition from Phase 1 to Phase 2 and processing state 7 marks the transition from Phase 2 to Phase 3. The subsequence enclosed in braces and preceded by an “R” is the result of having to restore state information after the changes in Phase 2 were made, due to conflict between states 2 and 4. At the end of that subsequence, execution control returns to the context of state 4, so the next subsequence reverts to Phase 2. Finally, execution control returns again to the context of state 0, which visits state 4 for its last transition with Phase 1 in effect. The minimum possible number of state visits in this example is the number of non-terminal states times the number of classes (because every non-terminal state in this example associates a state transition with every class value) plus one for state 0, which comes to 41. However, Phase 2 processing requires ten extra visits as does Phase 3. Thus the total number of state visitations is 61.

The two examples just presented represent two ends of a spectrum in the relative complexity of state machines. At one end of the spectrum are sets of regular expressions that are all literal expressions. In such cases, the corresponding state machine has a tree structure, as was illustrated by FIG. 14a so, all stall conditions can be removed and no states are visited more than once by the stall removal algorithm 1500. At the other end of the spectrum, all regular expressions in a set use large, overlapping symbol classes with repetition operators (e.g., ‘*’ and ‘+’). The set's corresponding state machine is a complex graph structure with many cycles. That structure causes the stall removal algorithm 1500 to visit many of the states multiple times and removal of every stall condition is not guaranteed. Many applications contain a mixture and the complexity of their corresponding state machines is proportional to the percentage of literal expressions. Regardless of complexity, the stall removal algorithm 1500 presented removes every stall for which correct execution of the state machine is assured.

Given the assumed data structure used to represent a NextStateArray in the second example, many states were visited many times, phase changes notwithstanding. Constructing the recursive algorithm to give priority to stopping the recursion compensates to a degree for that inefficiency. In another embodiment, a NextStateArray is implemented with a more complex data structure whose entries consist of an array of pointers to the set of next states. Associated with each next state is a list of symbols or symbol classes that cause a transition to that state. Using such a representation for the NextStateArray eliminates the extra visits made by stall removal algorithm 1500. Using this representation, the sequence of states visited by stall removal algorithm 1500, when processing state machine 1450 (FIGS. 14b, 16a, 16b, 16c), becomes: V{0, 6, 7, 7, 8, 1, 9, 8}, 2, C{7, 7, 8, 1, 9, 3, 7, 3, 8, 8}, V{1}, 4, 7, R{7, 8, 1, 9}, C {8, 5, 7, 8, 5}. There remain multiple visits to many of the states, but these are due to phase changes and to the fact that several states have transitions to the same next state. What is eliminated are multiple visits due to multiple transitions between the same two states. Using this representation for NextStateArray, results in a total of 31 visits to the states of state machine 1450 (FIG. 14b). The minimum possible is 23, which is the number of out-transitions plus 1 for state 0. Four extra visits are made due to Phase 2 and four extra visits are made due to Phase 3. This is a net reduction of 30 visits compared to using the previous data structure for NextStateArray.

This change in data structure for NextStateArray has no effect on the number of state visits required to process state machine 1400 (FIG. 14a). The impact of the change in a given application depends on the degree to which different symbol classes cause the same out-transition from a present state to a next state. Because this embodiment for NextStateArray may require algorithms in the compiler to be more complex and less efficient, there may be a tradeoff to make in choosing a representation for a NextStateArray that someone practiced in the art would make based on considering all the algorithms affected by the choice of representation made. Stall removal algorithm 1500 accommodates any advantageous embodiment of NextStateArray.

Some regular expression languages, as mentioned earlier, support a feature called subexpressions. A simple subexpression has the form ‘r₁ {r₂}r₃’, where r₁, r₂, and r₃ are arbitrary regular expressions. Here, left brace, ‘{’, denotes the start of a subexpression and right brace, ‘}’, denotes the end. Parentheses could be used for this purpose, however, they are also used in the regular expressions themselves for grouping elements together, so braces are used to avoid confusion. The subexpression, {r₂}, is denoted SE₁.

Using start conditions and trailing context, the subexpression r₁ {r₂}r₃ can be converted into the following form:

| | | |
|---|---|---|
| 1 | <SC₀>r₁/r₂r₃ | { BEGIN(SC₁); } |
| 2 | <SC₁>r₂/r₃ | { OUTPUT(SE₁); BEGIN(SC₂); } |
| 3 | <SC₂>r₃ | { BEGIN(SC₀); } |

SC₀ is the initially active start condition, so only the expression on line 1 is active. Using trailing context, the expression r₁/r₂r₃ establishes that all the elements of the original expression containing a subexpression are present before changing the start condition to SC₁. If there are multiple regular expressions with subexpressions, they will all be associated with start condition SC₀. Thus, using the trailing context assures that when the start state is changed, so the subexpression can be isolated and output, for example, that r₃ will also then be found in the input stream so that the start condition will return to SC₀. The expression on line 2 is conservative, assuring that the lexeme identified and output is the same one that would be identified in the original subexpression as r₂ by including r₃ as trailing context. As an example of why this is necessary, assume r₁ is ‘NUM’, r₂ is ‘[0-9]+’ and r₃ is ‘782’. Given an input string ‘NUM598782’, without the trailing context in line 2, the lexeme identified for r2 would be ‘598782’, but the correct lexeme is ‘598’. When the set of symbols that could be the last symbol of r₂ intersected with the set of symbols that could be the first symbol of r₃ is empty, then it is safe to leave out the trailing context part of line 2 because a state machine engine will correctly identify the end of the lexeme for r₂ when it processes the first symbol that is part of r₃. There will be no ambiguity to resolve. The output function, OUTPUT (SE₁), causes the token associated with the first (and only, in this case) subexpression to be reported. The purpose of line 3 is to consume the remainder of the original expression and return the start condition to SC₀.

There is no limit on the number of subexpressions that can appear in a regular expression and they may be arbitrarily nested. For example, ‘r₁{r₂{{{r₃}r₄}{r₅}}r₆}r₇’ contains five subexpressions. The notation used to refer to the i^{th} subexpression is SEᵢ. In the discussion that follows, SEᵢ is used to identify the token that a state machine returns when the subexpression is found in an input stream. In this embodiment, none of the subexpressions are returned unless the entire expression is matched in the input stream, and all of them are returned if there is a match. Subexpressions are numbered based on the order in which the left braces are encountered. In this example, SE₁ is ‘r₂{{{r₃}r₄}{r₅}}r₆’, SE₂ is ‘{{r₃}r₄}{r₅}’, SE₃ is ‘{r₃}r₄’, SE₄ is ‘r₃’, and SE₅ is ‘r₅’.

To support such arbitrarily complex expressions, stack hardware may be added to a state machine engine for storing lexeme start locations. For M input streams, M stacks may be used to store these start locations. Stacks are useful if more than one subexpression is allowed to begin with the same symbol, as with SE₂, SE₃, and SE₄ in this example, or if subexpressions are allowed to be nested.

At the level of the regular expression notation, additional output actions are defined as follows: (1) PUSH_SL—push the contents of a Start Location register (e.g., 1145 in FIG. 11) onto the top of the stack; (2) PUSH_OUT(Token)—output Token, use the value in the Start Location register as the token's start location, and push the Start Location register's value onto the top of the stack; (3) TOS_OUT(Token)—output Token and use the value on the top of the stack as the token's start location; and (4) POP_OUT(Token)—output Token, use the value on the top of the stack as the token's start location, and pop the stack.

To support these operations, two additional control bits, called the Start Location Stack (SLS) field, may be added to terminal format instructions to specify stack operations and the source of a Start Location value to output. With reference to FIG. 6a, the two needed bits may be a subfield of the Flags 635 field of a Terminal Format 625 instruction. With reference to FIG. 7b, in the case of the Terminal—Output Format 775 instruction, the two bits may be assigned to bit 31 and bit 28. The latter bit could be made available by reducing the Token field 785 by one bit, for example. Alternatively, the Start Condition field 780 could be reduced by one bit. The exemplary Terminal—No Output Format 795 instruction only requires the use of bit 31. This is because only a stack push operation can occur when there is no output, which implements PUSH_SL.

For the Terminal—Output Format 775 instruction, the four possible binary values of SLS may be assigned the following interpretation. A value of SLS=00 indicates that there are no stack operations to perform and that the start location to output may be taken from a Start Location register 1145 (FIGS. 11 and 12) as has been previously described. This corresponds to the OUTPUT(Token) output action. A value of SLS=01 indicates the current value of the Start Location register 1145 may be pushed onto the top of the stack and that same value also output. This corresponds to the PUSH_OUT(Token) output action. A value of SLS=10 indicates the start location value may be taken from the top of the start location stack for output. This corresponds to the TOS_OUT(Token) output action. Lastly, a value of SLS=11 indicates to pop the stack and to take the start location value from the top of the start location stack. This corresponds to the POP_OUT(Token) output action.

Using start conditions, trailing context, and stack operations, this complex example can be converted into the following form:

| 1 | <SC₀>r₁/r₂r₃r₄r₅r₆r₇ | { BEGIN(SC₁); } | | |
|---|---|---|---|---|
| 2 | <SC₁>r₂/r₃r₄r₅r₆r₇ | { PUSH_SL; BEGIN(SC₂); } | | |
| 3 | <SC₂>r₃/r₄r₅r₆r₇ | { PUSH_OUT(SE₄); BEGIN(SC₃); } | | |
| 4 | <SC₃>r₄/r₅r₆r₇ | { TOS_OUT(SE₃); BEGIN(SC₄); } | | |
| 5 | <SC₄>r₅/r₆r₇ | { | OUTPUT(SE₅); | POP_OUT(SE₂); |

| | BEGIN(SC₅); } | |
|---|---|---|
| 6 | <SC₅>r₆/r₇ | { POP_OUT(SE₁); BEGIN(SC₆); } |
| 7 | <SC₆>r₇ | { BEGIN(SC₀); } |

The above shows the worst case situation in which all trailing context is checked in each expression. To minimize the amount of trailing context included in the expressions, for every expression after the first one, each pair of adjacent elements may be tested. A function called Overlap(rᵢ, rⱼ) can be written to find the intersection of the set of symbols that could be the last symbol of rᵢ and the set of symbols that could be the first symbol of rⱼ. To optimize the regular expression on line 2, for example, start with i=2 and evaluate Overlap(rᵢ, rᵢ₊₁). If the result is the empty set, then all terms from rᵢ₊₁ on, can be left out of the expression. If the result is not empty, then increment i and repeat the evaluation. This process may be applied to the regular expression on each subsequent line. A more efficient form for this subexpression is shown below:

| 1 | <SC₀>r₁/r₂r₃r₄r₅r₆r₇ | { BEGIN(SC₁); } | | |
|---|---|---|---|---|
| 2 | <SC₁>r₂ | { PUSH_SL; BEGIN(SC₂); } | | |
| 3 | <SC₂>r₃ | { PUSH_OUT(SE₄); BEGIN (SC₃); } | | |
| 4 | <SC₃>r₄ | { TOS_OUT(SE₃); BEGIN(SC₄); } | | |
| 5 | <SC₄>r₅ | { | OUTPUT(SE₅); | POP_OUT(SE₂); |

| | BEGIN(SC₅); } | |
|---|---|---|
| 6 | <SC₅>r₆ | { POP_OUT(SE₁); BEGIN(SC₆); } |
| 7 | <SC₆>r₇ | { BEGIN(SC₀); } |

To explain how this example works, the following notation is used to show the contents of the start location stack: SLS[:x:y: . . . :], where x is the value on the top of the stack, y is the next value, and so on. An empty stack is shown as SLS[::]. SLᵢ is the i^{th} start location, and is associated with rᵢ. The description that follows applies to both of the above listings of regular expressions. In this example, SC₀ is the initially active start condition, so only the expression on line 1 is active. Using trailing context, the expression r₁/r₂r₃r₄r₅r₆r₇ establishes that all the elements of the original expression containing the five subexpressions are present before changing the start condition to SC₁. Since r₂ is the first element of a regular expression containing nested subexpressions, but not the last element of any of them, the PUSH_SL action is specified on line 2 so that the current value of the start location will be available later when the end of SE₁ is reached, after matching r₆. The start location stack is SLS[:SL₂:]. The other action taken is to activate start condition SC₂. On line 3, since r₃ is the first element of three different subexpressions, SE₂, SE₃, and SE₄, and it is the last element of SE₄, PUSH_OUT(SE₄) is the output action needed. This causes output of token SE₄, with start location SL₃ and the current value of the end location. SL₃ must also be pushed onto the stack for future reference when SE₂ and SE₃ are identified. The start location stack now looks like SLS[:SL₃:SL₂:]. Start condition SC₃ is activated. Now the only active regular expression is on line 4. Since r₄ is the last element of SE₃, which is ‘{r₃}r₄’, but this will not be the last subexpression to need start location SL₃, the TOS_OUT(SE₃) output action is required. This outputs token SE₃ and takes the start location to be the value on the top of the stack which is SL₃. There is no change to the start location stack. Start condition SC₄ is activated. Line 5 has the only active regular expression and the lexeme associated with r₅ will be found. r₅ is the last element of two subexpressions, SE₅ and SE₂. SE₅ consists only of r₅ so the OUTPUT(SE₅) output action is sufficient to report it. The start location is taken from the current value in the Start Location register 1145. SE₂ consists of ‘{{r₃}r₄}{r₅}’, and is the last subexpression that will need the start location associated with r₃, so POP_OUT(SE₂) is the appropriate output action. Token SE₂ is reported as well as start location SL₃ and the stack is popped leaving SLS[:SL₂:]. Start condition SC₅ is activated next. On line 6, r₆ will be identified. It is also the last element of a subexpression, SE₁, and the only one that needs the start location of r₂, so the POP_OUT(SE₁) output action is used again, but with token SE₁. The start location stack is now empty: SLS[::]. Start condition SC₆ is activated to enable the final element, r₇, to be matched. Lastly, SC₀ is activated on line 7. The foregoing example is provided for illustration purposes and is not intended to limit the scope of subexpression use. Those of skill in the art will recognize that subexpressions may be represented in various manners, stack information may be stored in various manners, and more or less register bits may be used in various configurations to store the information described above.

When the same element is allowed to be the last part of two or more subexpressions, which occurred with r₅ in the previous example, the ability to output more than one token when a lexeme is identified is needed. This may require additional hardware in a state machine engine. For example, a means for signaling the need for multiple output and for storing and accessing multiple terminal output type instructions may be added. In one embodiment, a Terminal Chaining format is defined that contains the address of a block of Terminal Output instructions, one per matched subexpression. Each Terminal Output instruction contains a bit that signals that this is the last instruction in the block. When a state machine engine fetches a Terminal Chaining instruction, it stops reading symbols from the input stream, and proceeds to fetch the sequence of instructions at the indicated output block. The last Terminal Output instruction in the block is the same as a normal, single output terminal instruction would be, so execution resumes as normal. If the value of the start state is to be changed, this last instruction in the block will so indicate.

### ALTERNATIVE EMBODIMENTS

In one embodiment, a start condition stack may be added in order, for example, to allow multiple expressions with different start conditions to switch to a common set of regular expressions. Such a stack may be implemented using additional actions, such as exemplary PUSH_SC and POP_SC actions. In general, this capability allows sets of regular expressions to behave in much the same way subroutines in programming languages do. Any subroutine can call any other subroutine, including itself, and they can nest to arbitrary depth. Each time a call is made, a return location is pushed onto a stack. Each time a subroutine completes, the stack is popped and control returns to the location so indicated by the value popped. Similarly, any regular expression in a set can activate any other start condition to enable another set. Each time this is done, the current start condition may be pushed onto the start condition stack. In an advantageous embodiment, the sets of expressions are written in such a way that the stack is empty when processing of an input completes. In one embodiment, there is at least one expression in each set whose activation is accompanied by a push, such that (1) it will eventually match a lexeme in the input, and (2) it has a pop action.

To implement push and pop actions, two additional control bits may be added to the Terminal Format type instructions that would control the start condition stack, indicating Push, Pop, or NOP. PUSH_SC would normally be used in conjunction with BEGIN, to save the value in a current start condition register before switching to a new one. When the bits indicate a Pop, the value on the top of the start condition stack would be loaded into the current start condition register and removed from the stack. Implementation of such a start condition stack allows, for example, multiple expressions with different start conditions to switch to a common set of regular expressions. The stack remembers which start condition was in effect when the common set is entered, so that control can be returned to that start condition by executing a POP_SC.

In one embodiment, a regular expression engine limits the maximum size of a lexeme to a fixed value. In this embodiment, if the maximum size is selected to be the capacity of the backup buffer, this the state machine engine will never need to access a symbol that is not present in the backup buffer. Any match in progress will be declared to be a failure if it has not succeeded after the maximum number of symbols have been evaluated. At that point, the worst case backup is to the first symbol in the backup buffer. Enforcing this limit means that the state machine engine may not always find the longest possible match. However, it will find the longest match that does not exceed the limit. This approach may introduce multiple advantages, including, for example, increased performance and smaller state machines requiring less state transition table memory.

Without the maximum size lexeme option, a state machine engine may attempt to match a lexeme larger than the size of the backup buffer, but then fail to complete the match. It may then be required to backup to a symbol that is not in the backup buffer. In one embodiment, such as a data streaming application, the needed symbol may no longer be available. In an advantageous embodiment, all symbols of an input are stored in a secondary memory and a working subset of them move through the backup buffer. If a needed symbol is not in the backup buffer, then a performance penalty occurs due to the time required to reload the backup buffer with one or more missing symbols.

As another alternative, those skilled in the art of writing regular expressions will appreciate that it is possible to write regular expressions in such a way that they (1) do not fail to match once the first symbol of a match is found, or (2) do not match more than a specified number of symbols. An example of (1) is an expression like ‘[A-Za-z] [A-Za-z0-9]*’, which could easily match more than N symbols. It poses no problem because a last accepting state for this expression is at most one symbol back. After the first symbol satisfies the first symbol class, the expression as a whole cannot fail, it's just greedy. As an example of (2), suppose N is the maximum number of symbols allowed in a lexeme. The expression ‘<[A-Za-z0-9]*>’ could match more than N symbols since there is no limit on the number of alphanumeric characters allowed between the angle brackets. Once a left angle bracket, ‘<’, is encountered, if a right angle bracket, ‘>’, is not encountered before some other non-alphanumeric symbol is, the whole expression will fail. If for example, more than N symbols have been examined and no last accepting state has been encountered, upon failing, the state machine engine will need to access the symbol that follows the left angle bracket, but it won't be in the backup buffer. Such an expression can be converted to the finite form ‘<[A-Za-z0-9]{0,N−2}>’. This expression cannot match more than N symbols. The drawback is that the state machine representing this expression will have N−3 more states in it than the expression this replaces. That is due to the need to actually count instances of symbols that match the class by virtue of changing states upon encountering each one. The star operator only requires a single state to which the machine returns every time the class is satisfied, with one or more out transitions for when it is not.

In one embodiment, a regular expression engine may limit the size of a lexeme to a value in a register whose value is set when a state machine engine is initially configured. This adds some flexibility so that the creator of regular expressions for an application that uses only one set can choose an advantageous value. In this embodiment, the register may be located in the Input/Output Controller 410 of FIG. 4 and its value set using the Control Input 404 when the engine is initially configured. In another embodiment, a regular expression engine could limit the size of a lexeme to a value in a register which is set for each job. In this embodiment, the register may be located in the Input/Output Controller 410 of FIG. 4 with its value set via the Input Data 406 each time a job is started, thus increasing flexibility by allowing the value to be selected according to the type of input to be scanned in a given job.

In one embodiment, a regular expression engine may be configured to optionally backup beyond the size of the backup buffer by using an additional memory through which the input stream passes first. The additional memory may be another portion of the regular expression engine or, alternatively, may be external to the engine. The additional memory may be configured to buffer a larger portion of the input stream so that backups may extend beyond the buffer stored in the backup buffer of the regular expression engine.

In one embodiment, a regular expression engine may be configured to find all patterns regardless of overlap. This may be accomplished, for example, by (1) always backing up to the next symbol and never backing up to a last accepting state location or trail head location, (2) reporting every accepting state encountered, and (3) reporting all expressions associated with an accepting state when there is more than one. In one embodiment, a compiler maintains a list of accepted expressions for each accepting state and includes the state number or a reference to it in the token information so that the associated list can be retrieved when the token is returned.

In one embodiment, a regular expression engine may be configured to add subexpression storage and a mechanism for referring to what is stored to be used as part of the match. For example, the regular expression ‘{[A-Za-z]+}[□\t]+\1’ will find all repeated words in a document, e.g. ‘the the’. ‘\1’ refers to whatever was matched in the subexpression between the braces. In one embodiment, the number of subexpressions stored is bounded by a finite limit that may be either determined by the programmer or the regular expression engine that the compiler would enforce. In an advantageous embodiment, extra hardware compares a referenced subexpression to the current input stream in parallel with the continued operation of the state machine engine. In one embodiment, if the input fails to match the stored subexpression, other regular expressions may be matched. In one embodiment, if the input matches both the regular expression containing the referenced subexpression and one or more other regular expressions, the usual priority rules apply in which the longest match is reported, and in the case of a tie, the earliest listed regular expression is reported.

The foregoing description details certain embodiments of the invention. It will be appreciated, however, that no matter how detailed the foregoing appears in text, the invention can be practiced in many ways. As is also stated above, it should be noted that the use of particular terminology when describing certain features or aspects of the invention should not be taken to imply that the terminology is being re-defined herein to be restricted to including any specific characteristics of the features or aspects of the invention with which that terminology is associated. The scope of the invention should therefore be construed in accordance with the appended claims and any equivalents thereof.

1. A method of recognizing a lexeme in a data file comprising a plurality of symbols, the method comprising:
generating one or more regular expression queries;
generating a deterministic finite automata (DFA) based on the regular expression queries;
executing the DFA on the data file, wherein the executing comprises
identifying a first lexeme in the data file after evaluating one or more symbols of the data file;
storing in a storage device a location in the data file associated with a last symbol of the first lexeme;
evaluating one or more additional symbols of the data file;
determining if the first lexeme is a part of a second lexeme comprising the one or more additional symbols; and
if the first lexeme is not a part of the second lexeme, reporting the identification of the first lexeme and evaluating additional symbols starting with a symbol immediately following the stored location.

2. The method of claim 1, further comprising storing in another storage device a last accepting state.

3. The method of claim 2, wherein the last accepting state comprises information related to contents of an instruction pointer associated with the step of identifying the first lexeme.

4. The method of claim 1, further comprising:
if the first lexeme is a part of the second lexeme, reporting the identification of the first lexeme and the second lexeme.

5. The method of claim 1, further comprising:
if the first lexeme is a part of the second lexeme, reporting the identification of the second lexeme.

6. The method of claim 1, wherein a width of the storage device corresponds to one of the group comprising 8, 16, 32, 64, and 128 bits.

7. A method of recognizing a lexeme in a data file comprising a plurality of symbols, the method comprising:
generating a regular expression query including a lexeme and a trailing context, wherein each of the lexeme and the trailing context includes one or more symbols;
generating a deterministic finite automata (DFA) based on the regular expression query;
executing the DFA on the data file, wherein the executing comprises
identifying the lexeme in the data file after evaluating one or more symbols of the data file;
storing in a storage device a trail head location indicating a position of the symbol immediately following the lexeme;
evaluating one or more additional symbols of the data file;
determining if the additional symbols match the trailing context; and
if the additional symbols match the trailing context, reporting the identification of the lexeme.

8. The method of claim 7, wherein if the additional symbols match the trailing context, evaluating additional symbols starting with the symbol indicated by the trail head location.

9. The method of claim 7, wherein if the additional symbols do not match the trailing context, evaluating additional symbols starting with a location identified by a last accepting state.

10. The method of claim 7, wherein if the additional symbols do not match the trailing context and there is not a stored last accepting state, evaluating additional symbols starting with the second symbol of the lexeme.

11. A compiler configured to generate a deterministic finite automata (DFA) based at least partly upon one or more regular expression queries, the compiler comprising:
means for determining one or more non-terminal states that occur logically after a non-terminal accepting state and before either of (1) a next non-terminal accepting state or (2) a terminal state; and
means for associating a state transition instruction of the non-terminal accepting state with each of the determined one or more non-terminal states.

12. The compiler of claim 11, wherein the state transition instruction includes any output instructions associated with the non-terminal accepting state.

13. A method of removing stall states from a state machine, the method comprising:
(a) identifying a non-terminal accepting state by searching one or more states downstream from an initial state, wherein a lexeme is associated with the non-terminal accepting state;
(b) identifying a non-terminal non-accepting state downstream from the identified non-terminal accepting state;
(c) associating information identifying the lexeme with the non-terminal non-accepting state; and
(d) repeating steps b and c until another non-terminal accepting state or a terminal state is reached.

14. The method of claim 13, further comprising repeating steps a-d for each of a plurality of initial states.

15. A method of selecting one set of regular expression queries among a plurality of sets of regular expression queries, the method comprising:
storing a plurality of regular expression queries in a computing device;
receiving a data file comprising a plurality of symbols;
identifying a start condition value in the received data file; and
determining one set of regular expression queries that corresponds with the start condition.

16. The method of claim 15, wherein each of the sets of regular expression queries comprises one or more regular expressions.

17. The method of claim 15, wherein a jump table stores one or more start condition values each associated with an entry in a start state table.

18. The method of claim 17, wherein each entry in the start state table is associated with a start location of each of the sets of regular expression queries.

19. A method of switching between sets of regular expression queries, the method comprising:
storing a plurality of sets of regular expression queries in a computing device;
receiving a data file comprising a plurality of symbols;
identifying a start condition value in the received data file;
determining a set of regular expression queries from the stored plurality of sets of regular expression queries that corresponds with the start condition;
analyzing one or more symbols of the data file according to the determined set of regular expression queries;
identifying, based on the one or more symbols of the data file, another set of regular expression queries; and
executing the identified another set of regular expression queries.

20. The method of claim 19, wherein each set of regular expression queries comprises one or more regular expressions.

21. The method of claim 20, wherein two or more sets of regular expression queries each comprise a particular regular expression.

22. The method of claim 19, wherein the act of identifying comprises identifying a lexeme in the data file that indicates the another set of regular expression queries.

23. The method of claim 19, wherein the one or more symbols comprises a lexeme.

24. The method of claim 23, wherein another start condition is associated with the lexeme.

25. The method of claim 19, wherein:
if the one or more symbols matches a first predetermined pattern, the method further comprises executing a first regular expression query; and
if the one or more symbols matches a second predetermined pattern, the method further comprises executing a second regular expression query.

26. A method of lexically analyzing a data file, the method comprising:
(a) providing a first rule set corresponding to a first set of regular expressions;
(b) identifying a first lexeme in the data file based at least partly upon the first rule set;
(c) based on the identified first lexeme, identifying a second rule set corresponding to a second set of regular expressions; and
(d) analyzing the data file according to the second rule set.

27. The method of claim 26, wherein step d further comprises:
(e) identifying a second lexeme in the data file based at least partly upon the second rule set;
(f) based on the identified second lexeme, identifying a third rule set corresponding to a third set of regular expressions; and
(g) analyzing the data file according to the third rule set.

28. The method of claim 27, wherein step g further comprises:
(h) identifying a third lexeme in the data file based at least partly upon the third rule set;
(i) based on the identified third lexeme, identifying a fourth rule set corresponding to a fourth set of regular expressions; and
(g) analyzing the data file according to the fourth rule set.

29. A method of lexically analyzing a data file, the method comprising:
(a) providing a N^{th} rule set corresponding to a N^{th} set of regular expressions;
(b) identifying a N^{th} lexeme in the data file according to the N^{th} rule set;
(c) based on the identified first lexeme, identifying a N+1^{th} rule set corresponding to a N+1^{th} set of regular expressions;
(d) setting N equal to N+1; and
(e) repeating steps b-d.

30. A system for lexically analyzing a data file, the system comprising:
(a) means for providing a N^{th} rule set corresponding to a N^{th} set of regular expressions;
(b) means for identifying a N^{th} lexeme in the data file according to the N^{th} rule set;
(c) means for identifying a N+1^{th} rule set corresponding to a N+1^{th} set of regular expressions based on the identified first lexeme;
(d) means for setting N equal to N+1;
(e) means for repeating steps b-d.

31. A system for locating one or more tokens in a plurality of data files, each data file comprising a plurality of symbols, the system comprising:
a storage device for storing at least a portion of one or more regular expression queries;
a compiler configured to generate a deterministic finite automata (DFA) based at least partly upon the one or more regular expression queries,
an execution engine configured to operate on the plurality of data files according to the DFA, wherein the execution engine is configured to process one symbol every M clock cycles; and
a multiplexer coupled to the execution engine and configured to receive symbols from at least M of the plurality of data files, wherein the execution engine receives one symbol from each of the M data files at least every M clock cycles.

32. A method of locating one or more tokens in M data files, each data file comprising a plurality of symbols, the method comprising:
receiving one or more regular expression queries;
generating a deterministic finite automata (DFA) based at least partly upon the one or more regular expression queries; and
operating on the plurality of data files according to the DFA, wherein the execution engine receives one symbol from each of the M data files at least every M clock cycles.

33. A system for locating one or more tokens in M data files, each data file comprising a plurality of symbols, the system comprising:
means for receiving one or more regular expression queries;
means for generating a deterministic finite automata (DFA) based at least partly upon the one or more regular expression queries; and
means for operating on the plurality of data files according to the DFA, wherein the execution engine receives one symbol from each of the M data files at least every M clock cycles.

34. An apparatus for processing a single data file comprising a plurality of symbols, the apparatus comprising:
a segmenter configured to divide the file into M regions;
M storage locations each configured to buffer portions of one of the M regions;
a core execution unit configured to execute a state machine, wherein movement from a current state to a next state in the state machine requires M clock cycles, the core execution unit comprising a storage device for storing information indicating one or more boundaries between the M regions, wherein the core execution unit reads a symbol from one of the M storage locations during each clock cycle.

35. The apparatus of claim 34, wherein each of the M storage locations comprises a buffer.

36. The apparatus of claim 34, wherein a buffer comprises each of the M storage locations.

37. The apparatus of claim 34, wherein the data file comprises M substreams, wherein an i^{th} substream comprises one or more symbols of an i^{th} region and one or more symbols of an i+1^{st} region.

38. The apparatus of claim 37, wherein the core execution unit is further configured to re-process some symbols in the i+1^{st} region in connection with analysis of the i^{th} substream in order to identify a lexeme that crosses a boundary between the i^{th} and the i+1^{st} regions.

39. The apparatus of claim 37, wherein the core execution unit is further configured to stop re-processing of symbols in the i+1^{st} region in connection with the i^{th} substream (1) after all symbols in the i^{th} substream have been processed and (2) when an output result in re-processing the i+1^{st} region in connection with the i^{th} substream is the same as an output result produced by processing an i+1^{st} substream.

40. The apparatus of claim 34, wherein the data file comprises M substreams, wherein an i^{th} substream comprises one or more symbols of an i^{th} region and zero or more symbols of an i+1^{st} region.

41. The apparatus of claim 34, wherein the apparatus stores indications of each time the core execution unit (1) initiates an output and (2) determines that a start state is going to be entered.

42. A method of representing a state machine, the method comprising:
(a) determining a number M of out transitions from a Nth state in the state machine;
(b) generating an instruction corresponding to each of the M transitions from the Nth state, wherein each of the instructions includes an indication of a next state in the state machine;
(c) repeating steps a and b for each of the states of the state machine; and
(d) storing at least some of the instructions for each of the states of the state machine in a storage device, wherein the indication of the next state in the one or more instructions is usable to determine an address of the next state in the storage device.

43. The method of claim 42, wherein for a particular state in the state machine, M-1 of the transitions are failure transitions and the M-1 failure transitions are combined in a single instruction for storage in the storage device.

44. The method of claim 42, wherein the M transitions for the particular state are stored in the storage device.

45. The method of claim 42, wherein an opcode associated with the M transitions from the particular state indicates that the single instruction represents transitions from M-1 states.

46. The method of claim 42, wherein for a particular state in the state machine, M-2 of the transitions are failure transitions and the M-2 failure transitions are combined in a single instruction for storage in the storage device.

47. The method of claim 46, wherein an opcode associated with the M transitions from the particular state indicates that the single instruction represents transitions from M-2 states.

48. The method of claim 42, wherein for a particular state in the state machine, M-P of the transitions are failure transitions and the M-P failure transitions are combined in a single instruction for storage in the storage device.

49. The method of claim 48, wherein an opcode associated with the M transitions from the particular state indicates that the single instruction represents transitions from M-P states.

50. A method of moving between a plurality of states of a state machine, wherein a plurality of instructions indicate transitions between states of the state machine, the method comprising:
selecting an instruction corresponding to a transition from a first state, wherein the act of selecting is based, at least partly, on one or more current symbol classes;
setting an offset according to one or more of the current symbol classes and one or more fields of the selected instruction;
determining an address of a next state by adding the offset to an address of the selected instruction.

51. The method of claim 50, wherein the offset is set equal to the current symbol class.

52. The method of claim 50, wherein the offset is set according to a correspondence between one or more elements of the selected instruction and the current symbol classes.

53. The method of claim 50, wherein the offset is set to the value obtained by subtracting an element of the selected instruction from one of the current symbol classes.

54. The method of claim 50, wherein the offset is set to the result of an arithmetic operation performed on one or more of the current symbol classes and one or more elements of the selected instruction

55. The method of claim 50, wherein the offset is set according to one or more of the current symbol classes.

56. The method of claim 42, wherein at least one of the instructions is a virtual terminal instruction, wherein the virtual terminal instruction includes (a) information indicating an output that corresponds to the state associated with the virtual terminal instruction and (b) information usable to determine a next initial state, and wherein by executing the virtual terminal instruction, a transition is made directly to the next initial state and the output is produced in a single clock cycle.

57. A state machine comprising:
a plurality of instructions, each instruction representing a transition from one state to another state in a state machine; and
a virtual terminal instruction including (a) information indicating an output that corresponds to a state associated with the virtual terminal instruction and (b) information usable to determine a next state, wherein by executing the virtual terminal instruction, the state machine transitions from the state associated with the virtual terminal instruction to the determined next state in a single clock cycle.

58. The state machine of claim 57, wherein, during the single clock cycle the output is produced.
